(19) United States
(12) Patent Application Publication
(10) Pub. No.: US 2014/0114802 A1
(43) Pub. Date: Apr. 24, 2014

(54) METHOD AND APPARATUS FOR ONLINE STORE

(71) Applicant: Venkatakrishna Mandalap, Princeton Junction, NJ (US)

(72) Inventor: Venkatakrishna Mandalap, Princeton Junction, NJ (US)

(21) Appl. No.: 13/658,071

(22) Filed: Oct. 23, 2012

(51) Int. Cl. G06Q 30/00

(52) U.S. Cl. 705/26.9; 705/27.1

(57) ABSTRACT

An apparatus including a server computer processor, and a server computer memory. The server computer processor may be programmed by computer software stored in the server computer memory to provide a plurality of administrator web pages of a web site to a first store computer. The plurality of administrator web pages may be configured to enable a user of an interactive device of the first store computer to enter sets of information concerning a plurality of products for sale from a first store located at a first physical address, the first store corresponding to the first store computer. The server computer processor may be programmed by computer software to provide a geographical gateway web site page. The geographical gateway web site page may allow a user of the first customer computer to select a geographic area in which one or more stores are located which sell a particular product.

### FIELD OF THE INVENTION

This invention relates to improved methods and apparatus concerning online stores.

### BACKGROUND OF THE INVENTION

There are various devices known in the prior art for online stores.

### SUMMARY OF THE INVENTION

In at least one embodiment of the present invention an apparatus is provided comprising a server computer processor, and a server computer memory. The server computer processor may be programmed by computer software stored in the server computer memory to provide a plurality of administrator web pages of a web site to a first store computer. The plurality of administrator web pages may be configured to enable a user of an interactive device of the first store computer to enter a first set of information concerning a plurality of products for sale from a first store located at a first physical address, wherein the first store corresponds to the first store computer.

The plurality of administrator web pages may be configured to enable a user of the interactive device of the first store computer to enter a second set of information concerning a plurality of vendors who provide products for sale from the first store.

The plurality of administrator web pages may be configured to enable a user of the interactive device of the first store computer to enter a third set of information concerning a plurality of customers who have purchased products sold from the first store.

The plurality of administrator web pages may be configured to enable a user of the interactive device of the first store computer to enter a fourth set of information concerning financial data involving sales from the first store.

The plurality of administrator web pages may be configured to enable a user of the interactive device of the first store computer to enter a fifth set of information concerning categories of products for sale from the first store.

The plurality of administrator web pages may be configured to enable a user of the interactive device of the first store computer to enter a sixth set of information concerning tax information regarding products for sale from the first store.

The plurality of administrator web pages may be configured to enable a user of the interactive device of the first store computer to enter a seventh set of information concerning shipping information regarding products for sale from the first store.

The server computer processor may be programmed by computer software stored in the server computer memory to provide a geographical gateway web site page. The geographical gateway web site page may be accessible from the server computer processor over the internet by a first customer using a first customer computer. The geographical gateway web site page may allow a user of the first customer computer to select a geographic area in which one or more stores are located which sell a particular product.

In at least one embodiment a method is provided, which may include including providing a plurality of administrator web pages of a web site to a first store computer from a server computer processor. The plurality of administrator web pages may be configured to enable a user of an interactive device of the first store computer to enter a sets of information as previously discussed. The server computer processor may be programmed by computer software stored in the server computer memory to provide a geographical gateway web site page, wherein the geographical gateway web site page is accessible from the server computer processor over the internet by a first customer using a first customer computer; and wherein the geographical gateway web site page allows a user of the first customer computer to select a geographic area in which one or more stores are located which sell a particular product.

### BRIEF DESCRIPTION OF THE DRAWINGS

FIG. 1 shows block diagram of an apparatus and method in accordance with an embodiment of the present invention;

FIG. 2A shows a block diagram of a customer computer for use with the method and/or apparatus of FIG. 1;

FIG. 2B shows a block diagram of a server computer for use with the method and/or apparatus of FIG. 1;

FIG. 2C shows a block diagram of a first store computer for use with the method and/or apparatus of FIG. 1;

FIG. 3 shows a first image which may be displayed on a customer computer display of FIG. 2A in accordance with an embodiment of the present invention;

FIG. 4 shows a second image which may be displayed on the customer computer display of FIG. 2A in accordance with an embodiment of the present invention;

FIG. 5 shows a third image which may be displayed on the customer computer display of FIG. 2A in accordance with an embodiment of the present invention;

FIG. 6 shows a fourth image which may be displayed on the customer computer display of FIG. 2A in accordance with an embodiment of the present invention;

FIG. 7 shows a fifth image which may be displayed on the customer computer display of FIG. 2A in accordance with an embodiment of the present invention;

FIG. 8 shows a flow chart of a method in accordance with an embodiment of the present invention;

FIG. 9 shows a flow chart of a method for setting up information for a store or vendor on a server web site, in accordance with an embodiment of the present invention;

FIG. 10 shows a flow chart of a method for dropping and/or shipping a product to a customer from a vendor, in accordance with an embodiment of the present invention;

FIG. 11 shows a flow chart of a method for adding a discount to a product, in accordance with an embodiment of the present invention;

FIG. 12 shows a flow chart of a method for creating a purchase order for a product, in accordance with an embodiment of the present invention;

FIG. 13 shows a flow chart of a method for shipping a product, in accordance with an embodiment of the present invention;

FIG. 14 shows a flow chart of a method for creating categories of products, in accordance with an embodiment of the present invention;

FIG. 15 shows a flow chart of a method for changing content for the store front website, in accordance with an embodiment of the present invention;

FIG. 16 shows a flow chart of a method for uploading a logo, in accordance with an embodiment of the present invention;

FIG. 17 shows a flow chart of a method for updating a main banner, in accordance with an embodiment of the present invention;

FIG. 18 shows a flow chart of a method for creating navigation, in accordance with an embodiment of the present invention;

FIG. 19 shows a flow chart of a method for updating a promotional box, in accordance with an embodiment of the present invention;

FIG. 20 shows a sixth image which may be displayed on the first store computer display of FIG. 2C in accordance with an embodiment of the present invention;

FIG. 21 shows a seventh image which may be displayed on the first store computer display of FIG. 2C in accordance with an embodiment of the present invention;

FIG. 22 shows a eighth image which may be displayed on the first store computer display of FIG. 2C in accordance with an embodiment of the present invention;

FIG. 23 shows a ninth image which may be displayed on the first store computer display of FIG. 2C in accordance with an embodiment of the present invention;

FIG. 24 shows a tenth image which may be displayed on the first store computer display of FIG. 2C in accordance with an embodiment of the present invention;

FIG. 25 shows a eleventh image which may be displayed on the first store computer display of FIG. 2C in accordance with an embodiment of the present invention;

FIG. 26 shows a twelfth image which may be displayed on the first store computer display of FIG. 2C in accordance with an embodiment of the present invention;

FIG. 27 shows a thirteenth image which may be displayed on the first store computer display of FIG. 2C in accordance with an embodiment of the present invention;

FIG. 28 shows a fourteenth image which may be displayed on the first store computer display of FIG. 2C in accordance with an embodiment of the present invention;

FIG. 29 shows a fifteenth image which may be displayed on the first store computer display of FIG. 2C in accordance with an embodiment of the present invention;

FIG. 30 shows a sixteenth image which may be displayed on the first store computer display of FIG. 2C in accordance with an embodiment of the present invention;

FIG. 31 shows a seventeenth image which may be displayed on the first store computer display of FIG. 2C in accordance with an embodiment of the present invention;

FIG. 32 shows a eighteenth image which may be displayed on the first store computer display of FIG. 2C in accordance with an embodiment of the present invention;

FIG. 33 shows a nineteenth image which may be displayed on the first store computer display of FIG. 2C in accordance with an embodiment of the present invention;

FIG. 34 shows a twentieth image which may be displayed on the first store computer display of FIG. 2C in accordance with an embodiment of the present invention;

FIG. 35 shows a twenty-first image which may be displayed on the first store computer display of FIG. 2C in accordance with an embodiment of the present invention;

FIG. 36 shows a twenty-second image which may be displayed on the first store computer display of FIG. 2C in accordance with an embodiment of the present invention;

FIG. 37 shows a twenty-third image which may be displayed on the first store computer display of FIG. 2C in accordance with an embodiment of the present invention;

FIG. 38 shows a twenty-fourth image which may be displayed on the first store computer display of FIG. 2C in accordance with an embodiment of the present invention;

FIG. 39 shows a twenty-fifth image which may be displayed on the first store computer display of FIG. 2C in accordance with an embodiment of the present invention;

FIG. 40 shows a twenty-sixth image which may be displayed on the first store computer display of FIG. 2C in accordance with an embodiment of the present invention;

FIG. 41 shows a twenty-seventh image which may be displayed on the first store computer display of FIG. 2C in accordance with an embodiment of the present invention;

FIG. 42 shows a twenty-eighth image which may be displayed on the first store computer display of FIG. 2C in accordance with an embodiment of the present invention;

FIG. 43 shows a twenty-ninth image which may be displayed on the first store computer display of FIG. 2C in accordance with an embodiment of the present invention;

FIG. 44 shows a thirtieth image which may be displayed on the first store computer display of FIG. 2C in accordance with an embodiment of the present invention;

FIG. 45 shows a thirty-first image which may be displayed on the first store computer display of FIG. 2C in accordance with an embodiment of the present invention;

FIG. 46 shows a thirty-second image which may be displayed on the first store computer display of FIG. 2C in accordance with an embodiment of the present invention;

FIG. 47 shows a thirty-third image which may be displayed on the first store computer display of FIG. 2C in accordance with an embodiment of the present invention;

FIG. 48 shows a thirty-fourth image which may be displayed on the first store computer display of FIG. 2C in accordance with an embodiment of the present invention;

FIG. 49 shows a thirty-fifth image which may be displayed on the first store computer display of FIG. 2C in accordance with an embodiment of the present invention;

FIG. 50 shows a thirty-sixth image which may be displayed on the first store computer display of FIG. 2C in accordance with an embodiment of the present invention;

FIG. 51 shows a thirty-seventh image which may be displayed on the first store computer display of FIG. 2C in accordance with an embodiment of the present invention;

FIG. 52 shows a thirty-eighth image which may be displayed on the first store computer display of FIG. 2C in accordance with an embodiment of the present invention;

FIG. 53 shows a thirty-ninth image which may be displayed on the first store computer display of FIG. 2C in accordance with an embodiment of the present invention;

FIG. 54 shows a fortieth image which may be displayed on the first store computer display of FIG. 2C in accordance with an embodiment of the present invention;

FIG. 55 shows a forty-first image which may be displayed on the first store computer display of FIG. 2C in accordance with an embodiment of the present invention;

FIG. 56 shows a forty-second image which may be displayed on the first store computer display of FIG. 2C in accordance with an embodiment of the present invention;

FIG. 57 shows a forty-third image which may be displayed on the first store computer display of FIG. 2C in accordance with an embodiment of the present invention;

FIG. 58 shows a forty-fourth image which may be displayed on the first store computer display of FIG. 2C in accordance with an embodiment of the present invention;

FIG. 59 shows a forty-fifth image which may be displayed on the first store computer display of FIG. 2C in accordance with an embodiment of the present invention;

FIG. 60 shows a forty-sixth image which may be displayed on the first store computer display of FIG. 2C in accordance with an embodiment of the present invention;

FIG. 61 shows a forty-seventh image which may be displayed on the first store computer display of FIG. 2C in accordance with an embodiment of the present invention;

FIG. 62 shows a forty-eighth image which may be displayed on the first store computer display of FIG. 2C in accordance with an embodiment of the present invention;

FIG. 63 shows a forty-ninth image which may be displayed on the first store computer display of FIG. 2C in accordance with an embodiment of the present invention; and

FIG. 64 shows a fiftieth image which may be displayed on the first store computer display of FIG. 2C in accordance with an embodiment of the present invention.

### DETAILED DESCRIPTION OF THE DRAWINGS

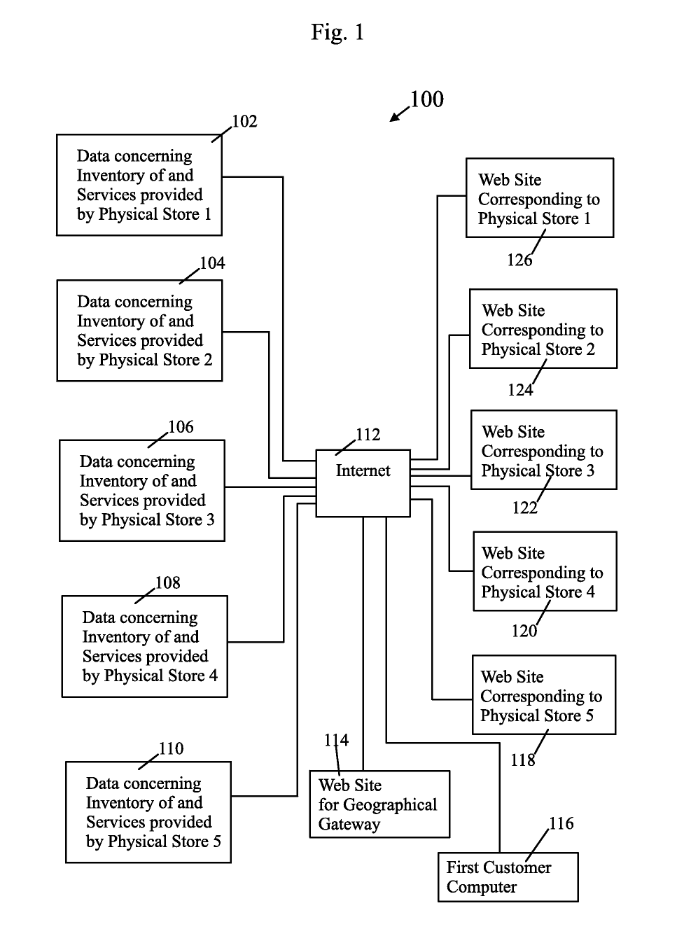

FIG. 1 shows block diagram 100 of an apparatus and method in accordance with an embodiment of the present invention.

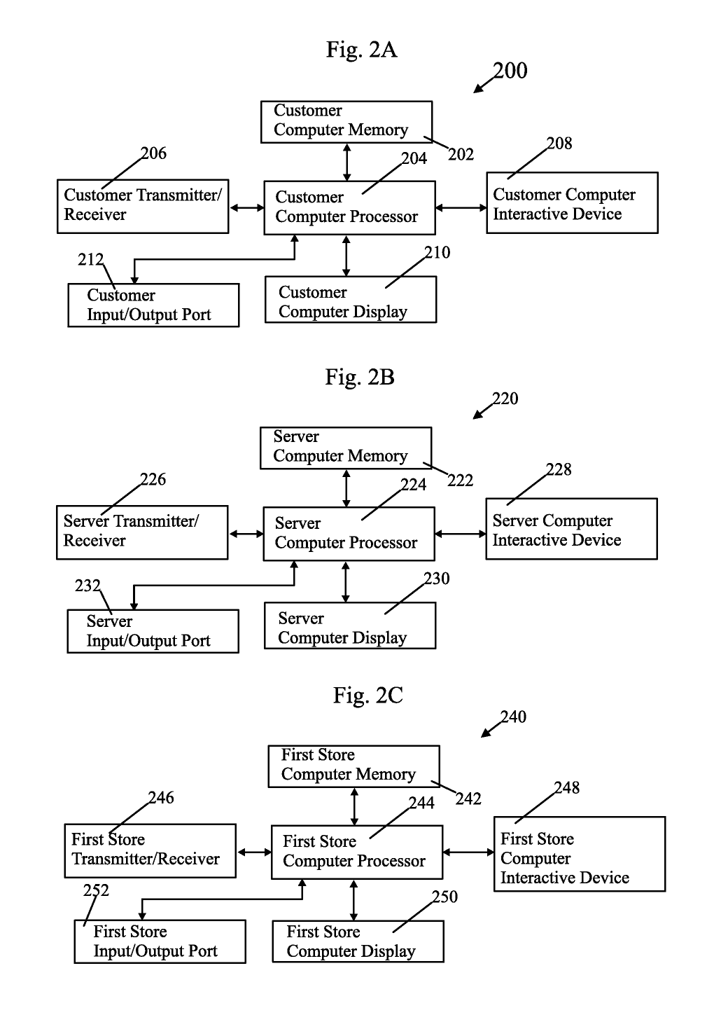

FIG. 1 shows modules 102, 104, 106, 108, and 110 which represent data concerning inventory of and services provided by a first, a second, a third, a fourth, and a fifth physical store, respectively. The data 102, 104, 106, 108, and 110, is provided through internet 112 to a web site for geographical gateway 114. The web site for geographical gateway 114, may include a server computer 220 as shown in FIG. 2B, and the data may be stored in a server computer memory 222.

FIG. 1 also shows modules 118, 120, 122, 124, and 126 which represent web sites for the first, the second, the third, the fourth, and the fifth physical stores. Each of the web sites for the physical stores may be store on the server computer 220, in the server computer memory 222.

FIG. 1 also shows module 116 which represents a first customer computer 116. The first customer computer 116 may be the same as or may be replaced by a customer computer 200 shown in FIG. 2A.

FIG. 2A shows a block diagram of a customer computer 200 for use with the method and/or apparatus of FIG. 1. The customer computer 200 may include a customer computer memory 202, a customer computer processor 204, a customer transmitter/receiver 206, a customer computer interactive device 208, a customer computer display 210, and a customer input/output port 212. The components 202, 206, 208, 210, and 212 may be connected by communications links with the customer computer processor 204. The communications links may be any known communications links such as hardwired, wireless, optical, or any other known communications links.

FIG. 2B shows a block diagram of the server computer 220 for use with the method and/or apparatus of FIG. 1. The server computer 220 may include a server computer memory 222, a server computer processor 224, a server transmitter/receiver 226, a server computer interactive device 228, a server computer display 230, and a server input/output port 232. The components 222, 226, 228, 230, and 232 may be connected by communications links with the server computer processor 224. The communications links may be any known communications links such as hardwired, wireless, optical, or any other known communications links.

FIG. 2C shows a block diagram of the first store computer 240 for use with the method and/or apparatus of FIG. 1. The first store computer 240 may include a first store computer memory 242, a first store computer processor 244, a first store transmitter/receiver 246, a first store computer interactive device 248, a first store computer display 250, and a first store input/output port 252. The components 242, 246, 248, 250, and 252 may be connected by communications links with the server computer processor 244. The communications links may be any known communications links such as hardwired, wireless, optical, or any other known communications links.

Each of the interactive devices 208, 228, and 248 may include one or more of a computer mouse, a computer keyboard, a touch screen, a stylus, or any other known computer interactive device.

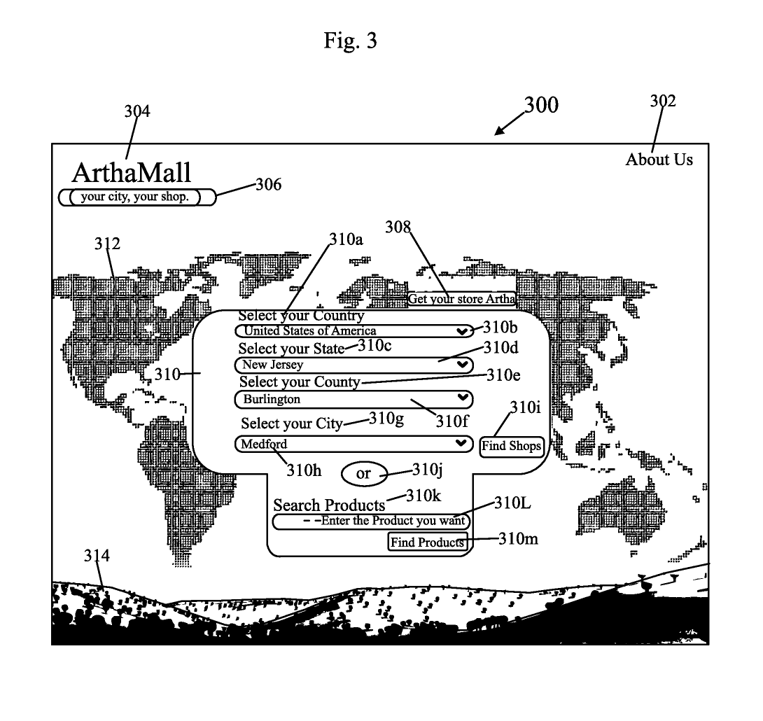

FIG. 3 shows a first image 300 which may be displayed on a customer computer display 210 of FIG. 2A in accordance with an embodiment of the present invention. The first image 300 may be caused to be displayed on the customer computer display 210 by a customer entering a web address, such as “www.shopartha.com” into the customer computer interactive device 208, which may cause the customer computer processor to request a home web site page for “www.arthamail.com from the server computer 220, for example via transmitter/receiver 206, the internet 112 (shown by FIG. 1), and server transmitter/receiver 226. In response, the server computer 220 may provide data for a home web site page, such as data for the first image 300 via server transmitter/receiver 226, internet 112, transmitter/receiver 206, to the customer computer processor 204, which causes the first image 300 to be displayed on the customer computer display 210.

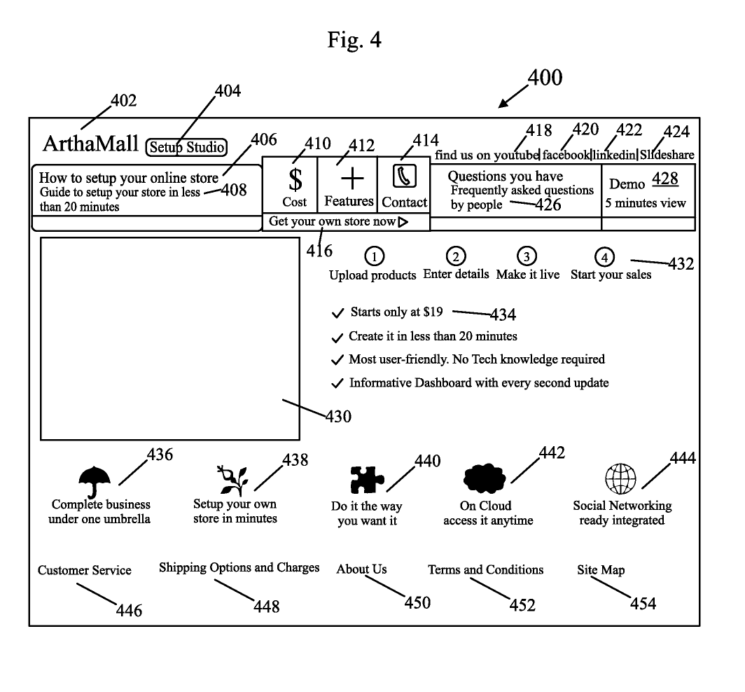

The first image 300 includes a field and/or text for “About Us”, which can be clicked on to display an image, not shown, which describes characteristics of the company that provides the web site. The first image 300 includes text 304 for “shopArtha” which may be a trademark. The first image 300 further includes a field 306 which may be text and may be clicked on to do reach the home page 300. The “your city, your shop” text in field 306 is a trade mark. The first image 300 further includes a field 308 for “Get your store Artha” which can be clicked on or otherwise selected using customer computer interactive device 208 to cause the computer processor 204 display the image 400 shown in FIG. 4 on display 210, which may include instructions.

The first image 300 includes a box 310. The box 310 includes text 310a and a field 310b including an upside arrow to click on to browse through a plurality of country names and select a single country name. In this case “United States of America” has been selected.

The box 310 further includes text 310c and a field 310d including an upside arrow to click on to browse through a plurality of state names and select a single state name. In this case “New Jersey” has been selected.

The box 310 further includes text 310e and a field 310f including an upside down arrow to select and/or click on using interactive device 208 to browse through a plurality of county names and select a single county name. In this case “Burlington” has been selected.

The box 310 further includes text 310g and a field 310h including an upside arrow to click on to browse through a plurality of city names and select a city name. In this case “Medford” has been selected.

The box 310 further includes a box 310i for selecting, such as clicking on, using interactive device 208, to find shops. When box 310i is selected with interactive device 208, this causes computer processor 204 to download data from server computer 220, and to display image 500 on display 210 referring to such data, which displays all stores who have joined the web site or have entered into an agreement with the provider of the service in the particular geographic region, such as in a town either by the store logo and/or store name in text hyperlinked.

The box 310 further includes a field 310j, which is typically static text and serves as a communication for the user to choose between different options.

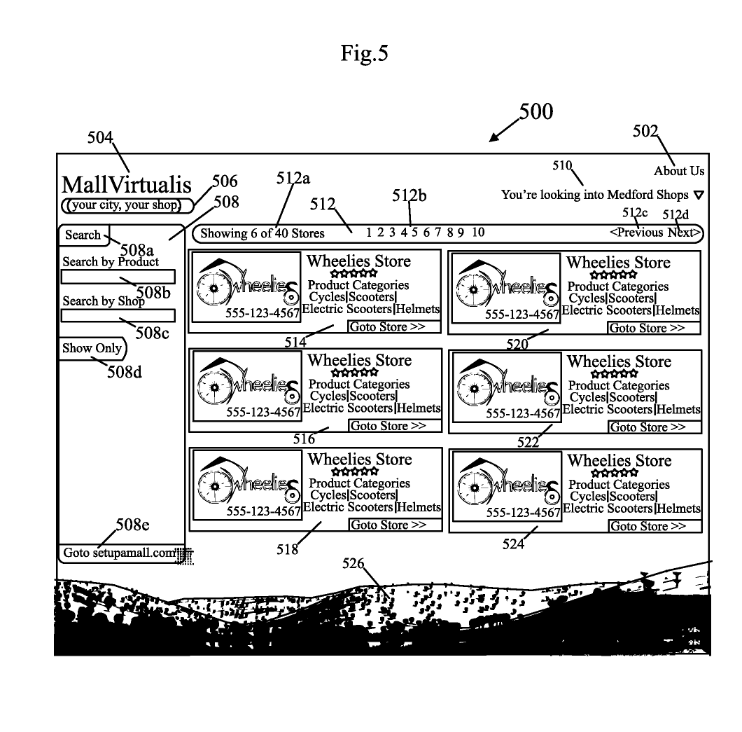

The box 310 further includes text 310k, and field 310L into which a name of a product can be entered into computer memory 202 and displayed on computer display 210 using interactive device 208, as executed by computer processor 204. The box 310 further includes a field 310m which can be selected or clicked on using interactive device 208 to find products, which causes the computer processor 204 to download data from the server computer 220, and display image 500, relating to the downloaded data, on the computer display 210, shown in FIG. 5, with stores of the selected products in that geographic region, such as in that town.

The image 300 in FIG. 3 also includes background images of countries 312, and a background image of land 314. Other background images can be used instead of 312 and 314.

In at least one embodiment, selections of fields or information input into customer computer interactive device 208 are processed by customer computer processor 204, and sent via transmitter/receiver 206, internet 112 (FIG. 1), and server transmitter/receiver 226 to the server computer processor 224; and the server computer processor 224 provides information back to the customer computer 200 via transmitter/receiver 226, internet 112, and transmitter/receiver 206, in response to the information input into customer computer interactive device 208.

FIG. 4 shows an image 400 which may be displayed on the customer computer display 210 of FIG. 2A in accordance with an embodiment of the present invention. A customer may cause the customer computer processor 204 to display the image 400 on the display 210 by selecting field 308 of the image 300 “Get your store Artha” using customer computer interactive device 208.

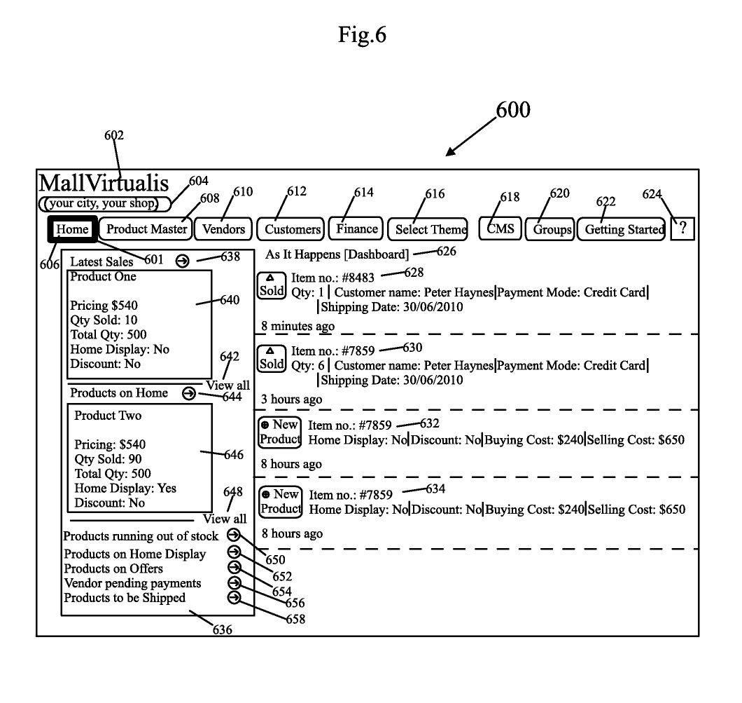

Selecting “Get your store Artha” field or text 308 from the image 300, using the interactive device 208 causes the computer processor 204 to display the image 600 shown in FIG. 6 on the display 210. The image 600 may include instructions to set up various parameters.

The image 400 includes text 402 and the field 404 “Setup Studio” for “ArthaMall” which identifies a web site in accordance with an embodiment of the present invention. The image 400 includes step by step instructions, such as creating categories, creating vendors, upload products and in overall just seven steps to setup the entire online store and to help a user set up the image 600 shown in FIG. 6, In order to populate the image 600 with images, product information and pricing.

The image 400 also includes the field 406 which can be selected to cause the computer processor 204 to display an image or web page showing instructions for how to set up an online store. The image 400 also includes the field 408 which can be selected to cause the computer processor 204 to display a guide to set up an online store 600. Generally, the images or web pages which processor 204 causes to be displayed on display 210, may be downloaded from the server computer 220 to the customer computer 200, such as via the server transmitter/receiver 226 and the customer transmitter/receiver 206.

The image 400 further includes a field 410 which can be selected to cause the computer processor 204 to display the cost of setting up an online store; a field 412, which can be selected to cause the computer processor 204 to display on a web page the features of an online store; and a field 414, which can be selected to cause the computer processor 204 to display on a web page contact information for someone to help with online store setup.

The image 400 includes field 416, which includes text and a triangle which can be selected using the interactive device 208 to cause the computer processor 204 to display on the display 210, a costing page, which may be any costing page known in the art.

The image 400 further includes fields 418, 420, 422, and 424, each of which can be selected using customer computer interactive device 208, to cause the computer processor 204 to display web pages of youtube (trademarked), facebook (trademarked), linkedin (trademarked), or slideshare (trademarked) computer software applications, respectively, on the display 210. These web pages may be downloaded from the server computer 220, such as via transmitter/receivers 226 and 206, to the customer computer 200.

The image 400 includes a field 426, which can be selected by the interactive device 208 to cause the computer processor 204 to display on display 210 questions regarding setting up an online store which have previously been asked or which are typically asked.

The image 400 includes a field 428 which can be selected by the interactive device 208 to cause the computer processor 204 to display on display 210, a video clip, “demo” or demonstration, of how to set up an online store. The image 400 includes a box or field 430 which may display a first draft web page of an online store that is being developed. The image 400 includes text 432 showing four steps for developing and/or using an online store.

The image 400 includes text 434 which details various characteristics of an online store and/or prices for developing an online store.

The image 400 further includes fields 436, 438, 440, 440, 442, and 444 which explains the quick benefits of the product.

The image 400 further includes fields 446, 448, 450, 452, and 454. Field 446 can be selected to cause the computer processor 204 to display customer service information on the display 210. Field 448 can be selected to cause the computer processor 204 to display shipping options and charges on the display 210. Field 450 can be selected to display information about the entity who is providing the web site. Field 452 can be selected to cause the computer processor 204 to display information on display 210 concerning terms and conditions for use of this online store setup web site. Field 454 can be selected to cause the computer processor 204 to display information on display 210 concerning a web site map for this online store setup web site.

FIG. 5 shows an image 500 which may be displayed on the customer computer display 210 of FIG. 2A in accordance with an embodiment of the present invention.

The image 500 includes fields 502, 504, 506, and 510. Field 502 may be selected using customer computer interactive device 208 to cause the computer processor 204 to display on the display 210 information about the entity providing the web site called “MallVirtualis”. Field 504 may be text for the web site. Field 506 may be selected using customer computer interactive device 208 to cause the computer processor 204 to display the image 300 shown in FIG. 3. Field 510 may indicate what shops or stores of what town or area are being looked into. For example, in FIG. 5, stores or shops physically located in the town of Medford, N.J., may be shown in image 500, in fields 514, 516, 518, 520, 522, and 524.

The image 500 may further include the box 508. The box 508 may include fields 508a, 508b, 508c, 508d, and 508e. The field 508a may be selected using customer computer interactive device 208 to cause the computer processor 204 to display on the display 210 search results relating to information provided in fields 508b, 508c, and 508d. A product description, name or category may be entered in field 508b using interactive device 208. A shop or store name may be entered into field 508c using interactive device 208. The field 508d may be used to select a specific product's common description such as “hair-pin”. Selecting the field 508a using the interactive device 208 may cause the computer processor 204 to execute an internet search for the product and/or shop specified in fields 508b and 508c, respectively. The search may be executed by downloading information from the server computer 220 (of FIG. 2B) and/or generally from the internet 112 (of FIG. 1), to the customer computer 200. (of FIG. 2A). Field 208e may be selected using customer computer interactive device 208 to cause the computer processor 204 to display on the display 210 a web site page for “setupamall.com” which can be downloaded from the server computer 220 and/or generally from the internet 112 to the customer computer 200.

The image 500 further includes box 512 which includes fields 512a, 512b, 512c, and 512d. Field 512a is text specifying that six of forty stores are shown in fields 514, 516, 518, 520, 522, and 524, i.e. each of 514, 516, 518, 520, and 522 shows information about a single geographic store. The stores 514, 516, 518, 520, and 522 have the same description, but typically would have different characteristics or descriptions.

Field 512b may show how many pages of results or pages of stores for a search. For example selecting “1” of field 512b using the customer computer interactive device 208 causes the computer processor 204 to display on the display 210 a first page of results, which may be the information for the six stores 514, 516, 518, 520, 522, and 524 shown in FIG. 5. Field 512c may be selected using customer computer interactive device 208 to cause the computer processor 204 to display on the display 210 a previous page of search results, such as a previous page of information about physical stores. Field 512d may be selected using customer computer interactive device 208 to cause the computer processor 204 to display on the display 210 a next page of search results, such as a next page of information about physical stores.

Each of fields 514, 516, 518, 520, 522, and 524 has information about a particular physical store, such as logo, name, phone number, rating in stars, products sold. Each of fields 514, 516, 518, 520, 522, and 524 has a button or field “Goto Store >>” which may be selected using customer computer interactive device 208 to cause the computer processor 204 to display on the display 210 further information about the particular physical store. Each of fields 514, 516, 518, 520, 522, and 524 may display different information about different stores, although the information is shown as the same in FIG. 5.

The image 500 also includes background 526.

FIG. 6 shows an image 600 which may be displayed on the customer computer display 210 of FIG. 2A in accordance with an embodiment of the present invention. The computer processor 204 may download data for the image 600 from the server computer 220, via transmitter/receivers 226 and 206 to cause the image 600 to be displayed on display 210, when a customer enters a web site address such as “www.mallvirtualis”. The image 600 may be a home page as indicated by the highlighting (as shown by dark square box) around “Home” field 606.

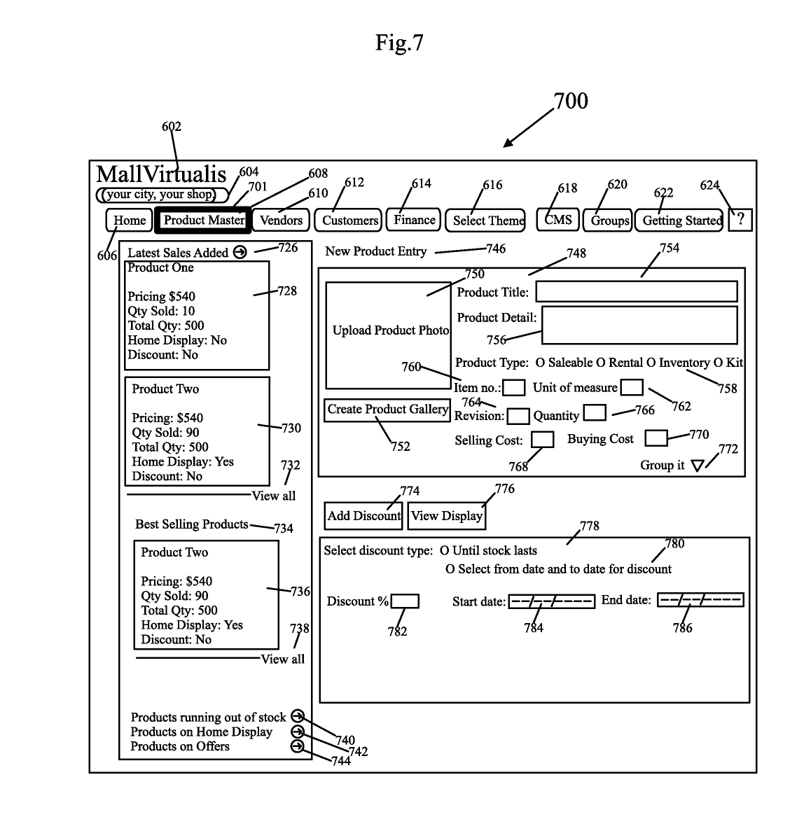

The image 600 may include text 602, fields 604, 606, 608, 610, 612, 614, 616, 618, 620, 622, and 624. A customer may select field 606 to display the image 606, using interactive device 208. A customer may select field 608 for “Product Master” to cause the processor 204 to download information from the server computer 220 to display the image 700, shown in FIG. 7, on the display 210. A customer may select any one of fields 610, 612, 614, 616, 618, 620, 622, and 624 to cause the processor 204 to download information from the server computer 220 to display the specific information concerning their division when you select.

The image 600 also includes text 626 for “As it Happens [Dashboard]”. Underneath the text 626, various information concerning products sold or new products provided by a particular store may be displayed on customer computer display 210. Underneath text 626 is shown fields 628, 630, 632, and 634. Each field of fields 628, 630, 632, and 634 provides information concerning a specific product, such as item number, quantity sold, customer name that bought the item, payment mode, shipping date, buying cost, selling cost, whether there is a discount.

The image 600 also includes a box 636. The box 636 includes fields 638, 640, 642, 644, 646, 648, 650, 652, 654, 656, and 658. Field 638 shows text for “Latest Sales” and includes a button with an arrow which can be selected using interactive device 208 to cause latest sales information to be downloaded from server computer 220 and displayed on customer computer display 210 by computer processor 204. Field 640 list various information about a “Product One”. Field 642 for “View all” can be selected using interactive device 208 to information regarding all products of one physical store that has information or data concerning its products published on a virtual online store, in accordance with embodiment of the present invention, to be downloaded from server computer 220 and displayed on customer computer display 210 by computer processor 204.

Items published on this web site for sale may or may not contain the physical stores inventory, which can be selected using interactive device 208 to download from the server computer 220 information regarding all products in one physical and display on customer computer display 210 by computer processor 204.

The field 650 includes a button with an arrow that can be selected to display on customer computer display 210 products that are almost out of stock. The button with an arrow in field 650 is a function, which when selected using interactive device 208, expands from quick view to display all the information pertaining to the function of the screen and its data with or without images.

The field 654 includes a button with an arrow that can be selected to display on customer computer display 210 products on Discount The “arrow” is a function to expand from quick view to display on the computer display 210 all the information pertaining to the function of the screen and its data with or without images.

The field 656 includes a button with an arrow that can be selected to display on customer computer display 210 vendor pending payments. The “arrow” is a function to expand from quick view to display all the information pertaining to the function of the screen and its data with or without images.

The field 658 includes a button with an arrow that can be selected to display on customer computer display 210 information regarding products to be shipped to a customer. The “arrow” is a function to expand from quick view to display all the information pertaining to the function of the screen and its data with or without images.

FIG. 7 shows an image 700 which may be displayed on the customer computer display 210 of FIG. 2A in accordance with an embodiment of the present invention. The computer processor 204 may download data for the image 700 from the server computer 220, via transmitter/receivers 226 and 206 to cause the image 700 to be displayed on display 210, when a customer selects the field 608 using the customer computer interactive device 208. Selecting the field 608 for “Product Master” may cause the computer processor 204 to highlight the field 608 such as with highlighting or black outline 701 shown in FIG. 7.

The image 700 includes fields or text 602, 604, 606, 608, 610, 612, 614, 616, 618, 620, 622, and 624 previously described with reference to FIG. 6. The image 700 further includes fields or text 726, 728, 730, 732, 734, 736, 738, 740, 742, and 744. The field or text 726 includes text for “Latest Sales Added” and a button with an arrow which can be selected using interactive device 208 to display the information concerning latest sales added or made for a particular physical store location in fields or boxes 728 and 730. The field or box 728 shows information regarding a “Product One” including its pricing, quantity sold, total quantity left available, and whether a discount is available on “Product One”.

Similarly, the field or box 730 shows information regarding a “Product Two” including its pricing, quantity sold, total quantity left available, and whether a discount is available on “Product Two”. The field 732 when selected using interactive device 208 causes all the latest products to be displayed on the computer display 210 by the computer processor 204. In at least one embodiment this means that information and/or data regarding a product from the last transaction executed is displayed first, such as in field 728 in image 700 of FIG. 7.

The field or text 734 refers to “Best Selling Products” at a particular physical store through their online website. The field or box 736 shows “Product Two” as one of, or as the best selling products. Pricing, quantity sold, quantity available, home display, and discount information is also shown in field or box 736. The field 738 when selected using interactive device 208 causes all the best selling products sold, the methods are designed to function to provide key data to the store owner to take efficient decisions to replenish based on real-time transactions be displayed on customer computer display 210.

Field 740 refers to “Products running out of stock” and has an arrow inside a circle which can be selected using interactive device 208 to cause a list or products which are either out of stock or about to run out of stock at a particular physical store to be displayed on display 210 by computer processor 204.

Field 744 refers to “Products on Discounts” and has an arrow inside a circle which can be selected using interactive device 208 to cause products which are on offers by clicking the arrow the screen expands and displays all the relevant data related to its function be displayed on display 210 by computer processor 204.

The image 700 also includes fields 746, 748, 750, 752, 754, 756, 758, 760, 762, 764, 766, 768, 770, and 772. The field 746 shows text for “New Product Entry” and the field or box 748 has information referring to the new product entry. The field or box 748 includes a box 750 with a photo of the new product which has been uploaded from the server computer 220 by the customer computer 200. The field or box 748 includes a product title in field 754, product details in field 756, an indication of product type in field 758, an item number for the product in field 760, a unit of measure for the product (such as pounds, ounces, feet, inches) in field 762, an indication of revision version or number in field 764, an indication of quantity in field 766, a selling cost in field 768, and a buying cost in field 770. The field 772 for “Group It” and an upside down triangle enables the data and/or information shown in field or box 748 to be attached to a category to enable the online user to see a collection of products with same purpose and/or meaning.

The image 700 also includes fields 774, 776, 778, 780, 782, 784, and 786. The field 774 can be selected using interactive device 208 to add a discount in computer memory 202 or 222 to the new product referred to in field or box 748. The field 776 can be selected using interactive device 208 to display the data for quick view to enable the store owner to make efficient decisions, on to see which product are on discount now. The field 778 displays information about a discount for the product. The field 780 shows that the discount will last until supplies or stock of the product lasts, or will last from one date to another. The field 782 is for a discount percentage, which is not shown. The fields 784 are for start and end dates for the discount of field 782 to be applied.

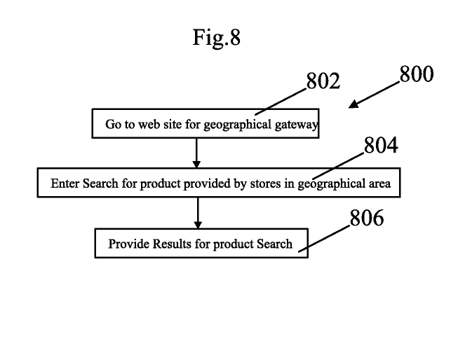

FIG. 8 shows a flow chart 800 of a method in accordance with an embodiment of the present invention. At step 802 a customer, such as a customer using customer computer 200 enters a web site for geographical gateway, such as 114 in FIG. 1, by entering a web site address through interactive device 208 of computer 200. At step 804, the customer performs a search for a product (Provide a screen shot image or refer to one of the previous image 500 shown in FIG. 5, in a specific geographic area. For example the customer may search for a product in a town geographic area, a city, a county, a state, a nation, or the entire world, such as similar to image 500 shown in FIG. 5. The search request at step 804 is supplied by customer computer 200 to server computer 220, which then provides search results back to customer computer 200. The search results may indicate the item, quantity available, physical store at which they are located, including address of physical store, price of item, and various other information.

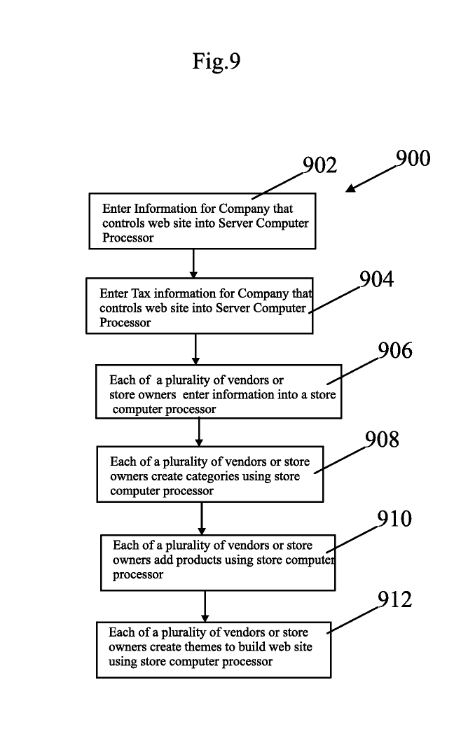

FIG. 9 shows a flow chart 900 of a method for setting up information for a store or vendor on a server web site, in accordance with an embodiment of the present invention. At step 902, a user enters information for a company that controls the server web site into the server computer processor 224 of FIG. 2B, such as through server computer interactive device 228, and this information may be stored in server computer memory 222. At step 904, tax information is entered by a user, using server computer interactive device 228 into server computer processor 224 and this may be stored in server computer memory 222. At step 906, each of a plurality of vendors or store owners may enter information into a store computer processor, each store computer processor similar or identical to the first store computer processor 244 shown in FIG. 2C, through a store computer interactive device, such as 248, and this may be stored in store computer memory, such as 242, and may be transmitted to the server computer 220 and stored in the server computer memory 222.

At step 908 each of the plurality of vendors or store owners may create categories using store computer interactive devices, such as 248 or similar or identical devices, categories are created to assign products under it and also used to assign navigation and promotions in theme. These categories may be stored in store computer memory 242, and also transmitted to the server computer 220 and stored in the server computer memory 222. At step 910 each of a plurality of vendors or store owners may add names or products to a list by using store computer interactive devices, such as 248 or similar or identical devices, and this list of products may be stored in store computer memory 242 and transmitted to server computer 220 and stored in server computer memory 222. At step 912 each of the plurality of vendors or store owners may create themes to build an individual store web site using the store computer interactive devices.

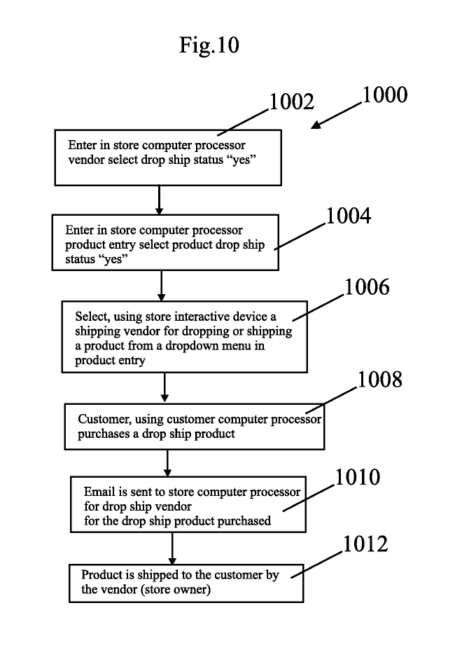

FIG. 10 shows a flow chart 1000 of a method for dropping and/or shipping a product to a customer from a vendor, in accordance with an embodiment of the present invention. At step 1002, a store owner or vendor may use the store computer interactive device 248 to enter into the store computer processor 244 a drop ship status of “yes”. In this case the store owner doesn't have or own the product to be sold, but he directly instructs the vendor to ship the product to the buyer. The drop ship status may be stored in store computer memory 242 and transmitted to server computer 220 and stored in server computer memory 222.

At step 1004, a store owner may use the store computer interactive device 248 to select a product which is dealt by the vendor to whom the dropship status is enabled as “Yes”.

At step 1006 a store owner or vendor may select using store interactive device 248 a shipping vendor for shipping a product.

At step 1008 a customer, using customer computer interactive device 208 and customer computer processor 204 shown in FIG. 2A may purchase a drop ship product, such as the product from steps 1002-1006.

At step 1010 an email may be sent to an email address of the owner of the store corresponding to the store computer 240 for the drop ship product purchased in step 1008. The owner of the store, in response to the email, may then ship to the customer and/or drop the product off at a particular location.

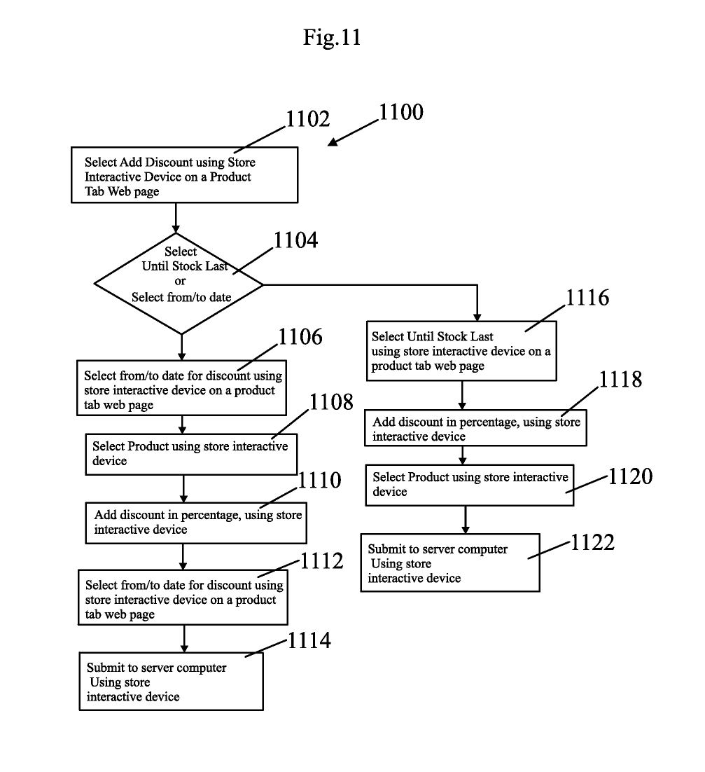

FIG. 11 shows a flow chart 1100 of a method for adding a discount to a product, in accordance with an embodiment of the present invention. At step 1102 a user, using store computer interactive device 248 may select add a discount on a product tab web page of a web site provided by the server computer 220 and displayed on the store computer display 250. At step 1104, the user, using store computer interactive device 248 may select until stock lasts or select from/to date. If the user selects “from/to date” for discount using the interactive device 248, the procedure continues at step 1106. Next, at step 1108, the user may select a product using the interactive device 248. The user may next add in a discount, in percentage, using the store interactive device 248 at step 1110. Next, at step 1112, the user may select a from/to date for the discount using the interactive device 248 through a product tab web page of the web site provided by the server computer 220. The user, may next, at step 1114, submit the name of the product, and related information to the server computer 220, and the server computer may cause the information including discount, concerning the product to appear on an updated version of the web site provided by the server computer 220.

If “select Until Stock last” was selected at step 1104, then the procedure continues to step 1116. At step 1116, the user uses the store interactive device 248 to select the “select until stock last” selection from a product tab web page provided by the server computer 220 to the store computer 240. At step 1118, the user adds a discount, in percentage using the store interactive device 248. At step 1120, a product is selected using store interactive device 248. At step 1122, the product name and information is submitted to the server computer 220 using the store interactive device 248.

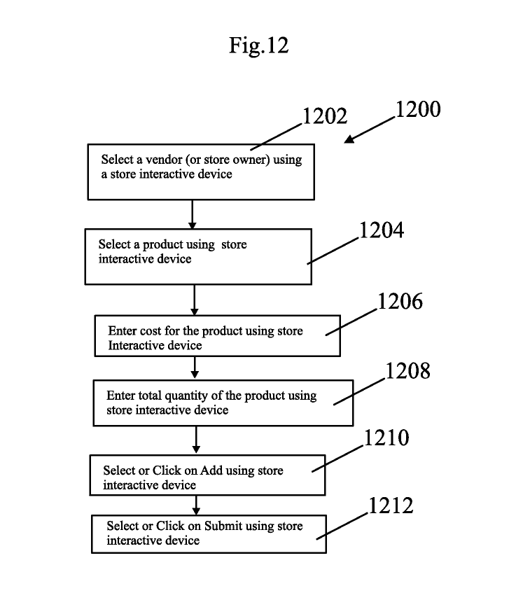

FIG. 12 shows a flow chart 1200 of a method for creating a PO (Purchase Order) for a product, in accordance with an embodiment of the present invention. At step 1202, a vendor (or store owner) is selected from a web site page of a web site provided by the server computer 220 to the store computer 240 by using the store interactive device 248. At step 1204 a product is selected using the store interactive device 248 from the web site page. At step 1206, a cost for the product is entered using store interactive device 248. At step 1208 a total quantity of the product to be purchased from the selected vendor is entered using the store interactive device 248. At step 1210 a user may select or click on text for “ADD” on a web page displayed on store computer display 250 by using the store interactive device 248. At step 1212, a user may cause the name of the product, cost and quantity as entered in steps 1204, 1206, and 1208, respectively, to be sent to the server computer 220 to be added to the server computer memory 222, to be displayed on the web site to be provided by server computer 220 to customer computer 200, by using store interactive device 248.

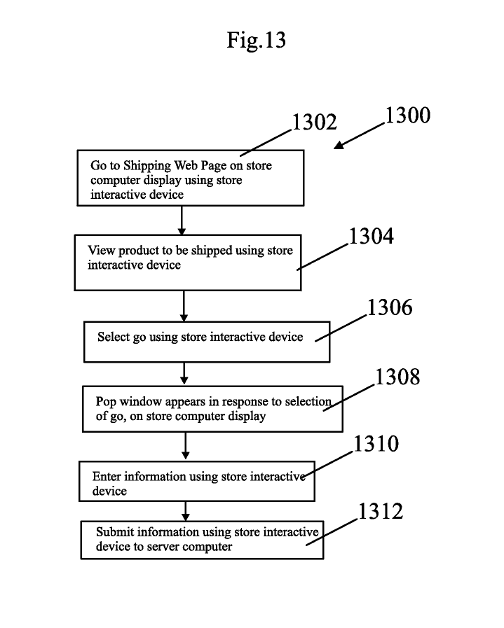

FIG. 13 shows a flow chart 1300 of a method for shipping a product, in accordance with an embodiment of the present invention. At step 1302, a user may go to, or cause a shipping web page of a web site, provided by the server computer 220 to the store computer 240, to be displayed on the store computer display 250. At step 1304, the user may user the store computer interactive device 248 to view a product to be shipped through the web site provided by the server computer 220 to the store computer 240. The user may then select “Go” on the web site, by using the store computer interactive device 248 at step 1306. In response, at step 1308, a pop up window may appear on the store computer display 250. At step 1310, a user may enter information using the store computer interactive device 248, concerning shipping of a product and this information may be submitted to the server computer 220 from the store computer 240, using the store computer interactive device 248.

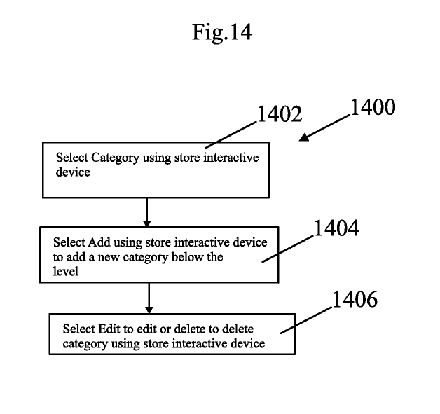

FIG. 14 shows a flow chart 1400 of a method for creating categories of products, in accordance with an embodiment of the present invention. At step 1402 a category of products, may be selected using store computer interactive device 248, on the web site provided by the server computer 220 to the store computer 240. At step 1404, a new category of products can be added by using store computer interactive device 248 on the web site provided by the server computer 220 to the store computer 240; and this new category can be added to the web site by being transmitted to the server computer 220 from the store computer 240, and stored in the server computer memory 222, so that it may be appropriately displayed with the web site provided by server computer 220. At step 1406 a category of products can be edited or deleted using the store interactive device 248 to change a category on the web site provided by the server computer 220. The store computer 240 sends information to the server computer 220 indicating that a category is to be edited or deleted and the server computer 220 stores this information in server computer memory 222 and edits or deletes the category as desired, and the next time the web site is provided to the store computer 240 from the server computer 220, the category is appropriately edited or deleted on the appropriate web site page.

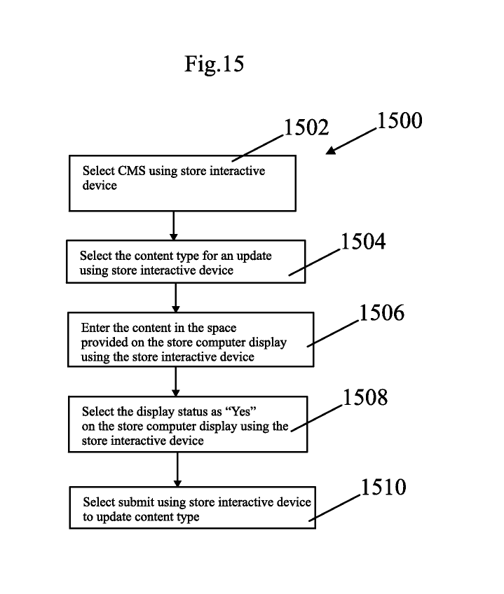

FIG. 15 shows a flow chart 1500 of a method for changing content for the store front website, in accordance with an embodiment of the present invention. At step 1502, a user, using the store interactive device 248 may select “CMS” (Content Management System) on a web site page provided by the server computer 220 to the store computer 240. At step 1504, a user, may select the content type for an update using the store interactive device 248. At step 1506, a user may enter content in a space provided on a web site page of the web site provided by the server computer 220 to the store computer 240 and displayed on the store computer display 250, using the store computer interactive device 248. At step 1508, a user may select the display status as “Yes” on the store computer display 250 on the web site provided by server computer 220 to store computer 240, using the store computer interactive device 248. At step 1510, the user may submit the content information to be updated from the store computer 240 to the server computer 220, using the store interactive device 248.

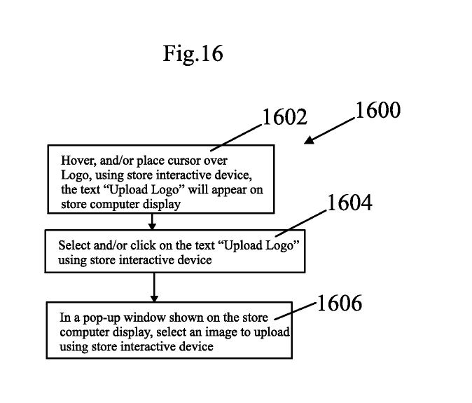

FIG. 16 shows a flow chart 1600 of a method for uploading a logo, in accordance with an embodiment of the present invention. At step 1602, the store interactive device 248 can be used to hover and/or place a cursor over a Logo, which may cause the store computer processor 244 in accordance with instructions provided by web site from server computer 220, to display the text “Upload Logo” on the store computer display 250. At step 1604, the “Upload Logo” on the web site page may be selected and/or clicked on using the store interactive device 248. In response to step 1604, at step 1606, a pop-up window may be displayed on the store computer display 250, and an image to upload may be selected using store computer interactive device 248. The image may be uploaded to the server computer 220 and stored in the server computer memory 222 for display on a web site provided by the server computer 220 for the store relating to the store computer 240.

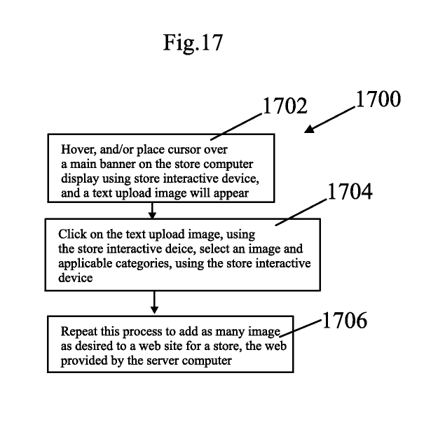

FIG. 17 shows a flow chart 1700 of a method for updating a main banner, in accordance with an embodiment of the present invention. At step 1702, the store computer interactive device 248 may be used to hover and/or place a computer cursor over a main banner on the store computer display 250 and in response a text upload image may appear on the display 250. At step 1704, a user may select and/or click on the text upload image, using the store computer interactive device 248 to select an image and applicable categories for the image. The image may be uploaded to the server computer 220 and stored in the server computer memory 222 so that it becomes associated with a web site to be provided for the store, which relates to the store computer 240. At step 1706, the process or 1702 and 1704 may be repeated for any number of images to be uploaded to the server computer 220.

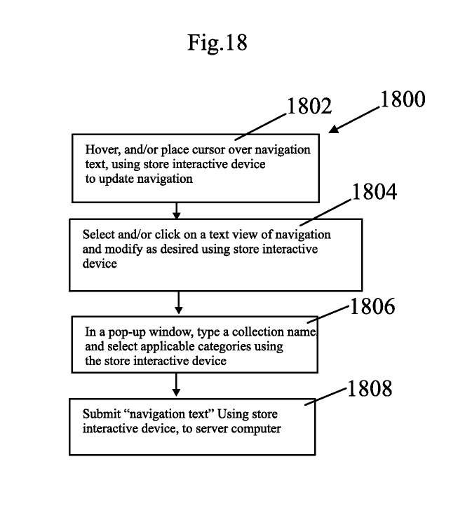

FIG. 18 shows a flow chart 1800 of a method for creating navigation, in accordance with an embodiment of the present invention. At step 1802, the store computer interactive device 248 may be used to hover and/or place a computer cursor over navigation text on the store computer display 250 to update navigation text menu by using this feature. At step 1804, the store computer interactive device 248 may be used to select and/or click on a text view of navigation and modify as desired (navigation is the menu which appears in any website on clicking takes it to the specific page). At step 1806, a collection name can be typed into a pop-up window shown on the store computer display 250 using the store interactive device 248 and applicable categories can be selected using store computer interactive device 248. At step 1808, the changes and update created can be submitted to the server computer 220 from the store computer 240, using store computer interactive device 248. Navigation text can be submitted at step 1808. In addition, in at least one embodiment, the website as provided by the server computer 220 may be programmed to automatically formulate and create menus for a first store and any number of further stores for their respective online stores or web sites.

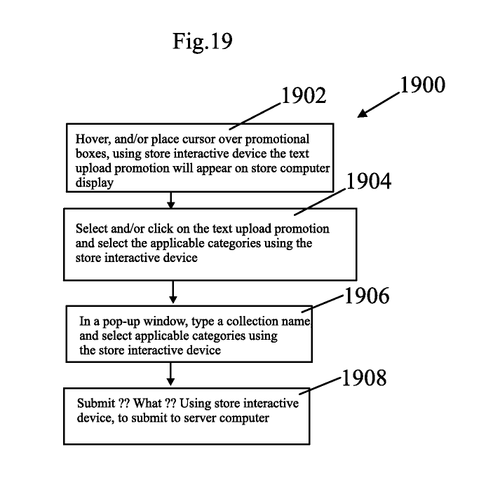

FIG. 19 shows a flow chart 1900 of a method for updating a promotional box, in accordance with an embodiment of the present invention. At step 1902, the store computer interactive device 248 may be used to hover and/or place a computer cursor over promotional boxes on the display 250 to cause upload promotion text to appear on the display 250. At step 1904 the user may use the store computer interactive device 248 to select and/or click on the upload promotion text and to select applicable categories. (categories which are created by the store owner which they assign to every product) At step 1906, in a pop-up window, a collection name can be typed and applicable categories can be selected using the store interactive device 248. At step 1908 the changed and the update created are submitted to the serve computer 220 and stored in the server computer memory 222. A promotional box may be submitted using the store interactive device 248 at step 1908. A submit button may be used enable a customer using the store web site to select a promotional box to view and buy all products associated with this section through the use of customer interactive device 208 of the customer computer 200.

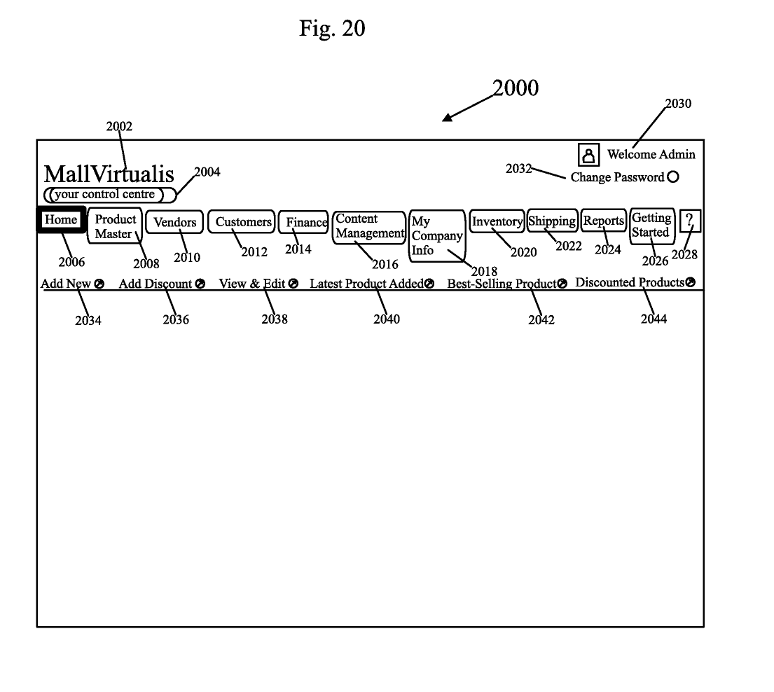

FIG. 20 shows an image 2000 which may be displayed on the first store computer display 250 by the first store computer processor 244 of FIG. 2C in accordance with an embodiment of the present invention, when an administrator of a first store goes to a “mall virtualis” web site of an embodiment of the present invention, and selects an administrator button or field. The image 2000 of FIG. 20 may be optional.

The image 2000 includes fields 2002, 2004, 2006, 2008, 2010, 2012, 2014, 2016, 2018, 2020, 2022, 2024, 2026, 2028, 2030, 2032, 2034, 2036, 2038, 2040, 2042, and 2044. Fields 2002, 2004, and 2030 are text headings. Field 2032 can be selected by an owner or administrator of a first store using the first store computer interactive device 248 to change the password for an administrator of the first store entering the portion of the “mall virtualis” web site allowing various first store parameters to be changed.

An administrator of a first store can use the first store computer interactive device 248 to select or click on any one of fields 2006, 2008, 2010, 2012, 2014, 2016, 2018, 2020, 2022, 2024, 2026, 2028, 2030, 2032, 2034, 2036, 2038, 2040, 2042, and 2044, to cause corresponding web pages to be displayed on the first store computer display 250 by the first store computer processor 244 of FIG. 2C as retrieved from the server computer 220 of FIG. 2B.

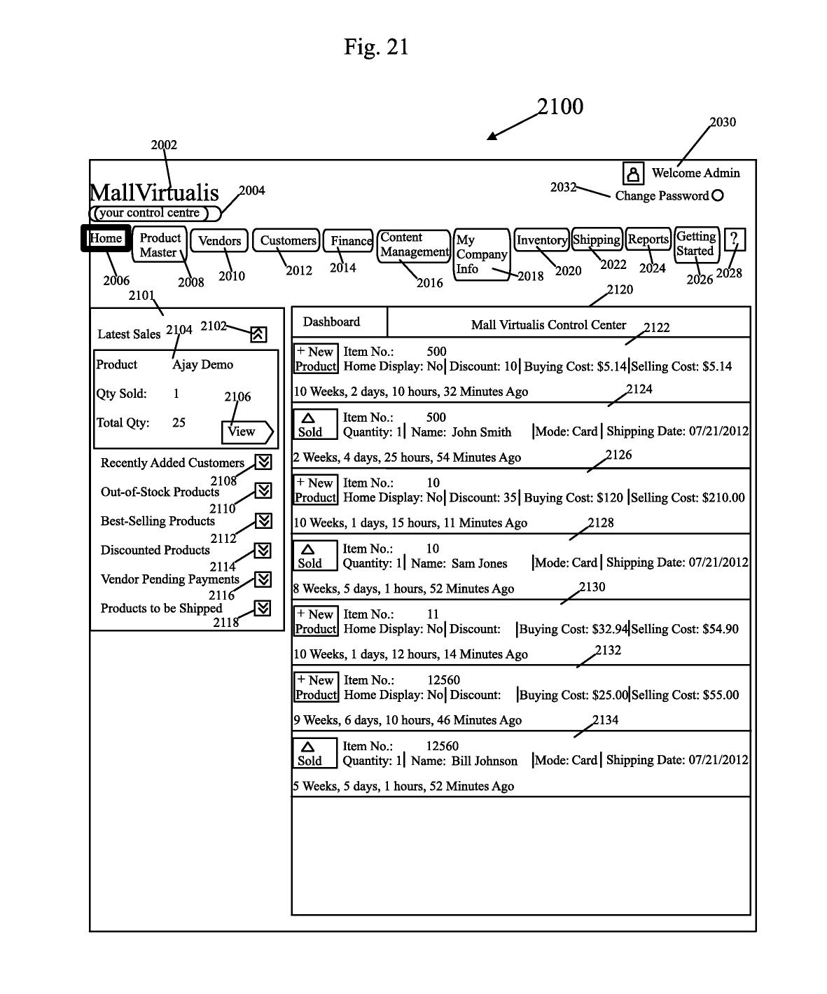

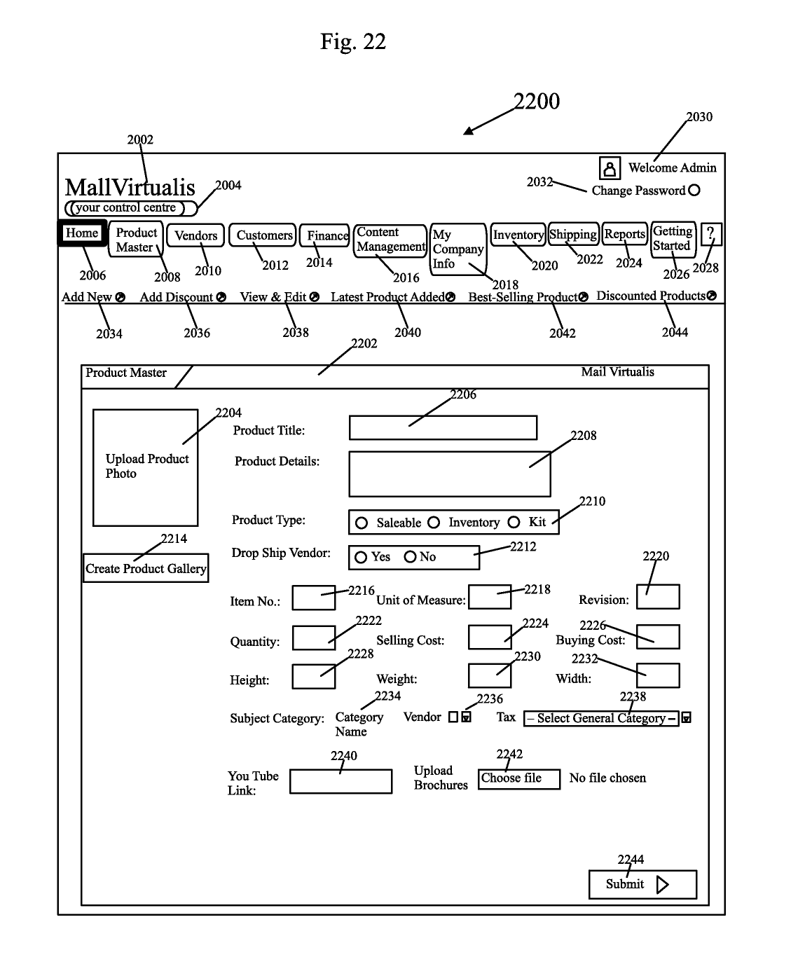

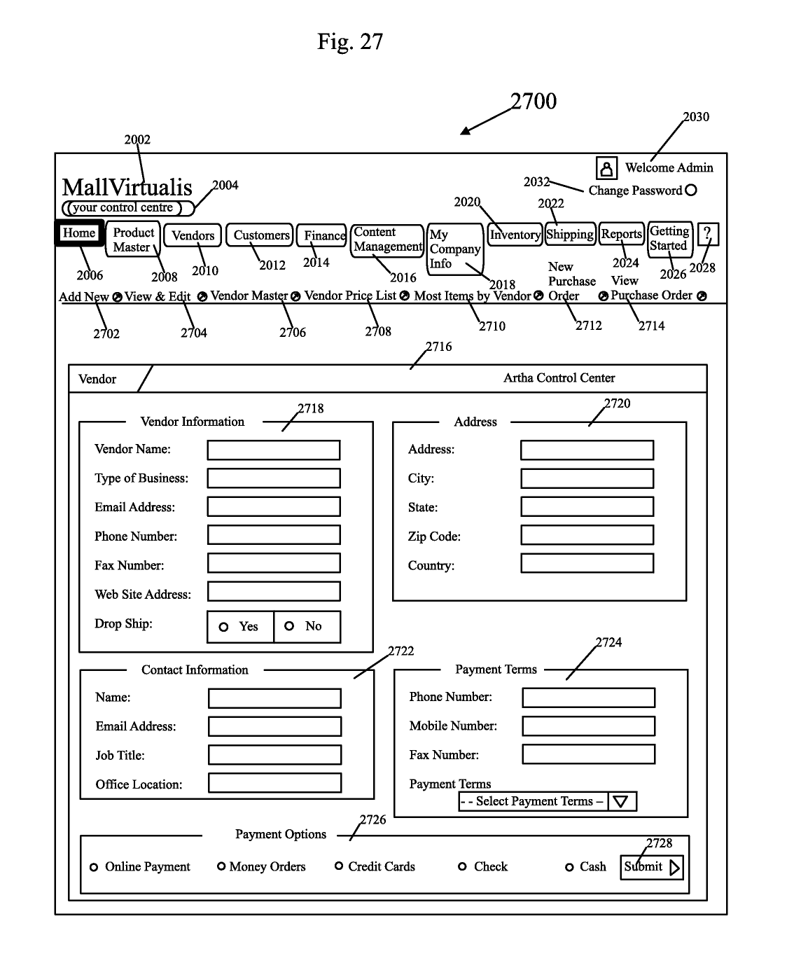

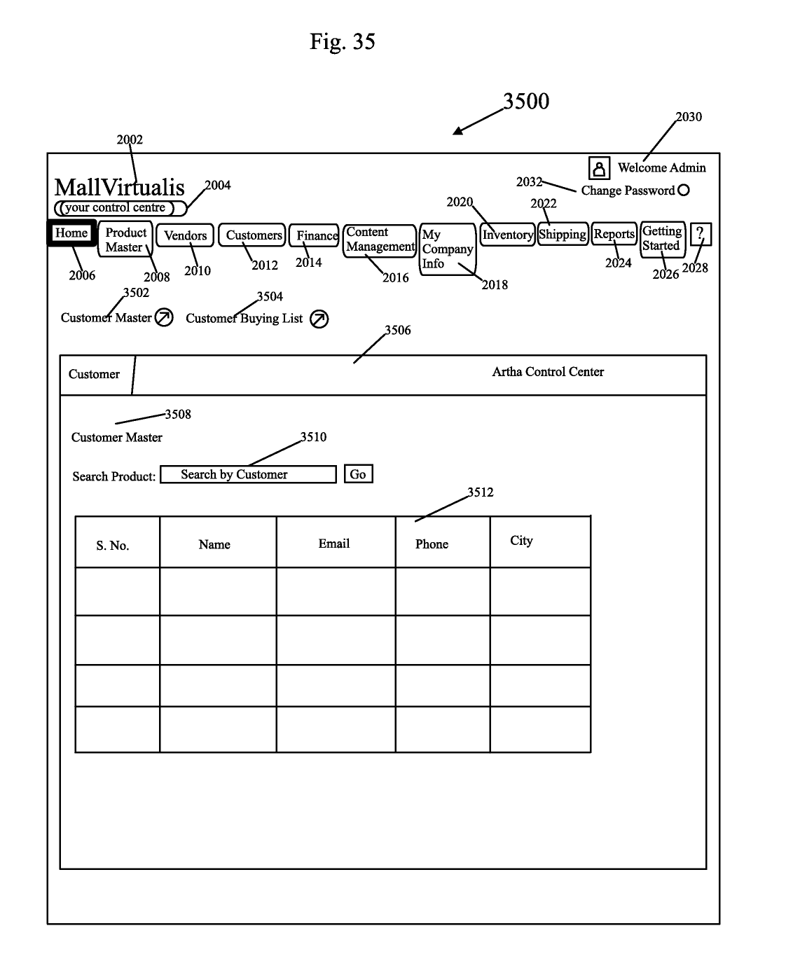

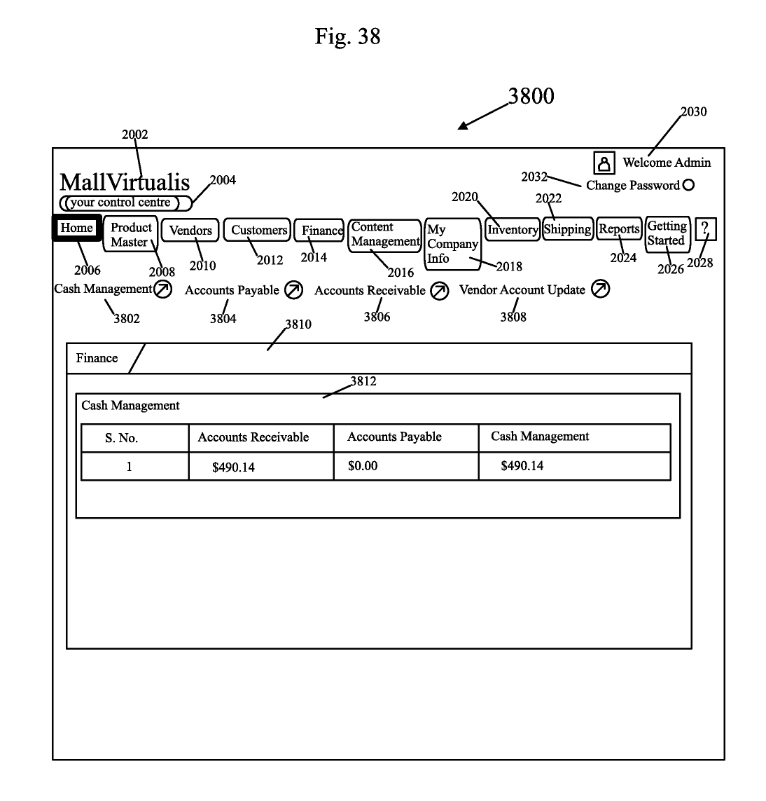

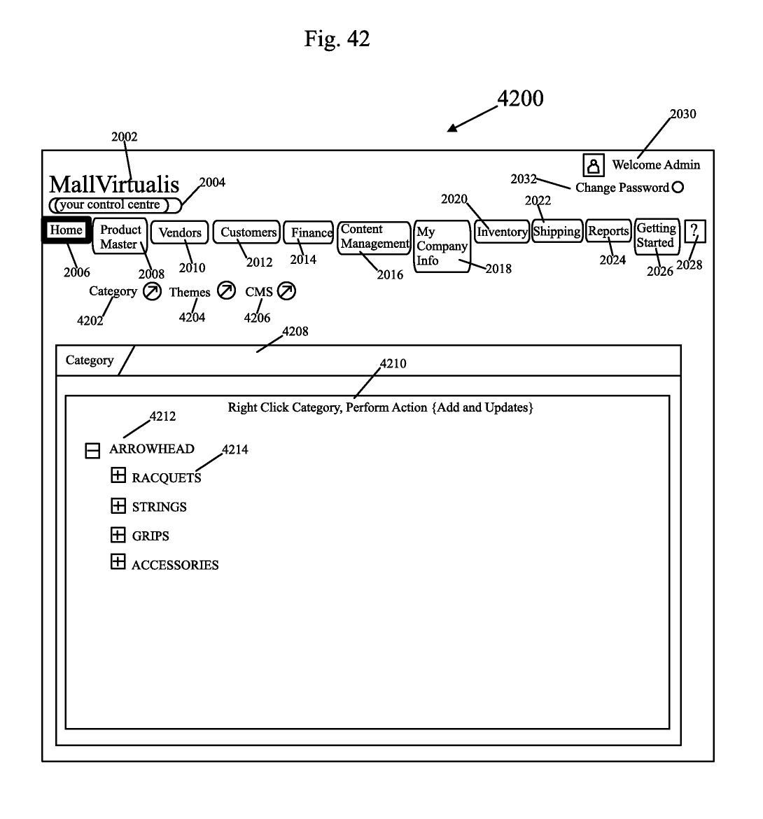

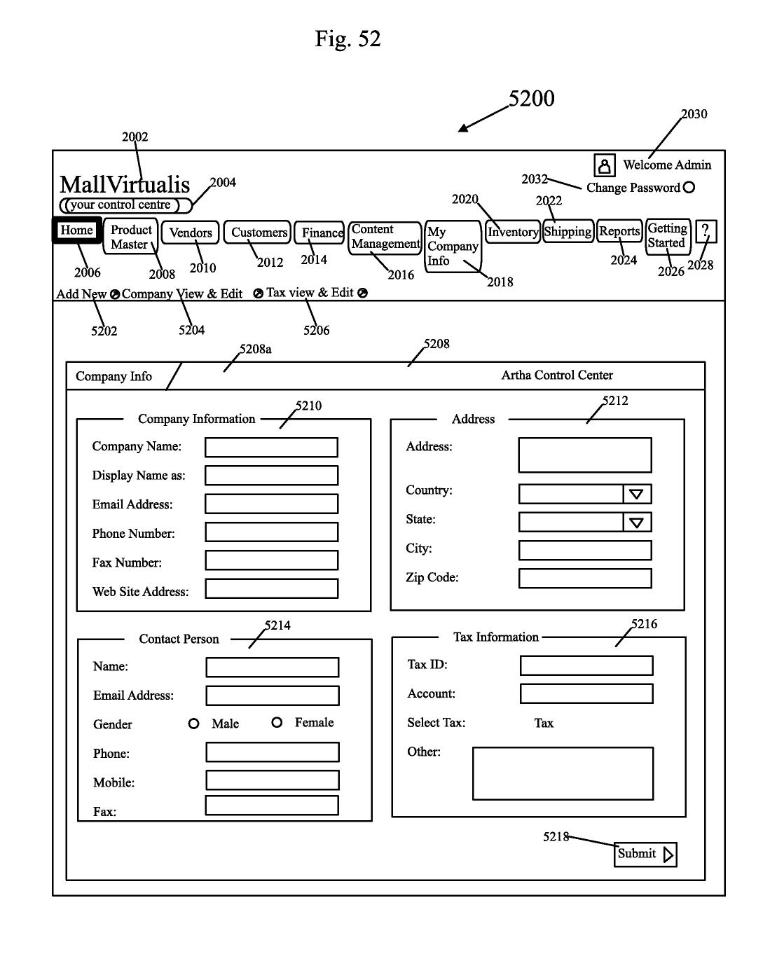

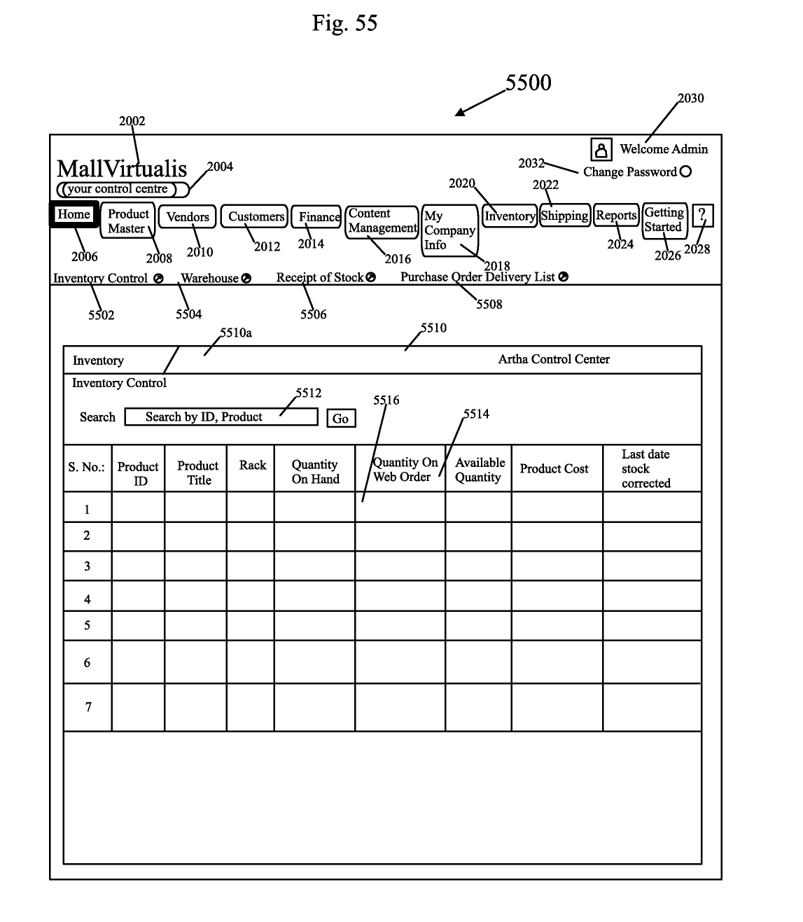

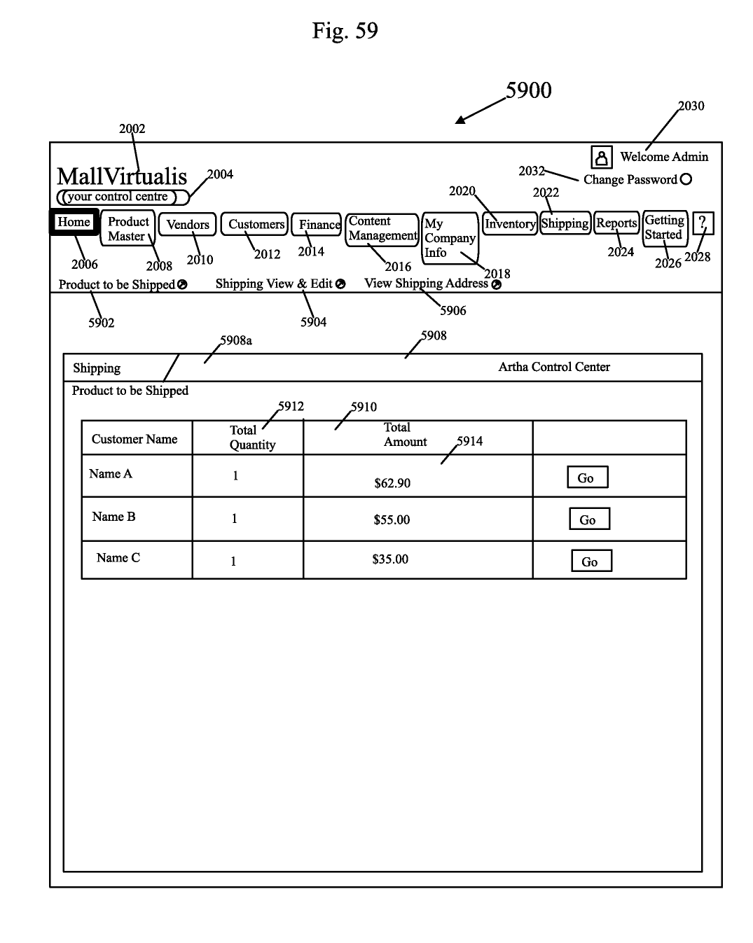

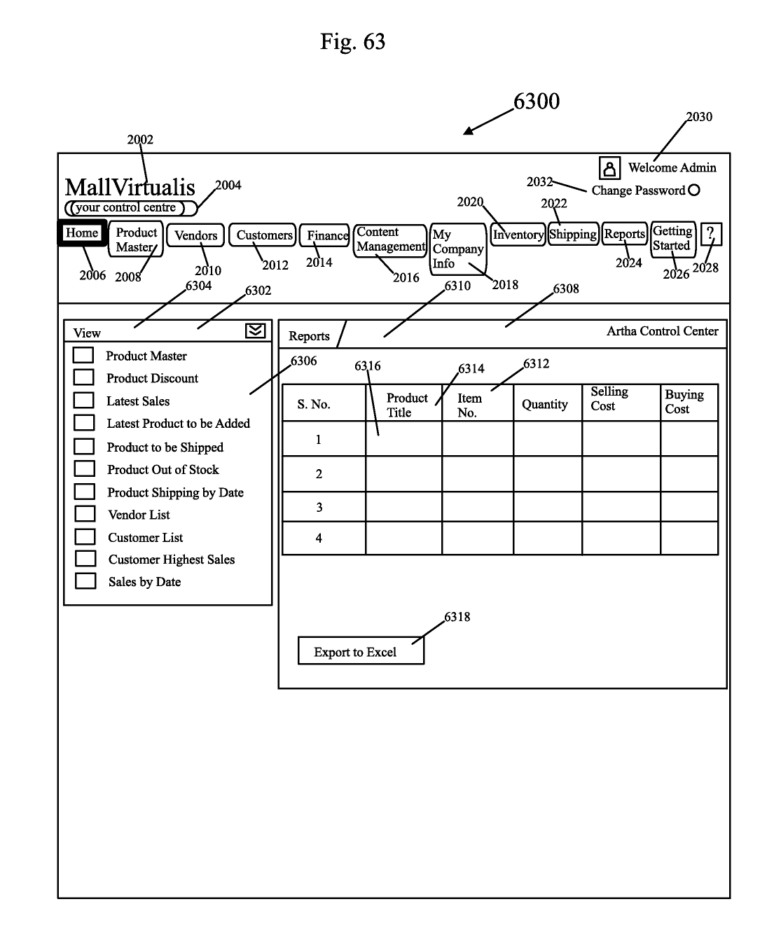

Generally speaking the selection of fields 2006, 2008, 2010, 2012, 2014, 2016, 2018, 2020, 2022, and 2024 using the computer interactive device 248 may cause the computer processor 244 to download from the computer server 220 and display on the computer display 250, images shown in FIG. 21, FIG. 22, FIG. 27, FIG. 35, FIG. 38, FIG. 42, FIG. 52, FIG. 55, FIG. 59, and FIG. 63, respectively, in accordance with an embodiment of the present invention. The fields 2026, 2028, and 2030 may not be used. The field 2032 can be used to logout of the website provided by the server computer 220 to the first store computer 240 on the first store computer display 250.

The image 2100 includes fields 2002, 2004, 2006, 2008, 2010, 2012, 2014, 2016, 2018, 2020, 2022, 2024, 2026, and 2028 which were previously described and explained above with reference to FIG. 20.

The image 2100 also includes box or field 2101 which provides “Latest Sales” information for the first store referred to by FIG. 2C. This latest sales information may be stored in the server computer memory 222 and downloaded to the first store computer memory 242 and displayed on the computer display 250. The box or field 2101 includes an icon 2102 which can be selected to display further sales information. The box or field 2101 includes box or field 2104 which shows sales information for a specific product in this case “Ajay Demo”, and shows quantity of the product sold and totay quantity of the product on hand. The box or field 2104 also includes a button or field 2106 which can be selected using the first store computer interactive device 248 to display a digital photograph of the product on the first store computer display 250 as downloaded from the server computer 220.

The box or field 2101 further includes text and an icon to the right of text for “Recently Added Customers” 2108, “Out of Stock Products” 2110, “Best Selling Products” 2112, “Discounted Products” 2114, “Vendor Pending Payments” 2116, and “Products to be Shipped” 2118. Each icon and/or text of 2108, 2110, 2112, 2114, 2116, and 2118 can be selected to display a list of information corresponding to the text. For example, the icon to the right of “Recently Added Customers” when selected using the first store computer interactive device 248 displays a list of recently added customers on the first store computer display 250 as downloaded from the memory 222 of the server computer 220 or from the memory 242 of the first store computer 240.

The image 2100 further includes a field or box 2120 for a “Dashboard” of “Mall Virtualis Control Center”. The field or box 2120 includes fields or rows 2122, 2124, 2126, 2128, 2130, 2132, and 2134, each of which have information about a new product or a product sold. For each row featuring a new product, the item no., whether a home display is available, discount, buying cost, selling cost and how long ago the product became available from the first store, are listed. For each row featuring a sold product, the item no., the quantity sold, the name of the customer who purchased the product, the mode of payment, the shipping date, and how long ago the product was sold, are listed.

FIG. 22 shows an image 2200 which may be displayed on the first store computer display 250 by the first store computer processor 244 of FIG. 2C in accordance with an embodiment of the present invention, when an administrator of a first store selects the field 2008 shown in FIG. 20, by using the first store computer interactive device 248.

The image 2200 includes fields 2002, 2004, 2006, 2008, 2010, 2012, 2014, 2016, 2018, 2020, 2022, 2024, 2026, and 2028 which were previously described and explained with reference to FIG. 20. The image 2200 also includes fields 2034, 2036, 2038, 2040, 2042, and 2044 which were also previously described and explained with reference to FIG. 20.

The image 2200 in FIG. 22 also includes box or window 2202 dealing with “Product Master” of the “Mall Virtualis” web site. The box or window 2202 includes fields 2204, 2206, 2008, 2210, 2212, 2214, 2216, 2218, 2220, 2222, 2224, 2226, 2228, 2230, 2232, 2234, 2236, 2238, 2240, 2242, and 2244.

Field 2204 can be selected using first store computer interactive device 248 to upload a product photo to the server computer 220. Fields 2206, 2208, and 2210 allow a user of first store computer interactive device 248 to enter product title, details, and product type information into the boxes shown next to the corresponding description. Similarly, the fields or boxes 2216, 2218, 2220, 2222, 2224, 2226, 2228, 2230, and 2232 allow a user of first store computer interactive device 248 to enter further information about a specific product. A user may also enter category name of the product, vendor who provides the product and general tax category for the product (such as taxable or not taxable item) in box or fields 2234, 2236, and 2238, respectively using first store computer interactive device 248. A You tube link for the product can be entered in field 2240, and computer files for brochures for the specific product can be chosen and downloaded by entering in field 2242 using the first store computer interactive device 248. All of the information in the box 2202 for a single specific product can be submitted to the server computer 220 from the first store computer 240 to upload to a first store web site by selecting the “submit” field 2244.

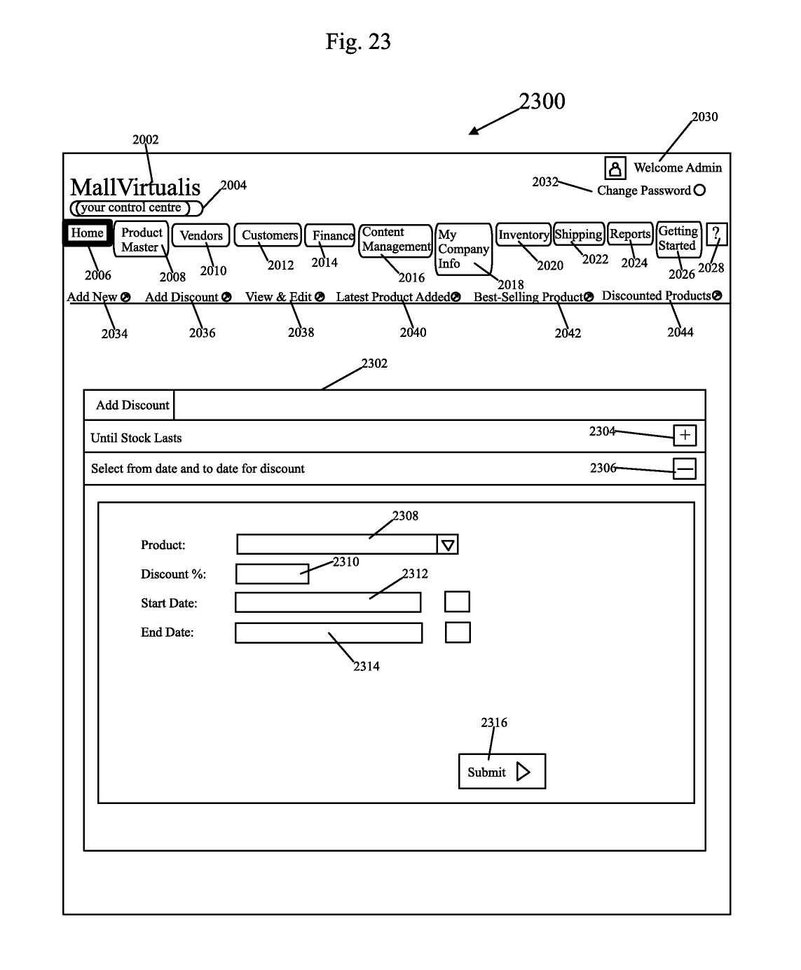

FIG. 23 shows an image 2300 which may be displayed on the first store computer display 250 by the first store computer processor 244 of FIG. 2C in accordance with an embodiment of the present invention, when an administrator of a first store selects the field 2008 shown in FIG. 20, by using the first store computer interactive device 248.

The image 2300 includes fields 2002, 2004, 2006, 2008, 2010, 2012, 2014, 2016, 2018, 2020, 2022, 2024, 2026, and 2028 which were previously described and explained with reference to FIG. 20. The image 2300 also includes fields 2034, 2036, 2038, 2040, 2042, and 2044 which were also previously described and explained with reference to FIG. 20.

The image 2300 also includes field or box 2302. The image 2300 is displayed by the first store computer processor 244 on the display 250, in response to selection of the field 2036 by a user using first store computer interactive device 248.

The field or box 2302 includes field or box 2304 which can be selected using interactive device 248 to set a discount for a product lasting until the stock of that specific product at the first store runs out. The field or box 2302 also includes field or box 2306 which can be selected using interactive device 248 to set a discount for a product lasting from a start date to an end date. The specific product for the discount can be selected or entered through field 2308, the discount percentage can be entered in box 2310, and the start date and end date can be entered in fields or boxes 2312 and 2314, respectively. All of the specific product information for the discount can be submitted by selecting submit field or button 2316, using interactive device 248 which causes the discount information to be uploaded from the first store computer 240 to the server computer 220 and then stored in the server computer memory 222 and this can be incorporated in the web site for the first store provided by the server computer 220. The discount information can also be stored on store computer memory 242.

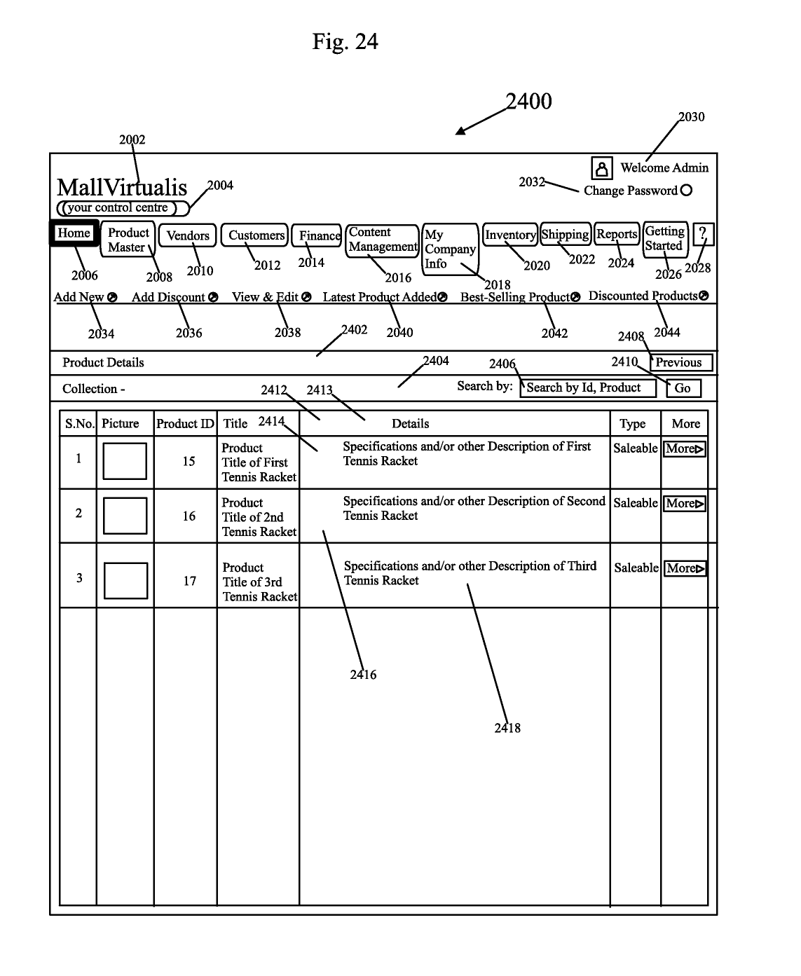

FIG. 24 shows an image 2400 which may be displayed on the first store computer display 250 by the first store computer processor 244 of FIG. 2C in accordance with an embodiment of the present invention, when an administrator of a first store selects the field 2038 for “View & Edit” shown in FIG. 20, by using the first store computer interactive device 248.

The image 2400 includes fields 2002, 2004, 2006, 2008, 2010, 2012, 2014, 2016, 2018, 2020, 2022, 2024, 2026, and 2028 which were previously described and explained with reference to FIG. 20. The image 2400 also includes fields 2034, 2036, 2038, 2040, 2042, and 2044 which were also previously described and explained with reference to FIG. 20.

The image 2400 also includes box or field 2402 concerning “Product Details” of a plurality of products which are available in the first store to which the first store computer 240 relates. The box or field 2402 includes a “Previous” button or field 2408 which allows the user of interactive device 248 to select field 2408 and go back to a previous screen.

The box or field 2402 also includes a row 2404 including the text “Collection” and a search entry box 2406 in which a product name or title and/or a product identification (ID) can be entered and then the button “Go” 2410 can be selected using interactive device 248 to search for a particular product or products. The results of such a search are shown in field or box 2412.

The box or field 2412 includes a headings row 2413 and rows 2414, 2416, and 2418. Each of rows 2414, 2416, and 2418 specifies information concerning a specific product, which has been found in the search executed using field 2406 and field 2410. The button “more” under the column labeled “more” can be selected for the appropriate product to obtain more information about that product.

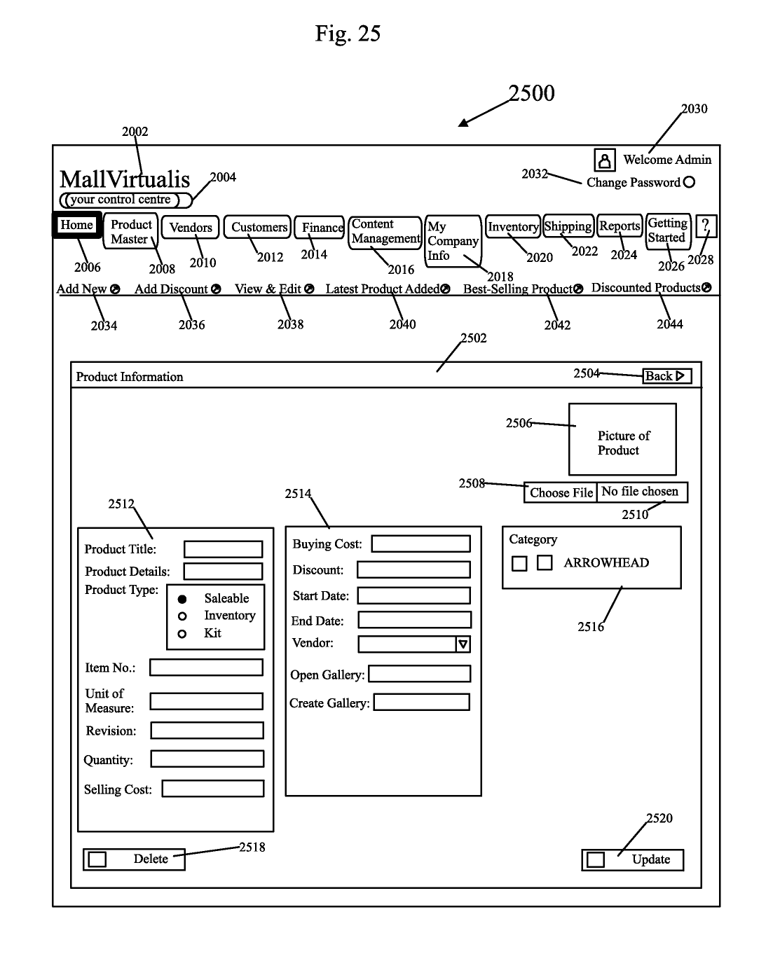

FIG. 25 shows an image 2500 which may be displayed on the first store computer display 250 by the first store computer processor 244 of FIG. 2C in accordance with an embodiment of the present invention, when an administrator of a first store selects the field “more” button on either of 2414, 2416 or 2418 shown in FIG. 20, by using the first store computer interactive device 248.

The image 2500 includes fields 2002, 2004, 2006, 2008, 2010, 2012, 2014, 2016, 2018, 2020, 2022, 2024, 2026, and 2028 which were previously described and explained with reference to FIG. 20. The image 2500 also includes fields 2034, 2036, 2038, 2040, 2042, and 2044 which were also previously described and explained with reference to FIG. 20.

The image 2500 also includes field or box 2502 for “Product Information”. The field or box 2502 includes a back button or field 2504 which goes back to a previous screen. The field or box 2502 also includes a boxes or fields 2512 and 2514 through which a user, using first store computer interactive device 248 can enter information for a specific product. The box or field 2516 also allows a user to enter information regarding the specific product. The field 2506 shows a picture of the product and the fields 2508 or 2510 can be chosen to indicate that a file for the product to be stored in computer memory such as server computer 222 or first store computer memory 242.

A user can select field 2518 using the first store computer interactive device 248 to delete information regarding this product, or select field 2520 to update information regarding this product (whose characteristics are shown in fields or boxes 2512, 2514, and 2516) in server computer memory 222 and/or the first store computer memory 242.

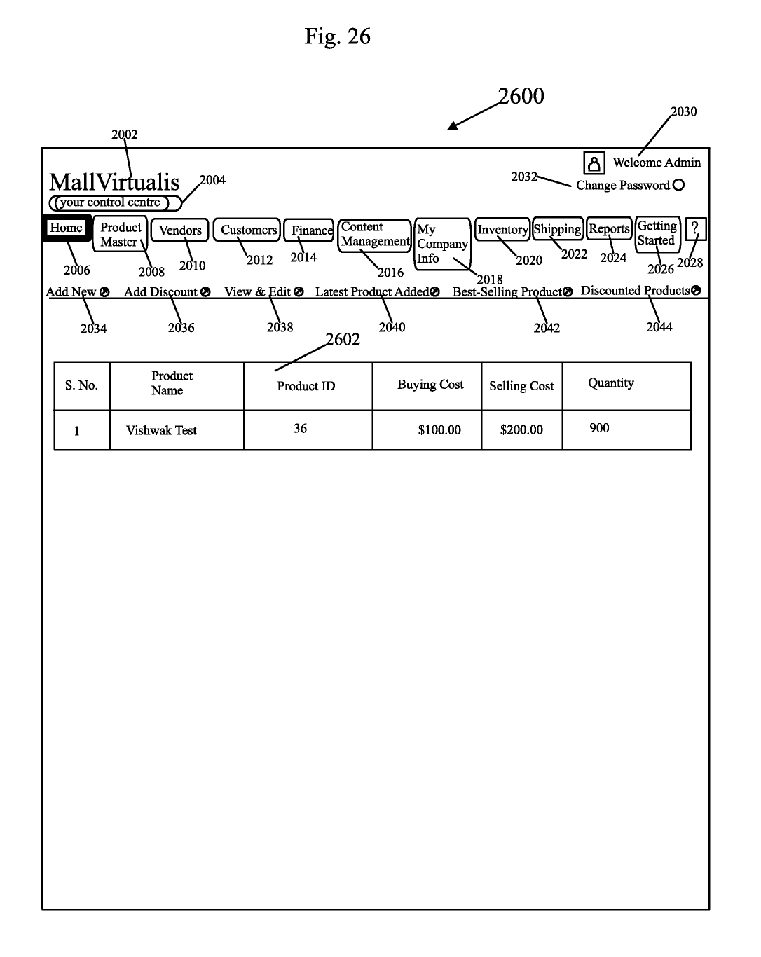

FIG. 26 shows an image 2600 which may be displayed on the first store computer display 250 by the first store computer processor 244 of FIG. 2C in accordance with an embodiment of the present invention, when an administrator of a first store selects the field 2040 for “Latest Product Added” shown in FIG. 20, by using the first store computer interactive device 248.

The image 2600 includes fields 2002, 2004, 2006, 2008, 2010, 2012, 2014, 2016, 2018, 2020, 2022, 2024, 2026, and 2028 which were previously described and explained with reference to FIG. 20. The image 2600 also includes fields 2034, 2036, 2038, 2040, 2042, and 2044 which were also previously described and explained with reference to FIG. 20.

The image 2600 includes a table or field 2602 which provides information concerning “Latest Product Added”. The table includes a heading row and a data row. The data may include an S. No. or other identification number for the product, a product name, a product identification, a buying cost, a selling cost and a number of available quantity at the first store.

FIG. 27 shows an image 2700 which may be displayed on the first store computer display 250 by the first store computer processor 244 of FIG. 2C in accordance with an embodiment of the present invention, when an administrator of a first store selects the field 2706 for “Vendor Master” shown in FIG. 27, by using the first store computer interactive device 248.

The image 2700 includes fields 2002, 2004, 2006, 2008, 2010, 2012, 2014, 2016, 2018, 2020, 2022, 2024, 2026, and 2028 which were previously described and explained with reference to FIG. 20. The image 2700 also includes fields 2702, 2704, 2706, 2708, 2810, 2712, and 2714, each of which can be selected to display a specific web page or pop up window as will be described.

The image 2700 also includes field or box 2716 for “Vendor Master” information, displayed by selecting field 2706 using computer interactive device 248. The field or box 2716 includes box 2718 for entry of information for a specific vendor, box 2720 for entry of address information for the specific vendor, box 2722 for entry of contact information for the specific vendor, and box 2724 for entry of payment term information for the specific vendor. The field or box 2716 also includes payment options which can be entered for the specific vendor. The field or box 2716 includes a “Submit” button 2718 which can be selected using the first store computer interactive device 248 to cause all of the information entered into the empty boxes or fields or boxes 2718, 2720, 2722, 2724, and 2726, to be uploaded to the server computer 220 and stored in the server computer memory 222 and in the first store computer memory 242.

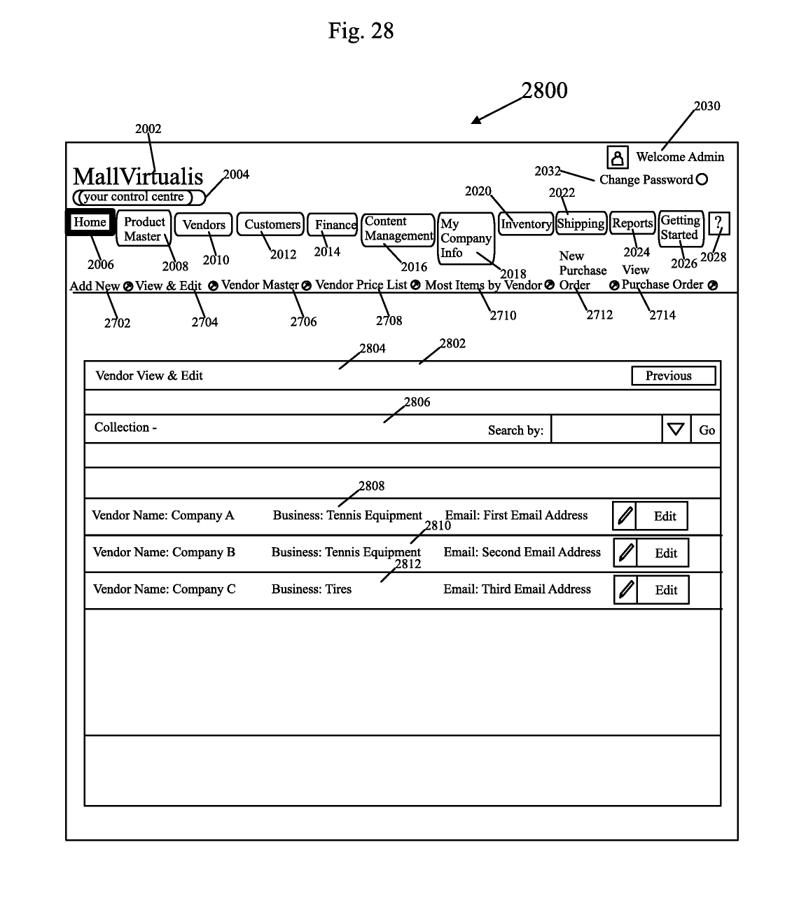

FIG. 28 shows an image 2800 which may be displayed on the first store computer display 250 by the first store computer processor 244 of FIG. 2C in accordance with an embodiment of the present invention, when an administrator of a first store selects the field 2704 for “View & Edit” shown in FIG. 27, by using the first store computer interactive device 248.

The image 2800 includes fields 2002, 2004, 2006, 2008, 2010, 2012, 2014, 2016, 2018, 2020, 2022, 2024, 2026, and 2028 which were previously described and explained with reference to FIG. 20. The image 2800 also includes fields 2702, 2704, 2706, 2708, 2810, 2712, and 2714, referred to in FIG. 27.

The image 2800 further includes field or box 2802. The field or box 2802 includes a row 2804 which includes text and a “Previous” button for selecting to go the previous screen. The field or box 2802 also includes a row 2806 referring to a “Collection” search, which includes an empty search field next to “Search by” into which can be entered a search term, as well as an upside arrow for browsing through search items, and a “Go” button for causing the first store computer processor 244 to execute a search through the server computer 220. The search results in this case, are shown in rows 2808, 2810, and 2812. Each or rows 2808, 2810, and 2812 includes a vendor company, the business they are in, the email address of the company, and an edit button which can be selected to edit information about the particular vendor company.

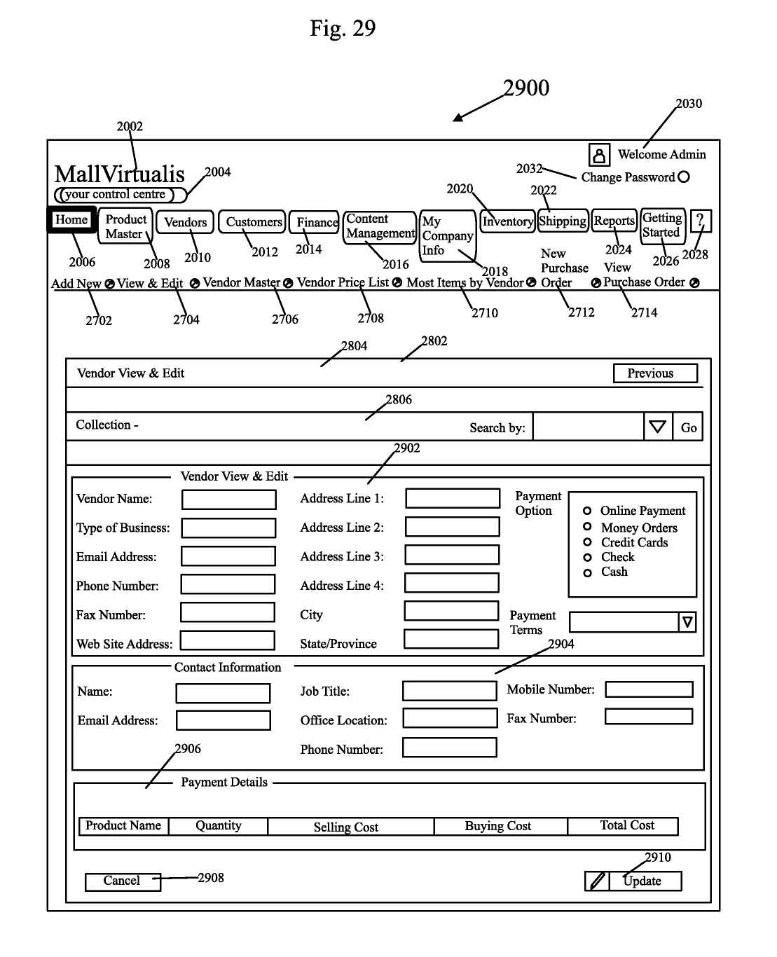

FIG. 29 shows an image 2900 which may be displayed on the first store computer display 250 by the first store computer processor 244 of FIG. 2C in accordance with an embodiment of the present invention, when an administrator of a first store selects the field 2704 for “View & Edit” shown in FIG. 27, by using the first store computer interactive device 248 and then selects one of the Edit buttons of rows 2808, 2810, and 2812 shown in FIG. 28.

The image 2900 includes fields 2002, 2004, 2006, 2008, 2010, 2012, 2014, 2016, 2018, 2020, 2022, 2024, 2026, and 2028 which were previously described and explained with reference to FIG. 20. The image 2900 also includes fields 2702, 2704, 2706, 2708, 2810, 2712, and 2714, referred to in FIG. 27.

The image 2900 includes fields or boxes 2802, 2804, and 2806 previously shown in FIG. 28. The image 2900 also includes field or box 2902 which provides entry boxes in which information concerning a specific vendor can be entered. The image 2900 also includes box or field 2904 which provide entry boxes in which contact information regarding a specific vendor can be entered, and payment details box or field which allows entry of payment details information. The image 2900 includes a cancel button 2908 which can be selected using the first store computer interactive device 248 to cancel entry of the information in image 2900. The image 2900 also includes an update button 2910 which can be selected using the first store computer interactive device 248 to cause the first store computer 240 to upload the information regarding the specific vendor entered in FIG. 29 to the server computer 220 and to store the information on the server computer memory 222 for use on the first store web site.

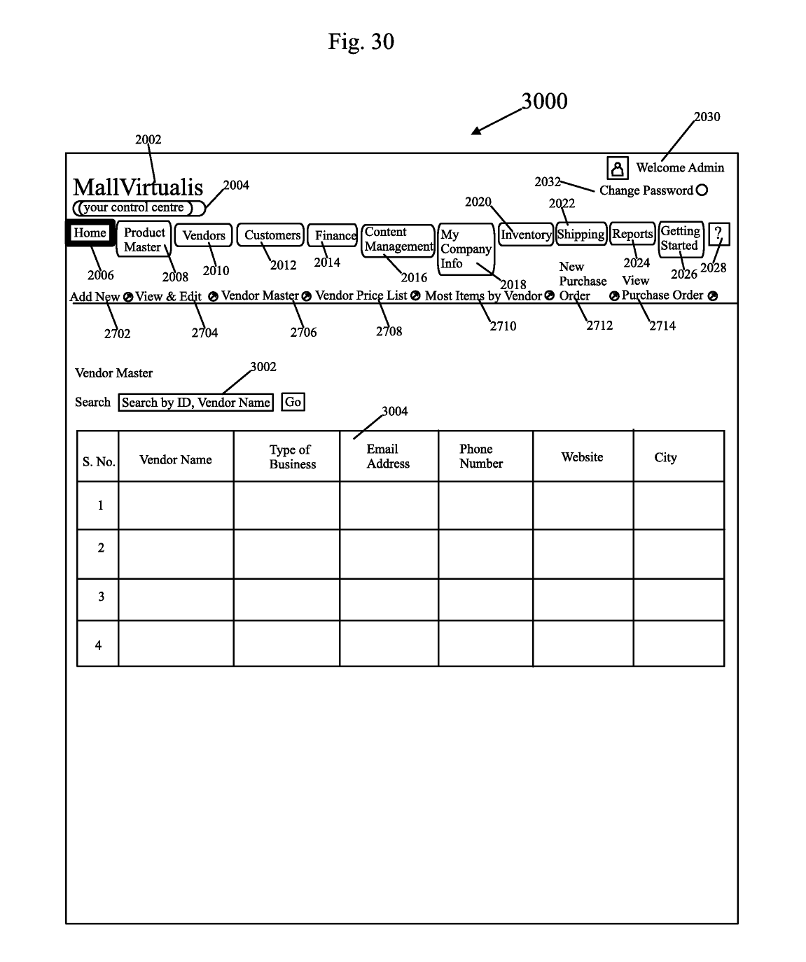

FIG. 30 shows an image 3000 which may be displayed on the first store computer display 250 by the first store computer processor 244 of FIG. 2C in accordance with an embodiment of the present invention, when an administrator of a first store selects the field 2706 for “Vendor Master” shown in FIG. 27, by using the first store computer interactive device 248.

The image 3000 includes fields 2002, 2004, 2006, 2008, 2010, 2012, 2014, 2016, 2018, 2020, 2022, 2024, 2026, and 2028 which were previously described and explained with reference to FIG. 20. The image 3000 also includes fields 2702, 2704, 2706, 2708, 2810, 2712, and 2714, referred to in FIG. 27.

The image 3000 also includes a search entry box 3002 in which a vendor name or vendor identification can be entered and then “Go” button to the right can be selected using the first store computer interactive device 248 to display a table 3004, which is a list vendors which are under the vendor name.

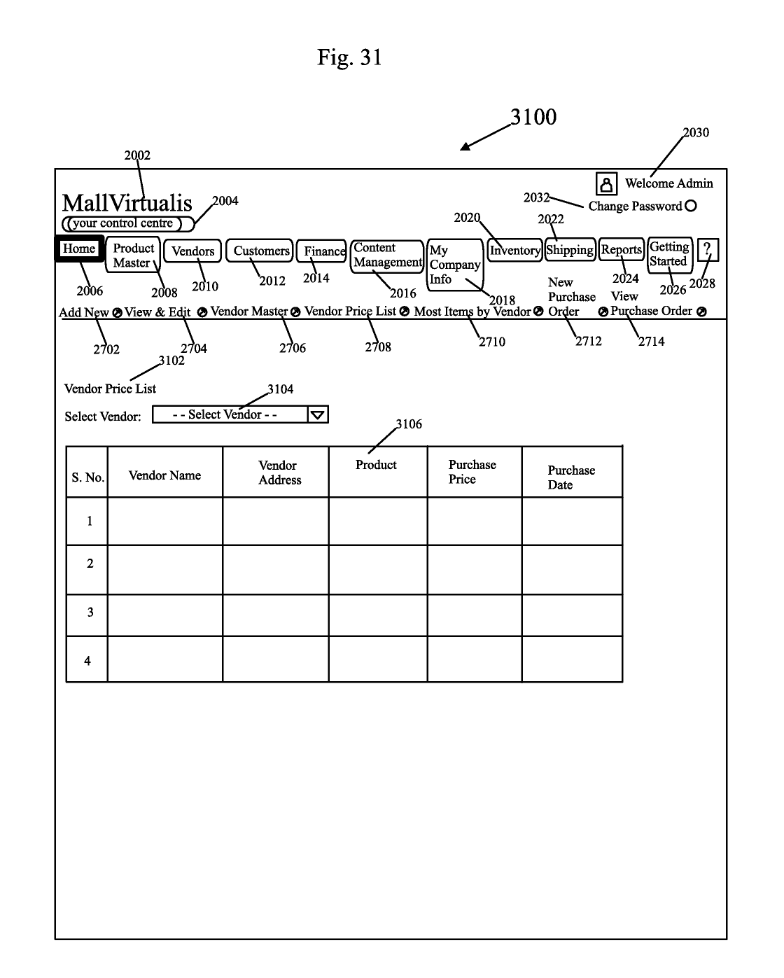

FIG. 31 shows an image 3100 which may be displayed on the first store computer display 250 by the first store computer processor 244 of FIG. 2C in accordance with an embodiment of the present invention, when an administrator of a first store selects the field 2708 for “Vendor Price List” shown in FIG. 27, by using the first store computer interactive device 248.

The image 3100 includes fields 2002, 2004, 2006, 2008, 2010, 2012, 2014, 2016, 2018, 2020, 2022, 2024, 2026, and 2028 which were previously described and explained with reference to FIG. 20. The image 3100 also includes fields 2702, 2704, 2706, 2708, 2810, 2712, and 2714, referred to in FIG. 27.

The image 3100 also includes text “Vendor Price List” 3102. The image 3100 also includes an entry box and upside arrow 3104 for selecting a vendor name or browsing for a vendor name. The image 3100 also includes a table 3106 of prices and other information about a plurality of products. The table 3106 includes a first row which is a headings row, and a plurality of further rows which, although shown blank in the second through sixth columns would typically include information regarding a plurality of products which would be stored in server computer memory 222 and/or first store computer memory 242.

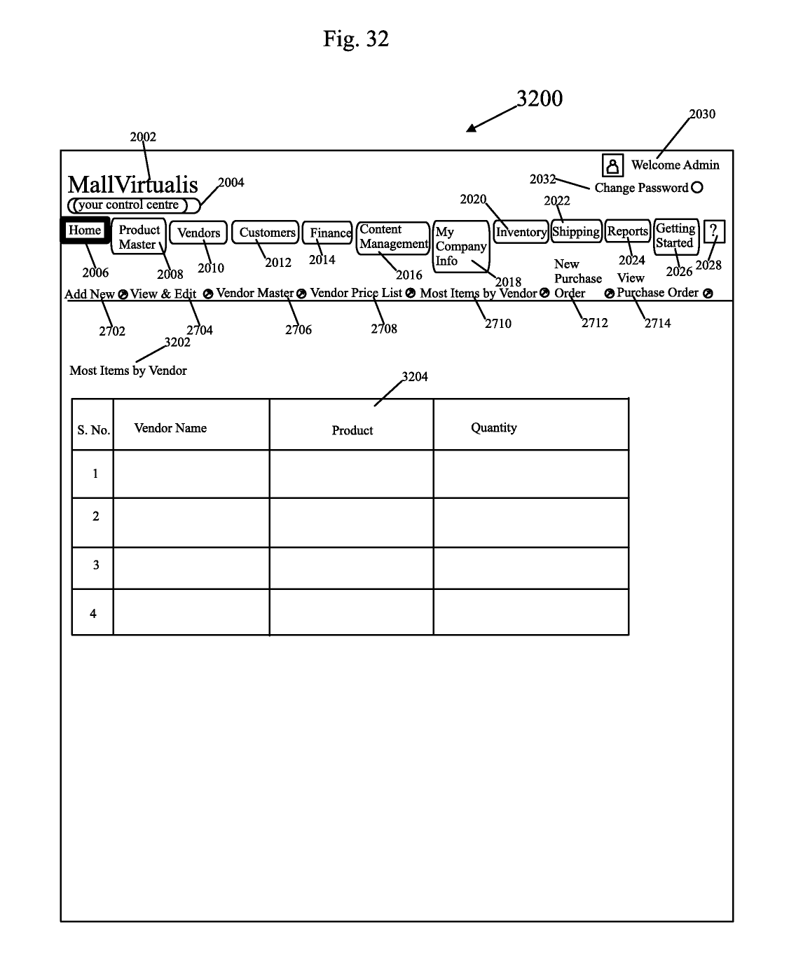

FIG. 32 shows an image 3200 which may be displayed on the first store computer display 250 by the first store computer processor 244 of FIG. 2C in accordance with an embodiment of the present invention, when an administrator of a first store selects the field 2710 for “Most Items by Vendor” shown in FIG. 27, by using the first store computer interactive device 248.

The image 3200 includes fields 2002, 2004, 2006, 2008, 2010, 2012, 2014, 2016, 2018, 2020, 2022, 2024, 2026, and 2028 which were previously described and explained with reference to FIG. 20. The image 3200 also includes fields 2702, 2704, 2706, 2708, 2810, 2712, and 2714, referred to in FIG. 27.

The image 3200 also includes text “Most Items by Vendor” 3202. The image 3200 also includes a table 3204 of a plurality of products, wherein the product which is sold most by a vendor would be listed in the second row (below the headings row). The table 3204 includes a first row which is a headings row, and a plurality of further rows which, although shown blank in the second through fourth columns would typically include information regarding a plurality of products which would be stored in server computer memory 222 and/or first store computer memory 242. The first data row in table 3204 which include information about the best selling product, the second data row in table 3204 information about the next best selling product, the third data row information about the next best selling product, and the fourth data row information about the next best selling product.

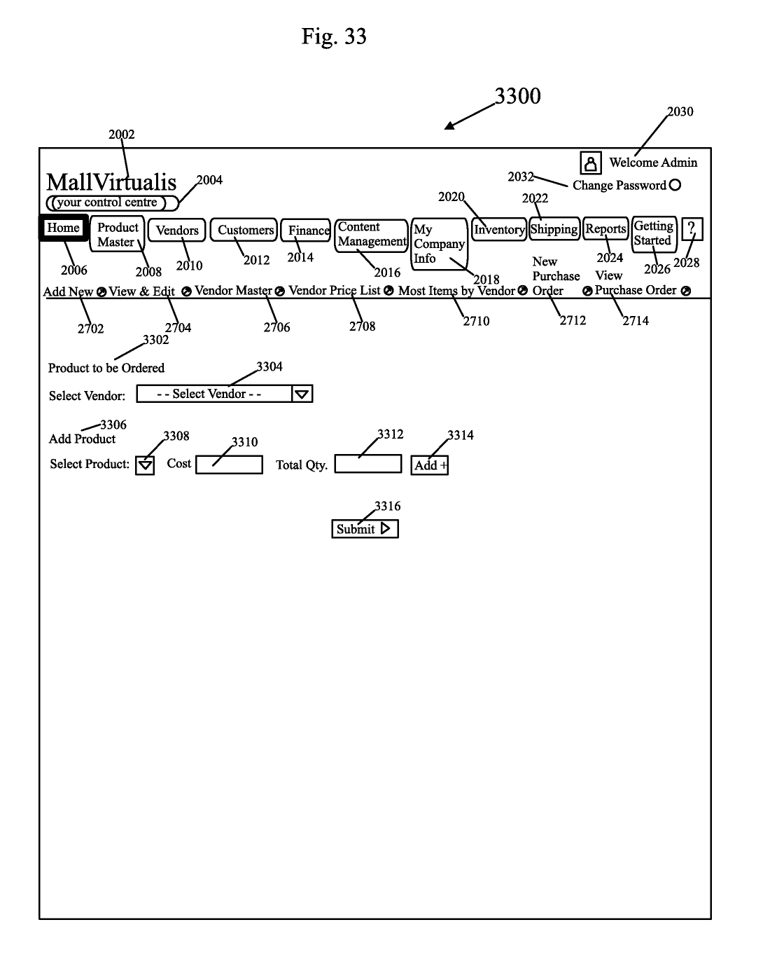

FIG. 33 shows an image 3300 which may be displayed on the first store computer display 250 by the first store computer processor 244 of FIG. 2C in accordance with an embodiment of the present invention, when an administrator of a first store selects the field 2712 for “New Purchase Order” shown in FIG. 27, by using the first store computer interactive device 248.

The image 3300 includes fields 2002, 2004, 2006, 2008, 2010, 2012, 2014, 2016, 2018, 2020, 2022, 2024, 2026, and 2028 which were previously described and explained with reference to FIG. 20. The image 3300 also includes fields 2702, 2704, 2706, 2708, 2810, 2712, and 2714, referred to in FIG. 27.

The image 3300 further includes text for “Product to be Ordered” 3302. The image 3300 also includes search entry box and upside arrow 3304 for searching and/or browsing using the first store computer interactive device 248 to select a specific vendor.

The image 3300 further includes a field 3306 for “Add Product”. The image 3300 further includes a field 3308 for selecting a product, field 3310 for entering the cost of the product, field 3312 for entering the quantity of the product available at the first store, and field or button 3314 for selecting to indicate that the product should be added to computer memory, and finally field or button 3316 for “Submit” to select with store computer interactive device 248 to submit the information from fields 3304, 3308, 3310, 3312, and 3314 regarding the product to be ordered to the server computer 220 for storing in the server computer memory 222 and in the customer computer memory 242.

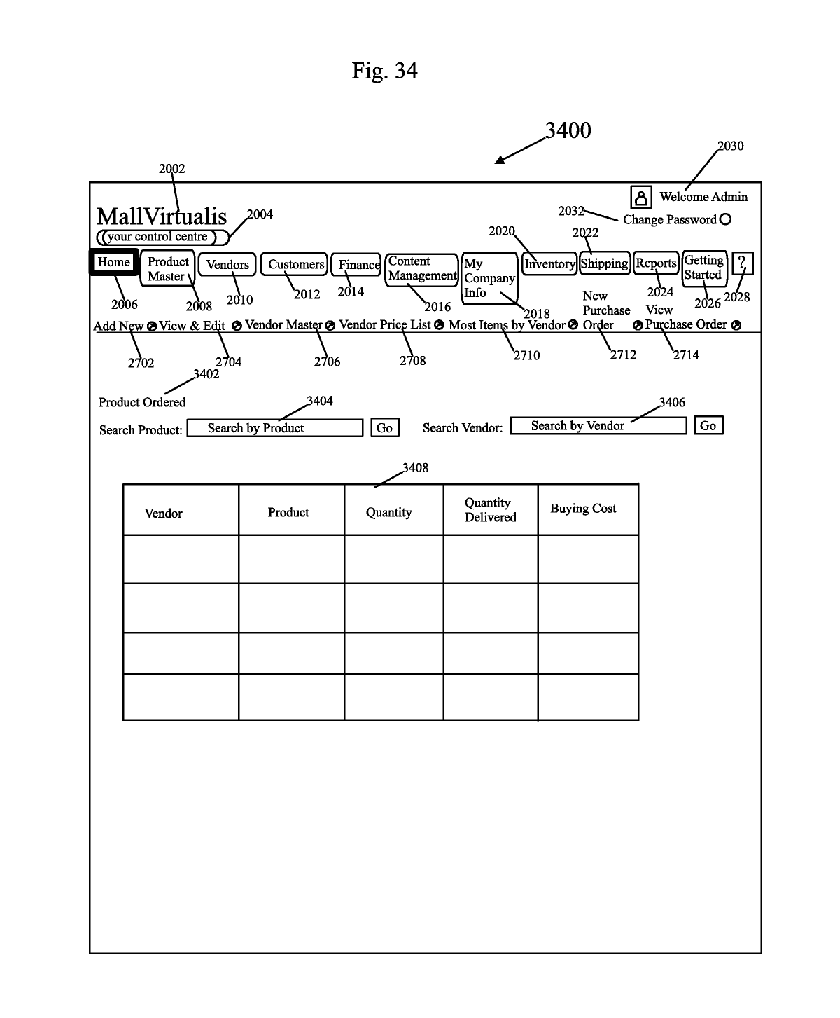

FIG. 34 shows an image 3400 which may be displayed on the first store computer display 250 by the first store computer processor 244 of FIG. 2C in accordance with an embodiment of the present invention, when an administrator of a first store selects the field 2714 for “View Purchase Order” shown in FIG. 27, by using the first store computer interactive device 248.

The image 3400 includes fields 2002, 2004, 2006, 2008, 2010, 2012, 2014, 2016, 2018, 2020, 2022, 2024, 2026, and 2028 which were previously described and explained with reference to FIG. 20. The image 3400 also includes fields 2702, 2704, 2706, 2708, 2810, 2712, and 2714, referred to in FIG. 27.

The image 3400 also includes text “Product Ordered” 3402, and search by product entry box and a go button to select for search 3404. The image 3400 also includes a search by vendor entry box and a go button to select for search 3406. The image 3400 also includes the table 3408 which includes a heading first row, and a plurality of data rows. Each data row may have information corresponding to the appropriate header for a plurality of vendors and/or a plurality of products.

FIG. 35 shows an image 3500 which may be displayed on the first store computer display 250 by the first store computer processor 244 of FIG. 2C in accordance with an embodiment of the present invention, when an administrator of a first store selects the field 2012 for “Customers” shown in FIG. 20, by using the first store computer interactive device 248.

The image 3500 includes fields 2002, 2004, 2006, 2008, 2010, 2012, 2014, 2016, 2018, 2020, 2022, 2024, 2026, and 2028 which were previously described and explained with reference to FIG. 20.

The image 3500 also includes fields 3502 for “Customer Master” and 3504 for “Customer Buying List”. Selecting the field 3502 with the first store interactive device 248 causes the field or box 3506 to be displayed on the store computer display 250 by the computer processor 244 as downloaded from the server computer 220. The field or box 3506 includes text for “Customer Master” 3508, and a search entry and search Go box 3510 for searching for a product by customer. A table 3512 is shown in FIG. 35, which has a first heading row and four data rows. The data rows are shown blank but would include data for a plurality of products by customer. The “S. No.” in the first column refers to a specific product, and the name, email, phone, and city, in the other columns of the table 3512 refers to information about a specific customer who has bought the specific “S. No.” product.

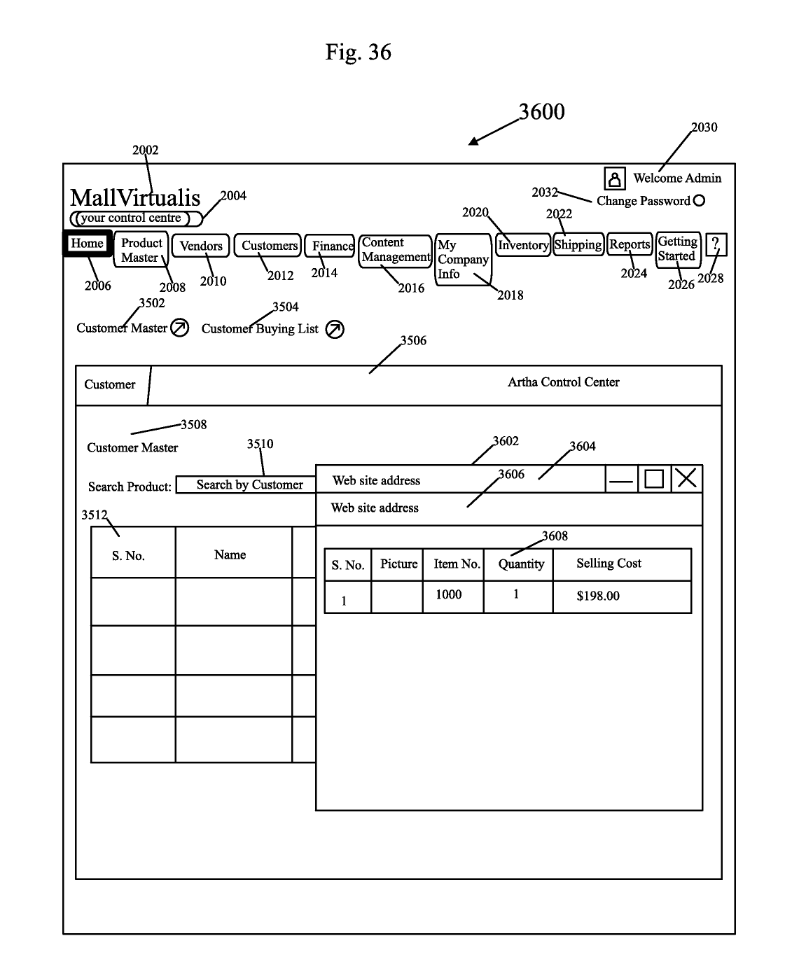

FIG. 36 shows an image 3600 which may be displayed on the first store computer display 250 by the first store computer processor 244 of FIG. 2C in accordance with an embodiment of the present invention, when an administrator of a first store selects “Customer Buying List” 3504 in FIG. 35 by using the first store computer interactive device 248.

The image 3600 includes fields 2002, 2004, 2006, 2008, 2010, 2012, 2014, 2016, 2018, 2020, 2022, 2024, 2026, and 2028 which were previously described and explained with reference to FIG. 20.

The image 3600 shows a field or box 3602 superimposed over the field or box 3506 described with reference to FIG. 35. The field or box 3602 includes a web site address of a customer, and allows information to be sent to a customer about a product that has been sold such as confirmation information. The field or box 3602 includes row 3604, and row 3606 having a web site address. The field or box 3602 includes a table 3608 having a header row and a data row. The data row of field 3608 may include a “S.No.” to identify the product, a picture of the product (not shown), and item no. of the product, a quantity of the product sold to the customer, and a selling cost for what was sold.

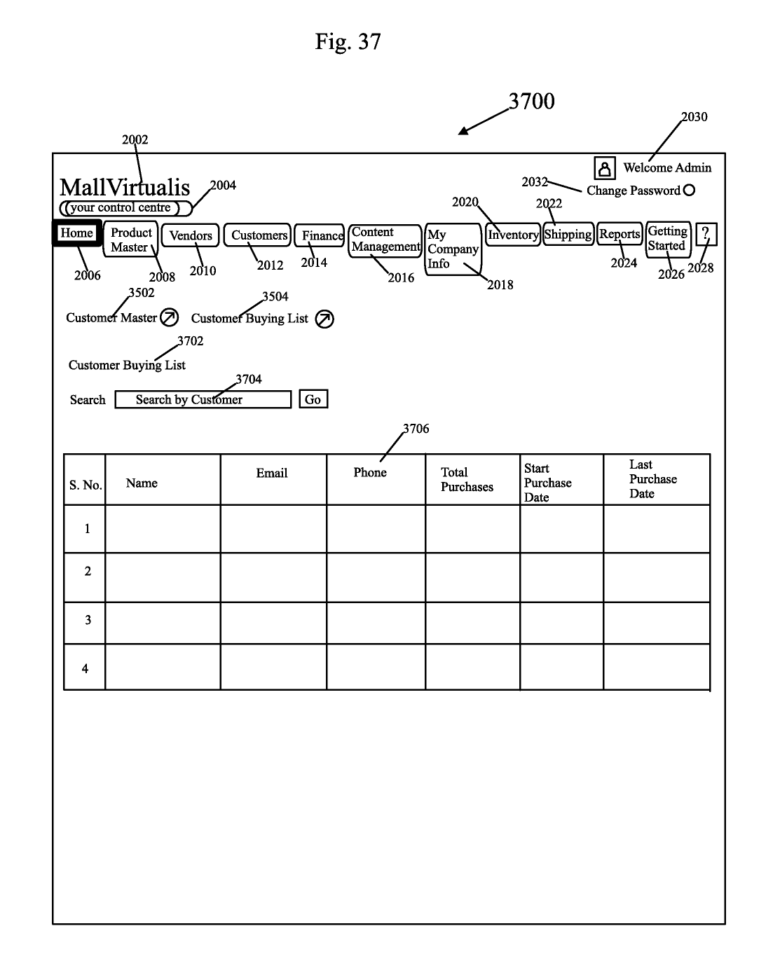

FIG. 37 shows an image 3700 which may be displayed on the first store computer display 250 by the first store computer processor 244 of FIG. 2C in accordance with an embodiment of the present invention, when an administrator of a first store selects the field 2012 for “Customers” shown in FIG. 20, by using the first store computer interactive device 248.

The image 3700 includes fields 2002, 2004, 2006, 2008, 2010, 2012, 2014, 2016, 2018, 2020, 2022, 2024, 2026, and 2028 which were previously described and explained with reference to FIG. 20.

The image 3700 also includes fields 3502 for “Customer Master” and 3504 for “Customer Buying List”. Selecting the field 3504 with the first store interactive device 248 causes the fields or boxes 3702, 3704, and 3706 to be displayed on the store computer display 250 by the computer processor 244 as downloaded from the server computer 220. The field 3702 is text “Customer Buying List”. The field 3704 includes a search entry box and Go button for searching by customer, a database, such as a database of customers and other data stored in server computer memory 222 and/or store computer memory 242. The table or field 3706 includes a first row of headings, and four data rows. Although the four data rows are shown empty in the second through seventh columns, typically data would be shown corresponding to the headings row. Data for a plurality of products purchased by a customer, with each product corresponding to a different “S.No.” or other product identification number would be shown in data rows in FIG. 37, and stored in computer memory 222 and/or computer memory 242.

FIG. 38 shows an image 3800 which may be displayed on the first store computer display 250 by the first store computer processor 244 of FIG. 2C in accordance with an embodiment of the present invention, when an administrator of a first store selects the field 2014 for “Finance” shown in FIG. 20,

The image 3800 includes fields 2002, 2004, 2006, 2008, 2010, 2012, 2014, 2016, 2018, 2020, 2022, 2024, 2026, and 2028 which were previously described and explained with reference to FIG. 20.

The image 3800 also includes fields 3802, 3804, 3806, and 3808 which will be described. The image 3802 for “Cash Management” can be selected by the first store computer interactive device 248 to cause the image or box 3812 to be displayed on the first store computer display 250 by the processor 244. The box 3812 includes a first row of headings and a data row showing Accounts receivable, accounts payable, and cash management for a store owner “S.No” is a Line Number.

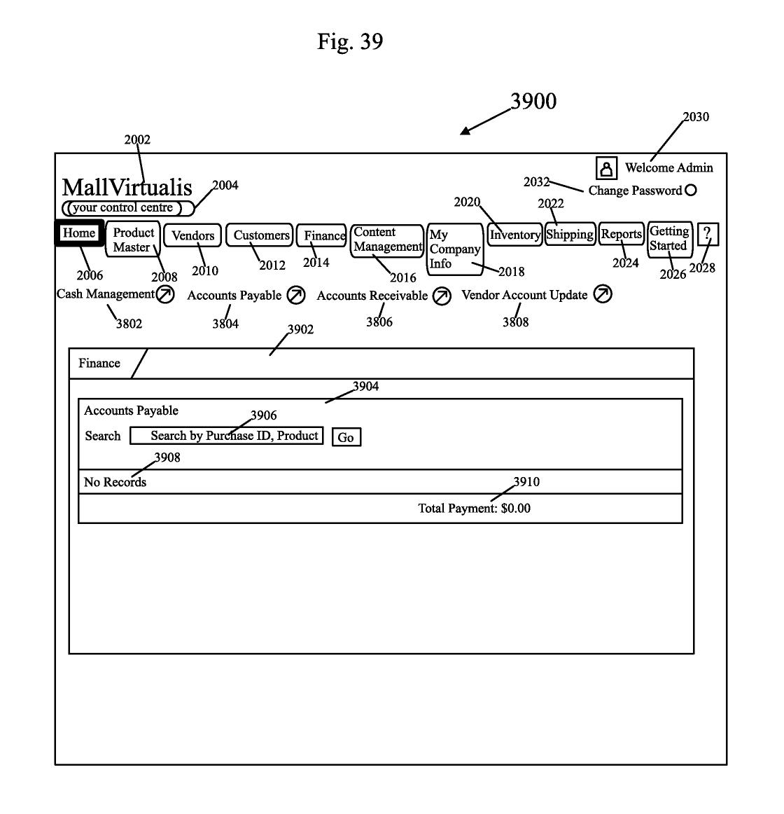

FIG. 39 shows an image 3900 which may be displayed on the first store computer display 250 by the first store computer processor 244 of FIG. 2C in accordance with an embodiment of the present invention, when an administrator of a first store selects the field 2014 for “Finance” shown in FIG. 20.

The image 3900 includes fields 2002, 2004, 2006, 2008, 2010, 2012, 2014, 2016, 2018, 2020, 2022, 2024, 2026, and 2028 which were previously described and explained with reference to FIG. 20.

The image 3900 also includes fields 3802, 3804, 3806, and 3808. The image 3804 for “Accounts Payable” can be selected by the first store computer interactive device 248 to cause the image or box 3902 to be displayed on the first store computer display 250 by the processor 244. The box 3902 includes a box or field 3904 for “Accounts Payable”. The box or field 3904 includes a search entry and go button 3906 for searching for a product by identification number. The field 3904 includes field 3908 which indicates that there are no records for the particular search and the field 3910 which indicates that there is a total payment of $0.00.

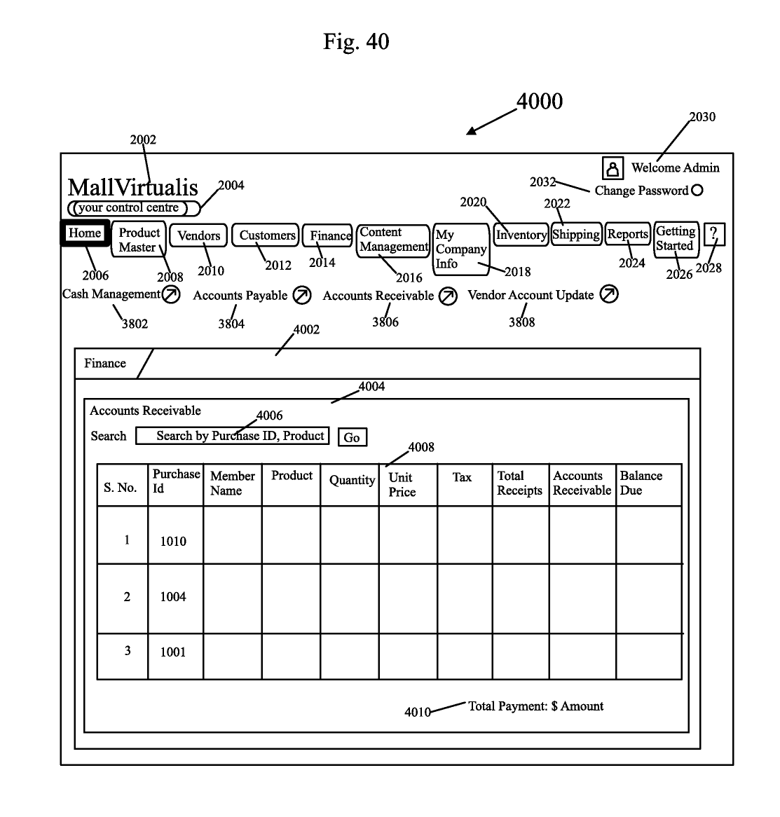

FIG. 40 shows an image 4000 which may be displayed on the first store computer display 250 by the first store computer processor 244 of FIG. 2C in accordance with an embodiment of the present invention, when an administrator of a first store selects the field 2014 for “Finance” shown in FIG. 20,

The image 4000 includes fields 2002, 2004, 2006, 2008, 2010, 2012, 2014, 2016, 2018, 2020, 2022, 2024, 2026, and 2028 which were previously described and explained with reference to FIG. 20.

The image 4000 also includes fields 3802, 3804, 3806, and 3808. The field 3806 for “Accounts Receivable” can be selected by the first store computer interactive device 248 to cause the image or box 4002 to be displayed on the first store computer display 250 by the processor 244. The box 4002 includes a box or field 4004 for “Accounts Payable”. The box or field 4004 includes a search entry and go button 4006 for searching for a product by identification number. The field 4004 includes field or table 4008.

The table 4008 includes a first row of headings and three data rows. The three data rows are shown empty in the third through tenth columns but would typically contain data corresponding to the first row of headings. The table 4008 shows “S.No.” (line number) for three products that were purchased and the member name, product, quantity, unit price, tax, total receipts, accounts receivable, and balance due data would be shown in the appropriate cells of the table 4008. The image 4000 also includes a field 4010 which would specify the total payment for all of the products shown in table 4008. All of this information may be stored in server computer memory 222 and store computer memory 242.

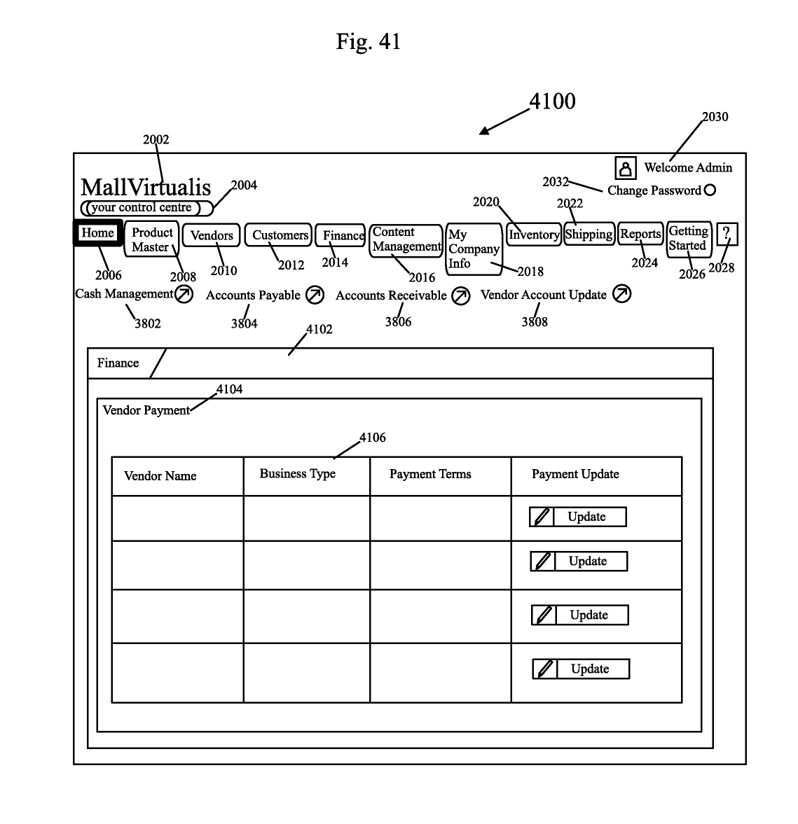

FIG. 41 shows an image 4100 which may be displayed on the first store computer display 250 by the first store computer processor 244 of FIG. 2C in accordance with an embodiment of the present invention, when an administrator of a first store selects the field 2014 for “Finance” shown in FIG. 20,

The image 4100 includes fields 2002, 2004, 2006, 2008, 2010, 2012, 2014, 2016, 2018, 2020, 2022, 2024, 2026, and 2028 which were previously described and explained with reference to FIG. 20.

The image 4100 also includes fields 3802, 3804, 3806, and 3808. The field 3808 for “Vendor Account Update” can be selected by the first store computer interactive device 248 to cause the image or box 4102 to be displayed on the first store computer display 250 by the processor 244. The box 4102 includes a box or field 4104 for “Vendor Payment”. The box or field 4104 also includes a table 4106 which includes a first row of headings and four data rows. The four data rows are shown as empty in the first through third columns but would typically include data corresponding to the headings. Data can be entered in the table 4106, first through third columns in the data rows by using the computer interactive device 248, such as by a computer keyboard of the device 248. The fourth column in the data row can be selected by using the first store computer interactive device 248 to “Update” information about vendor payment terms, as stored in the server computer memory 222 and/or the store computer memory 242.

FIG. 42 shows an image 4200 which may be displayed on the first store computer display 250 by the first store computer processor 244 of FIG. 2C in accordance with an embodiment of the present invention, when an administrator of a first store selects the field 2016 for “Content Management” shown in FIG. 20,

The image 4200 includes fields 2002, 2004, 2006, 2008, 2010, 2012, 2014, 2016, 2018, 2020, 2022, 2024, 2026, and 2028 which were previously described and explained with reference to FIG. 20.

The image 4200 also includes fields 4202, 4204, and 4206. The field 4204 for “Category” can be selected by the first store computer interactive device 248 to cause the image or box 4208 to be displayed on the first store computer display 250 by the processor 244. The box 4208 includes a box or field 4210. The box or field 4210 includes field 4212 which includes an icon or box and text “ARROWHEAD”. The field 4212 can be selected by using the first store computer interactive device 248 to list a plurality of fields 4214, which include subheadings under the term “ARROWHEAD”. The subheadings may correspond to a plurality of products offered by a specific manufacturer or company (such as in this case the “ARROWHEAD” company). Each subheading of field 4214 may have an icon or box to the left which can be selected using first store computer interactive device 248 to display further subheadings coming under that particular subheading, i.e. for example selecting box to left of “RACQUETS” may reveal various types of racquets as subheadings. All information may be downloaded from the server computer 220 and provided to the first store computer 240.

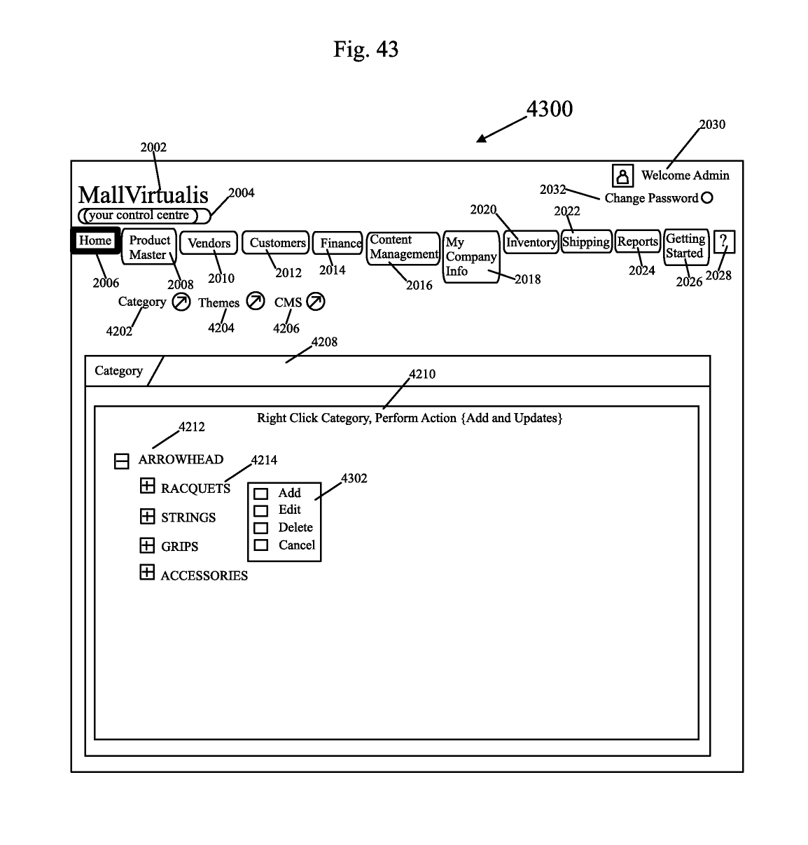

FIG. 43 shows an image 4300 which may be displayed on the first store computer display 250 by the first store computer processor 244 of FIG. 2C in accordance with an embodiment of the present invention, when an administrator of a first store selects the field 2016 for “Content Management” shown in FIG. 20.

The image 4300 includes fields 2002, 2004, 2006, 2008, 2010, 2012, 2014, 2016, 2018, 2020, 2022, 2024, 2026, and 2028 which were previously described and explained with reference to FIG. 20.

The image 4300 also includes fields 4202, 4204, and 4206. The field 4204 for “Category” can be selected by the first store computer interactive device 248 to cause the image or box 4208 to be displayed on the first store computer display 250 by the processor 244. The box 4208 includes a box or field 4210. The box or field 4210 includes field 4212 and fields 4124 previously described.

A box or field 4302 is shown superimposed over the box or field 4210, in FIG. 43. A user may right click, using the first store computer interactive device 248, on a heading or subheading, such as for example “RACQUETS” of subheadings 4214 to cause the box or field 4302 to be dispayed on the first store computer display 250. The user may then select “Add”, “Edit”, “Delete” or “Cancel”, or the corresponding box to the left of these, to add, edit, delete, or cancel a particular heading or subheading of 4212 or 4214.

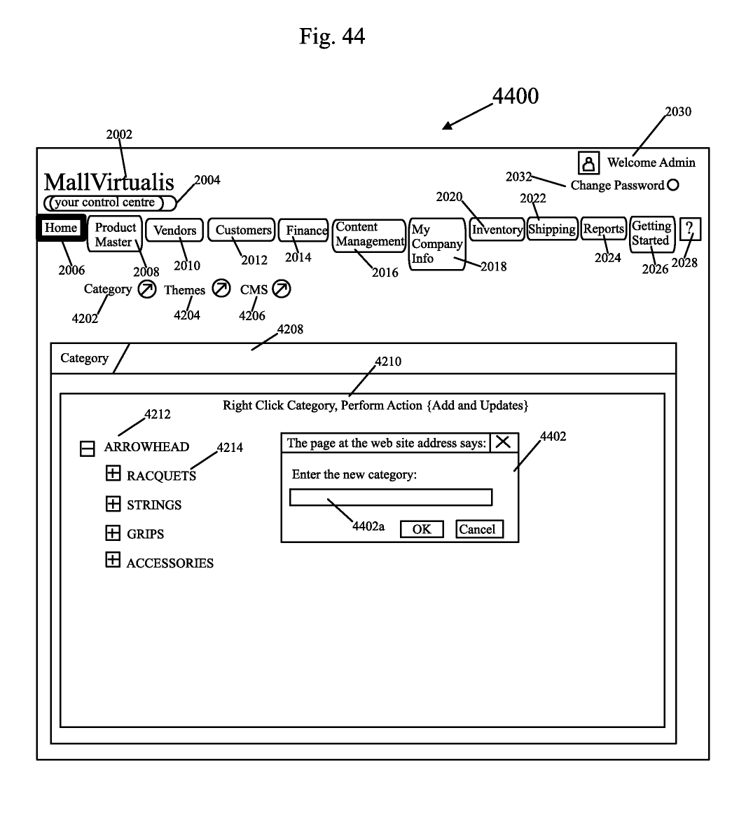

FIG. 44 shows an image 4400 which may be displayed on the first store computer display 250 by the first store computer processor 244 of FIG. 2C in accordance with an embodiment of the present invention, when an administrator of a first store selects the field 2016 for “Content Management” shown in FIG. 20.

The image 4400 includes fields 2002, 2004, 2006, 2008, 2010, 2012, 2014, 2016, 2018, 2020, 2022, 2024, 2026, and 2028 which were previously described and explained with reference to FIG. 20.

The image 4400 also includes fields 4202, 4204, and 4206. The field 4204 for “Category” can be selected by the first store computer interactive device 248 to cause the image or box 4208 to be displayed on the first store computer display 250 by the processor 244. The box 4208 includes a box or field 4210. The box or field 4210 includes field 4212 and fields 4124 previously described.

A box or field 4402 is shown superimposed over the box or field 4210, in FIG. 44. If a user selected “Add” from the field or box 4302 of FIG. 43, then the field or box 4402 is displayed allowing a user to add a new category to the list of headings or subheadings 4212 and/or 4214. The new category can be entered into entry box 4402a and then an “OK” button in the field or box 4402 can be selected using the first store computer interactive device 248 to cause the new category or heading or subheading to be inserted into fields 4212 and/or field 4214 and stored in the server computer memory 222 and/or the first store computer memory 242. A “cancel” button in the field 4402 can be selected to cancel the adding category, heading, or subheading operation.

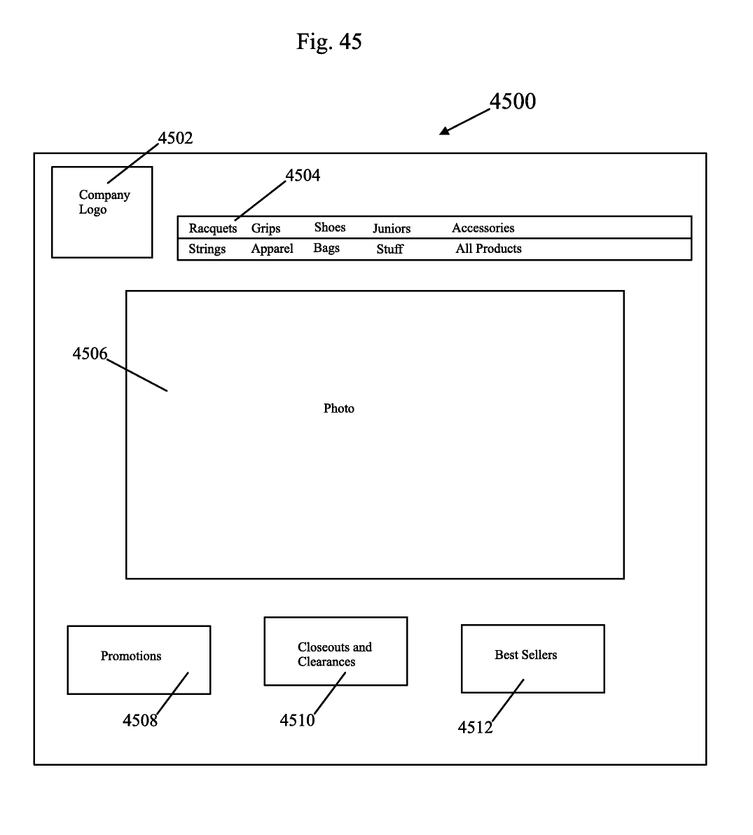

FIG. 45 shows an image 4500 which may be displayed on the first store computer display 250 by the first store computer processor 244 of FIG. 2C in accordance with an embodiment of the present invention, when an administrator of a first store selects the field 2018 for “My Company Info” shown in FIG. 20.

The image 4500 includes fields 4502, 4504, 4506, 4508, 4510, and 4512. The field 4502 may include a digital photograph of a company or first store logo. The field 4504 may include names of products sold by the particular company or first store. The field 4506 may include a photo of the physical first store or street view of the physical first store. The field 4508 may specify promotions relating to the first store. The field 4510 may specify closeouts and clearances relating to the first store. The field 4512 may specify best sellers relating to the first store. All of the information or data referring to fields 4502, 4504, 4506, 4508, 4510, and 4512 may be stored in server computer memory 222 and/or first store computer memory 242 and may be downloaded from the server computer 220 to the first store computer 240 such as by the first store computer 240 accessing a web site over the internet.

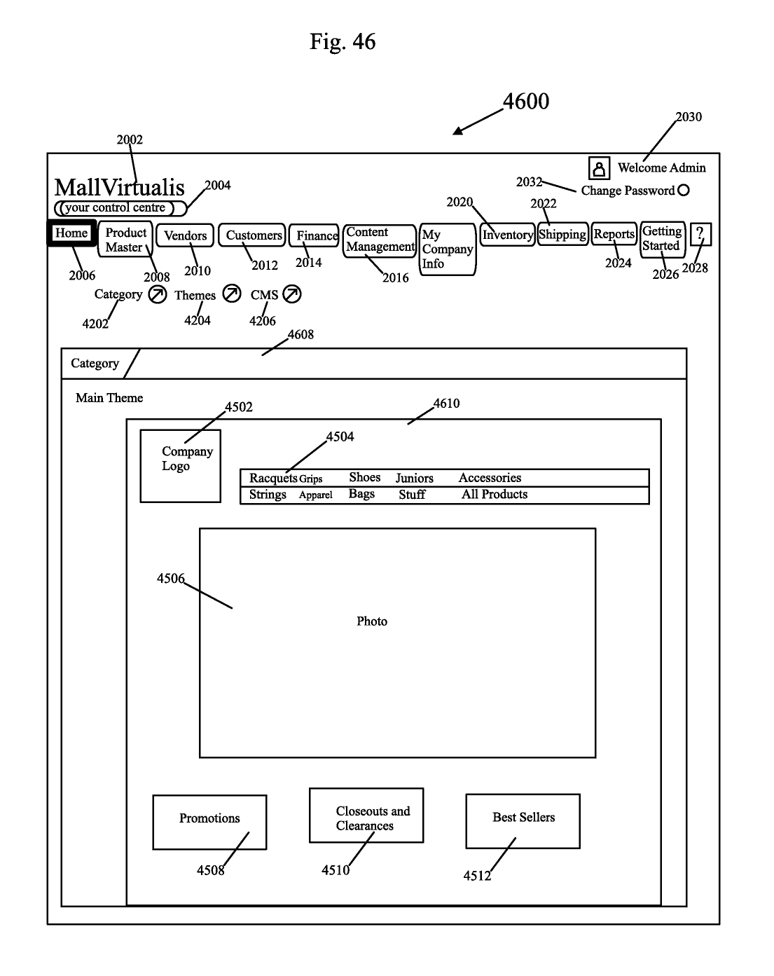

FIG. 46 shows an image 4600 which may be displayed on the first store computer display 250 by the first store computer processor 244 of FIG. 2C in accordance with an embodiment of the present invention, when an administrator of a first store selects the field 2016 for “Content Management” shown in FIG. 20.

The image 4600 includes fields 2002, 2004, 2006, 2008, 2010, 2012, 2014, 2016, 2018, 2020, 2022, 2024, 2026, and 2028 which were previously described and explained with reference to FIG. 20.

The image 4400 also includes fields 4202, 4204, and 4206. The field 4204 for “Category” can be selected by the first store computer interactive device 248 to cause the image or box 4608 to be displayed on the first store computer display 250 by the processor 244. The box 4608 includes a box or field 4610, which includes the fields and data shown in the image 4500 in FIG. 45. The field 4610 can be displayed by selecting “Themes” field 4204 using the first store computer interactive device 248. The field 4610 shows a main theme of the first store.

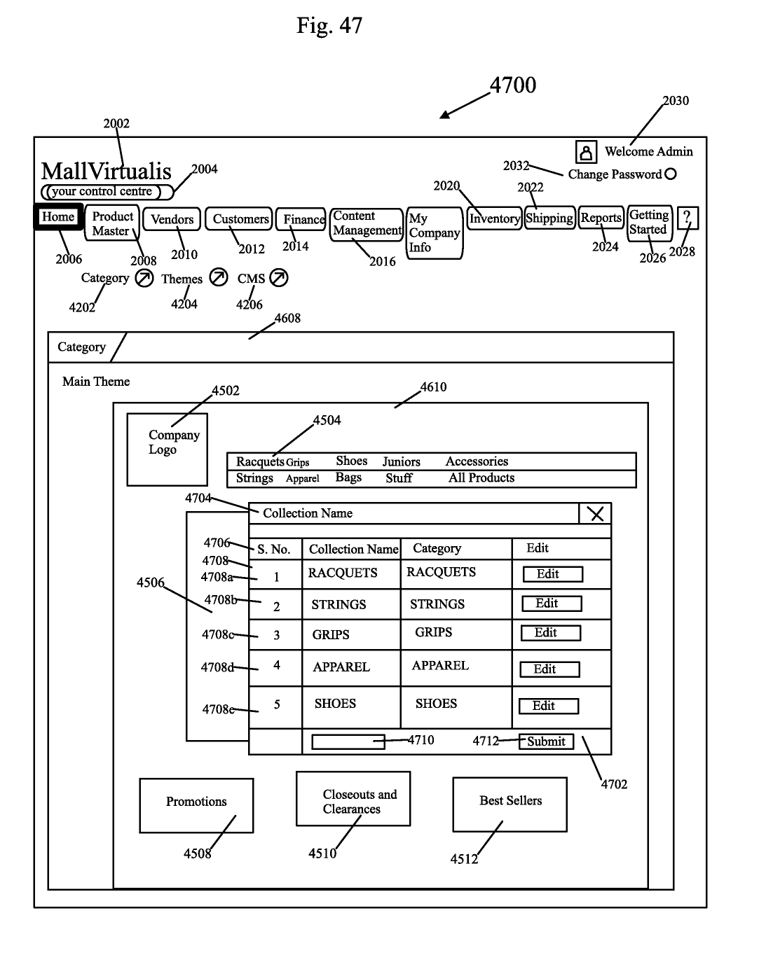

FIG. 47 shows an image 4700 which may be displayed on the first store computer display 250 by the first store computer processor 244 of FIG. 2C in accordance with an embodiment of the present invention, when an administrator of a first store selects the field 2016 for “Content Management” shown in FIG. 20.

The image 4700 includes fields 2002, 2004, 2006, 2008, 2010, 2012, 2014, 2016, 2018, 2020, 2022, 2024, 2026, and 2028 which were previously described and explained with reference to FIG. 20.

The image 4700 also includes fields 4202, 4204, and 4206. The field 4204 for “Category” can be selected by the first store computer interactive device 248 to cause the image or box 4608 to be displayed on the first store computer display 250 by the processor 244. The box 4608 includes a box or field 4610, which includes the fields and data shown in the image 4500 in FIG. 45. The field 4610 can be displayed by selecting “Themes” field 4204 using the first store computer interactive device 248. The field 4610 shows a main theme of the first store.

The image 4700 shows a table 4702 superimposed over the field 4506. The table 4702 includes field 4704 for “Collection Name”, a heading row 4706, and a plurality of data rows 4708 including data rows 4708a, 4708b, 4708c, 4708d, and 4708e. The image 4700 also includes field 4710 and submit field 4712. An edit button is provided for each data row of 4708a-e and can be selected to edit a particular data row. For example, the “S.No.” product “1” for RACQUETS” can be selected by selecting the “Edit” button on the row for that product, and then the collection name and/or the category and/or the “S.No.” can be changed or edited using the first store computer interactive device 248. A user can select the “Submit” button 4712 to cause the edits or changes to rows 4708a-e to be submitted and/or stored in the server computer memory 222 and/or the first store computer memory 242.

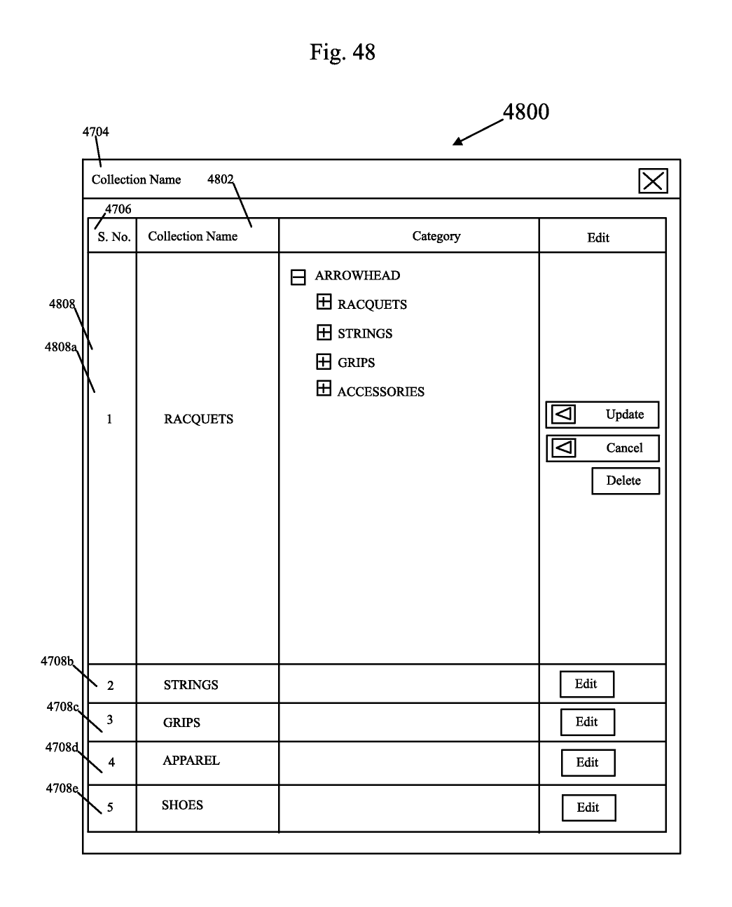

FIG. 48 shows an image 4800 which may be displayed on the first store computer display 250 by the first store computer processor 244 of FIG. 2C in accordance with an embodiment of the present invention, as an insert, superimposed over the field 4506 of FIG. 46. The image 4704 includes the text for “Collection name 4704. The image 4800 includes a table 4802, having a first row of headings 4706 and a plurality 4808 of data rows including data rows 4808a, 4708b, 4708c, 4708d, and 4708e. An edit button in the edit column of table 4702 in FIG. 47, was selected using the first store computer interactive device 248 to cause “Update”, “Cancel”, and “Delete” buttons to be displayed as shown in the first data row “Edit” column in row 4808a in FIG. 48. A user can change the “S.No.”, the collection name, or the category, in row 4808a, and then select either “Update”, “Cancel”, or “Delete” to cause the information to be updated, canceled, or deleted in the server computer memory 222 and/or the first store computer memory 242, and thus to cause a web site for the first store to be updated for later access. The other data rows 4708b-4708e can be updated in the same or a similar manner to data row 4708a of FIG. 47 (which becomes data row 4808a of FIG. 48).

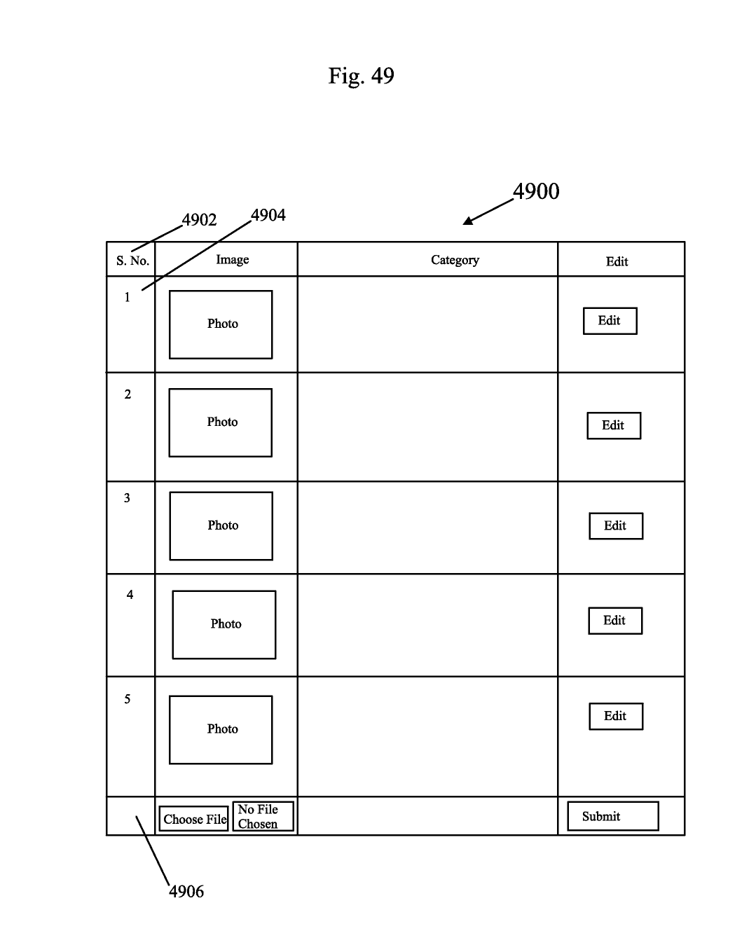

FIG. 49 shows an image 4900 which may be displayed on the first store computer display 250 by the first store computer processor 244 of FIG. 2C in accordance with an embodiment of the present invention, as an insert, superimposed over the field 4506 of FIG. 46.

The image 4900 includes a row of headings 4902. The image 4900 further includes a plurality of data rows 4904 and a row 4906. Each data row of rows 4904 includes an “S.No.”, a photo of a product, a category of a product, and an edit button for editing first through third column information. The row 4906 includes a “choose file button”, “no file chosen button”, and a “submit” button. The “choose file” button can be selected using the first store computer interactive device 248 to select a file for downloading from the server computer memory 222 and/or retrieving from the computer memory 242 for use in the data of rows 4904. The “submit” button in field or row 4906 can be selected using the computer interactive device 248 to submit all of the data of rows 4904 to computer memory 222 and/or 242.

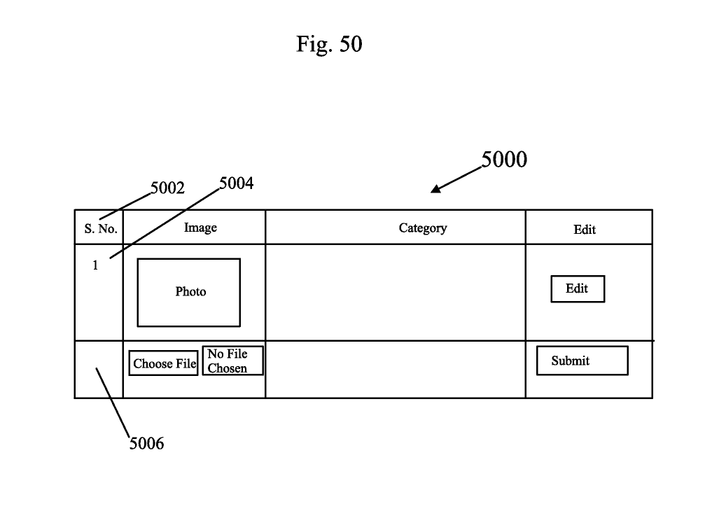

FIG. 50 shows an image 5000 which may be displayed on the first store computer display 250 by the first store computer processor 244 of FIG. 2C in accordance with an embodiment of the present invention, as an insert, superimposed over the field 4506 of FIG. 46. The image 5000 is a portion of the image 4900 which has been described.

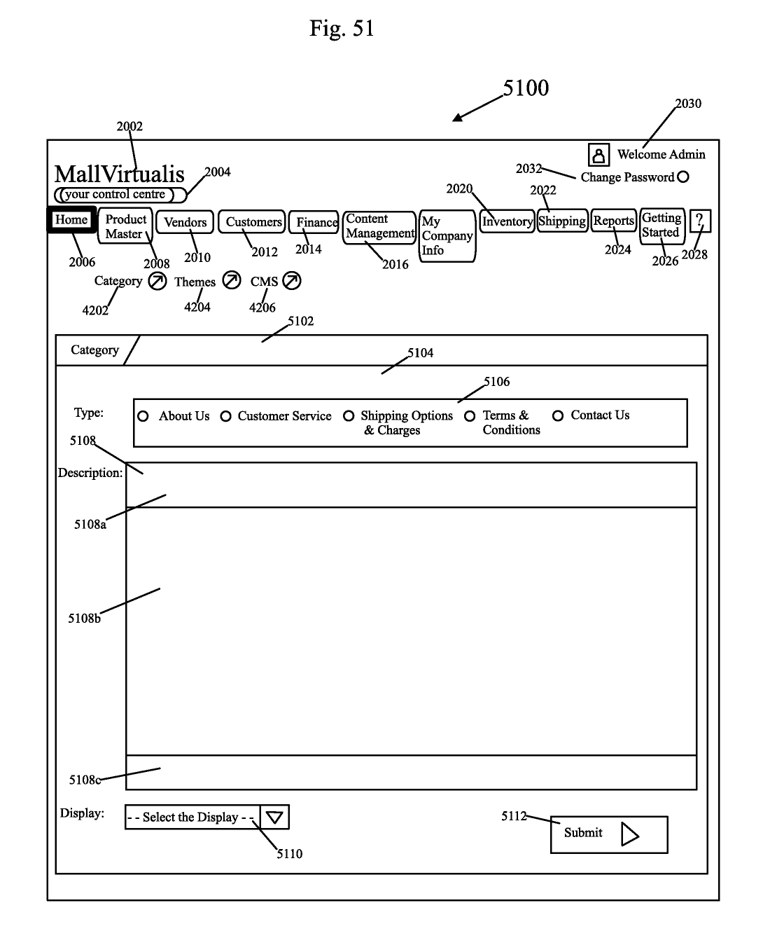

FIG. 51 shows an image 5100 which may be displayed on the first store computer display 250 by the first store computer processor 244 of FIG. 2C in accordance with an embodiment of the present invention, when an administrator of a first store selects the field 2016 for “Content Management” shown in FIG. 20.

The image 5100 includes fields 2002, 2004, 2006, 2008, 2010, 2012, 2014, 2016, 2018, 2020, 2022, 2024, 2026, and 2028 which were previously described and explained with reference to FIG. 20.

The image 5100 also includes fields 4202, 4204, and 4206. The field 4202 for “Category” can be selected by the first store computer interactive device 248 to cause the image or box 5102 to be displayed on the first store computer display 250 by the processor 244. The box 5102 includes a box or field 5104 which includes fields or boxes 5106, 5108, 5110, and 5112, which can be displayed by selecting field 4206 for “CMS”.

The field 5106 allows a first store owner using first store computer interactive device 248 to edit information in the first store web site concerning “About Us”, “Customer Service”, “Shipping Options & Charges”, “Terms & Conditions”, and “Contact Us”. A user can click on one of the circles to the left of the appropriate topic of 5106, and then enter information into fields 5108a-c of field 5108 using a computer interactive device 248 and then submit the information using field or submit button 5112 to store the information in server computer memory 222 and/or first store computer memory 242 so that it will be provided on the first store web site. The field 5110, including entry box and upside arrow can be selected to determine the display for the appropriate topic of field 5106.

FIG. 52 shows an image 5200 which may be displayed on the first store computer display 250 by the first store computer processor 244 of FIG. 2C in accordance with an embodiment of the present invention, when an administrator of a first store selects the field 2018 for “My Company Info” shown in FIG. 20.

The image 5200 includes fields 2002, 2004, 2006, 2008, 2010, 2012, 2014, 2016, 2018, 2020, 2022, 2024, 2026, and 2028 which were previously described and explained with reference to FIG. 20.

The image 5200 also includes fields 5202, 5204, and 5206. The field 5202 can be selected using the computer interactive device 248 to display the field 5208 on the first store computer display 250 as downloaded from the server computer 220 and displayed on a web site page.

The field 5208 includes title row 5208a, and fields 5210, 5212, 5214, 5216, and 5218. Field 5210 includes entry boxes for entering company or first store information using the first store computer interactive device 248 for uploading and storage in the server computer memory 222 and/or for storage in the first store computer memory 242, and for displaying later on a web site provided by the server computer 220. Field 5212 includes entry boxes for entering company or first store address information using the first store computer interactive device 248 for uploading and storage in the server computer memory 222 and/or for storage in the first store computer memory 242, and for displaying later on a web site provided by the server computer 220. Fields 5214 and 5216 includes entry boxes for entering company or first store contact person information and tax information, respectively, using the first store computer interactive device 248 for uploading and storage in the server computer memory 222 and/or for storage in the first store computer memory 242, and for displaying later on a web site provided by the server computer 220.

The field 5218 for “Submit” can be selected by using the first store computer interactive device 248 to submit all of the information entered in field 5208 to the server computer 220 for storage in computer memory 222 and for later display on a web site provided by the server computer 220.

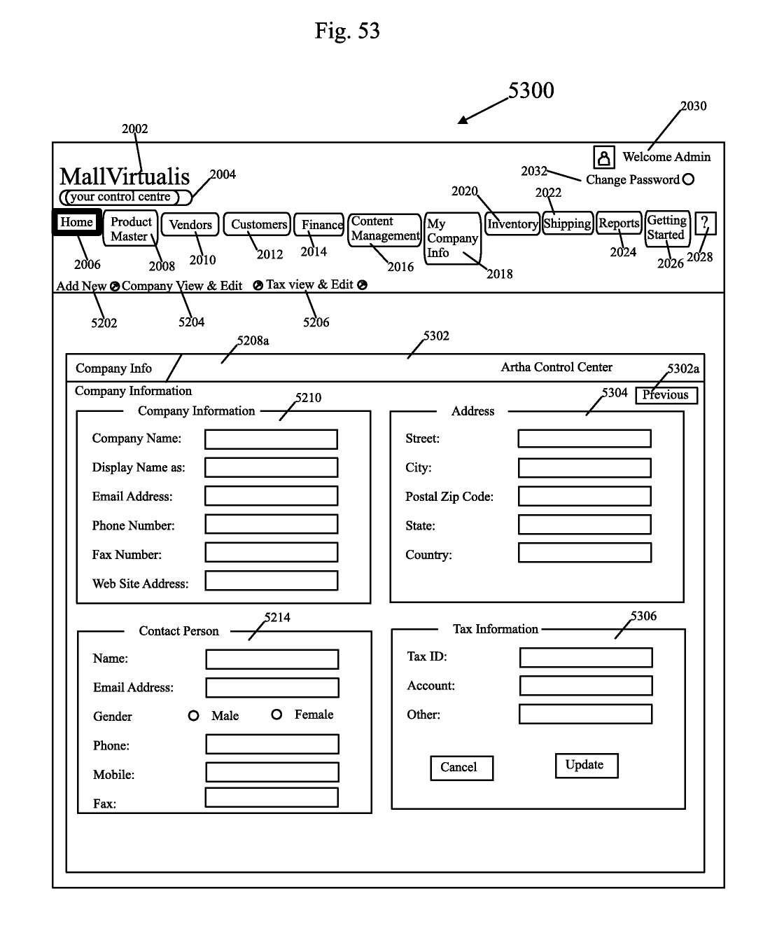

FIG. 53 shows an image 5300. The image 5300 is an alternative to image 5200. The image 5300 includes field 5302. Field 5302 includes 5210 and 5214 which were previously described with reference to FIG. 52. Field 5302 also includes field 5304 for address information and field 5306 for tax information. Field 5306 includes a “cancel” button for canceling updating of information and an “update” button for updating information. Field 5302 also includes field 5302a for going back to a previous screen of information.

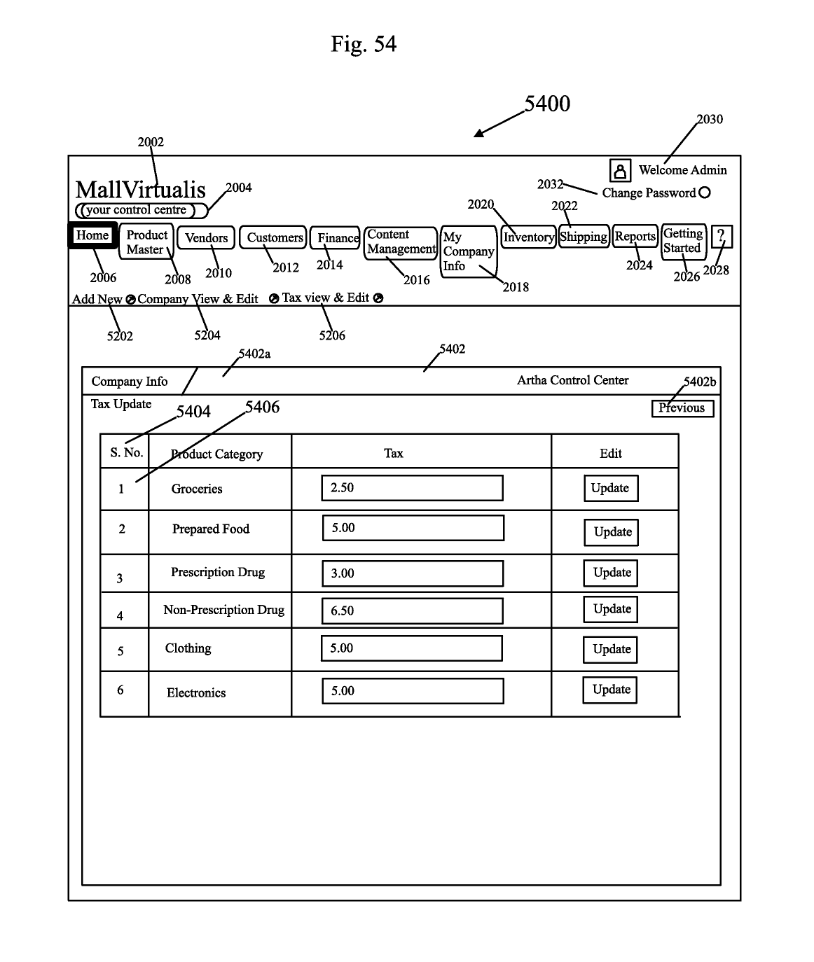

FIG. 54 shows an image 5400 which may be displayed on the first store computer display 250 by the first store computer processor 244 of FIG. 2C in accordance with an embodiment of the present invention, when an administrator of a first store selects the field 2018 for “My Company Info” shown in FIG. 20 and when a user selects “Tax view & Edit” field 5206.

The image 5400 includes fields 2002, 2004, 2006, 2008, 2010, 2012, 2014, 2016, 2018, 2020, 2022, 2024, 2026, and 2028 which were previously described and explained with reference to FIG. 20.

The image 5400 also includes fields 5202, 5204, and 5206.

The image 5400 includes a field 5402 including a text row 5402a. The field 5402 also includes a table including a row of headings 5404 and a plurality of rows 5406 of data. Each of row of data has first through third columns into which data can be entered for “S.No.” for a product, product category, and tax for a product, respectively. Each row of data of 5406 also includes an update button in the fourth column which can be selected to store and/or update data in the server computer memory 222 and/or the first store computer memory 242 by using the first store computer interactive device 248. The image 5400 also includes a “previous” button 5402b to go to a previous screen.

FIG. 55 shows an image 5500 which may be displayed on the first store computer display 250 by the first store computer processor 244 of FIG. 2C in accordance with an embodiment of the present invention, when an administrator of a first store selects the field 2020 for “Inventory” shown in FIG. 20 and when a user selects “Inventory Control” field 5502.

The image 5500 includes fields 2002, 2004, 2006, 2008, 2010, 2012, 2014, 2016, 2018, 2020, 2022, 2024, 2026, and 2028 which were previously described and explained with reference to FIG. 20.

The image 5500 also includes fields 5502, 5504, 5506, and 5508.

The image 5500 includes field 5510 which includes fields 5510a, 5512, 5514, and 5516. Field 5510a is a text field. Field 5512 includes a search entry box and a search “Go” button to do a search for a product, typically by product identification of a database stored on server computer memory 222, by using the first store computer interactive device 248 through a web site provided by the server computer 220. Field 5514 is a row of headings. Field 5516 includes a plurality of rows of data referring to the headings of field 5514. A search using field 5512 typically will bring back results and/or data for a product or products related to the search in the field 5516 from the server computer 220.

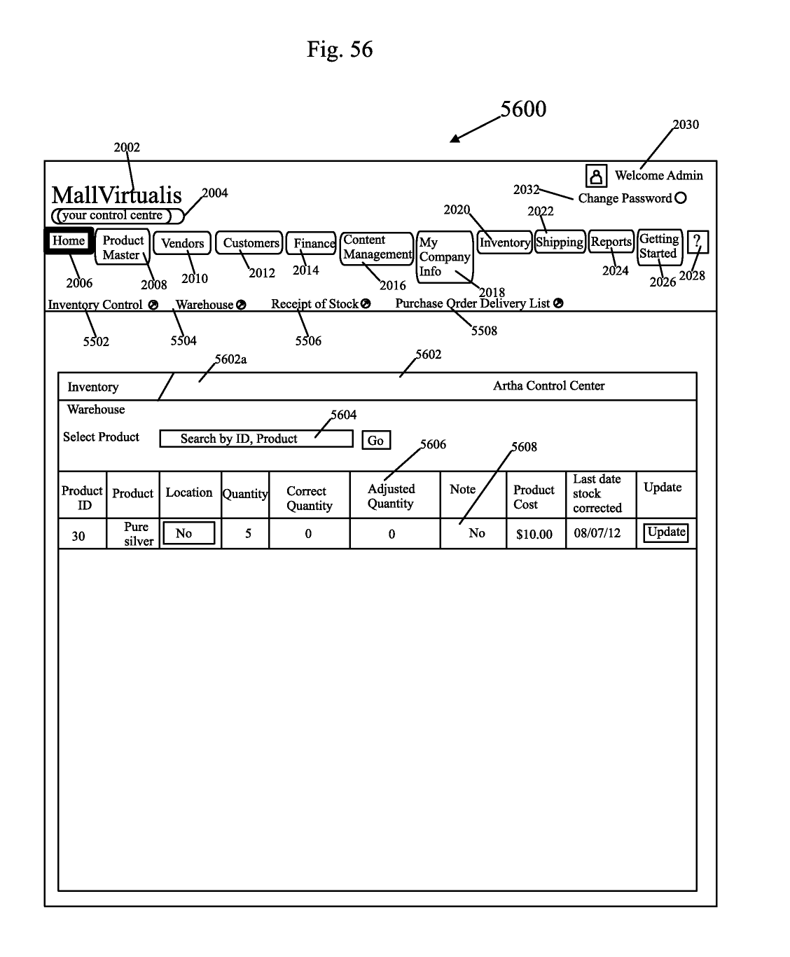

FIG. 56 shows an image 5600 which may be displayed on the first store computer display 250 by the first store computer processor 244 of FIG. 2C in accordance with an embodiment of the present invention, when an administrator of a first store selects the field 2020 for “Inventory” shown in FIG. 20 and when a user selects “Warehouse” field 5504.

The image 5600 includes fields 2002, 2004, 2006, 2008, 2010, 2012, 2014, 2016, 2018, 2020, 2022, 2024, 2026, and 2028 which were previously described and explained with reference to FIG. 20.

The image 5600 also includes fields 5502, 5504, 5506, and 5508.

The image 5600 includes field 5602, which includes fields 5602a, 5604, 5606, and 5608. Field 5602a is a text field. Field 5604 includes a search entry box and a search “Go” button to do a search for a product, typically by product identification of a database stored on server computer memory 222, by using the first store computer interactive device 248 through a web site provided by the server computer 220. Field 5606 is a row of headings. Field 5608 includes a row of data referring to the headings of field 5606. A search using field 5604 typically will bring back results and/or data for a product or products related to the search in the field 5608 from the server computer 220. The data in row 5608 in the first through ninth columns can be updated or changed by using first store computer interactive device 248 to change the data in the appropriate column and selecting an “update” button in the tenth column of field 5608 to update and/or store the changed information in the server computer memory 222 and/or the first store computer memory 242 and to provide the updated information through a web site provided for the first store from the server computer 220.

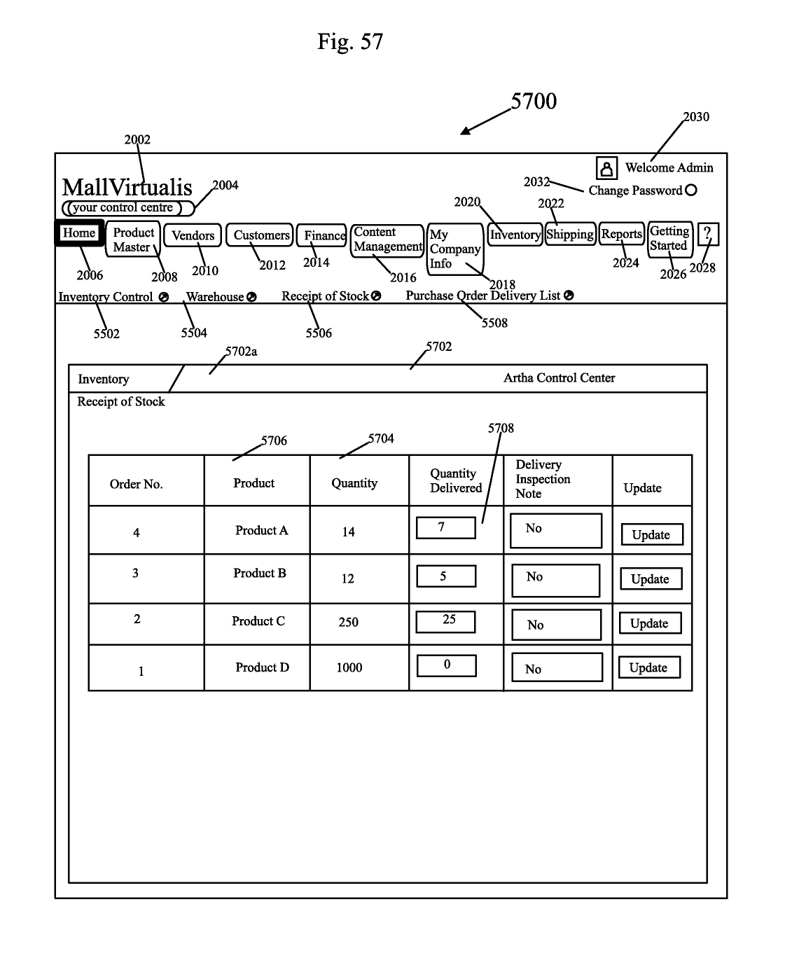

FIG. 57 shows an image 5700 which may be displayed on the first store computer display 250 by the first store computer processor 244 of FIG. 2C in accordance with an embodiment of the present invention, when an administrator of a first store selects the field 2020 for “Inventory” shown in FIG. 20 and when a user selects “Receipt of Stock” field 5506.

The image 5700 includes fields 2002, 2004, 2006, 2008, 2010, 2012, 2014, 2016, 2018, 2020, 2022, 2024, 2026, and 2028 which were previously described and explained with reference to FIG. 20.

The image 5700 also includes fields 5502, 5504, 5506, and 5508.

The image 5700 includes field 5702, which includes fields 5702a, 5704, 5706, and 5708. Field 5702a is a text field. Field 5704 is a table. Field 5706 is a row of headings. Field 5708 includes a plurality of rows of data referring to the headings of field 5706. The data in rows 5708 in the first through fifth columns can be updated or changed by using first store computer interactive device 248 to change the data in the appropriate column and selecting an “update” button in the sixth column of field 5708 to update and/or store the changed information in the server computer memory 222 and/or the first store computer memory 242 and to provide the updated information through a web site provided for the first store from the server computer 220.

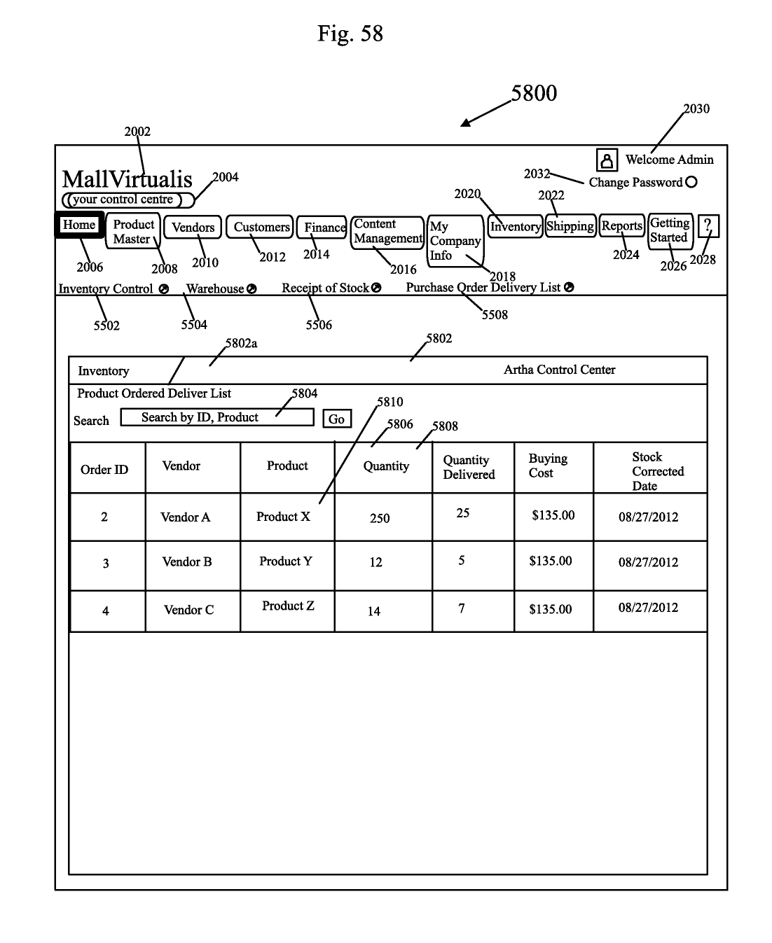

FIG. 58 shows an image 5800 which may be displayed on the first store computer display 250 by the first store computer processor 244 of FIG. 2C in accordance with an embodiment of the present invention, when an administrator of a first store selects the field 2020 for “Inventory” shown in FIG. 20 and when a user selects “Purchase Order Delivery List” field 5508.

The image 5800 includes fields 2002, 2004, 2006, 2008, 2010, 2012, 2014, 2016, 2018, 2020, 2022, 2024, 2026, and 2028 which were previously described and explained with reference to FIG. 20.

The image 5800 also includes fields 5502, 5504, 5506, and 5508.

The image 5800 includes field 5802, which includes fields 5802a, 5804, 5806, 5808, and 5810. Field 5802a is a text field. Field 5804 includes a search entry box and a search “Go” button to do a search for a product, typically by product identification of a database stored on server computer memory 222, by using the first store computer interactive device 248 through a web site provided by the server computer 220. Field 5806 is a table. Field 5808 is a row of headings. Field 5810 includes a plurality of rows of data referring to the headings of field 5808. A search using field 5804 typically will bring back results and/or data for a product or products related to the search in the field 5810 from the server computer 220.

FIG. 59 shows an image 5900 which may be displayed on the first store computer display 250 by the first store computer processor 244 of FIG. 2C in accordance with an embodiment of the present invention, when an administrator of a first store selects the field 2022 for “Shipping” shown in FIG. 20 and when a user selects “Product to be Shipped” field 5902.

The image 5900 includes fields 2002, 2004, 2006, 2008, 2010, 2012, 2014, 2016, 2018, 2020, 2022, 2024, 2026, and 2028 which were previously described and explained with reference to FIG. 20.

The image 5900 also includes fields 5902, 5904, and 5906.

The image 5900 includes field 5908, which includes fields 5908a, 5910, 5912, and 5914. Field 5908a is a text field. Field 5910 is a table. Field 5912 is a row of headings. Field 5914 includes a plurality of rows of data. A “go” button is provided in each row of data of field 5914 and can be clicked on using the first store computer interactive device 248 to cause the shipping of the particular product in the particular quantity shown in the particular row of field 5914. The shipping is caused by sending the shipping information to the server computer 220 which causes the shipping operation.

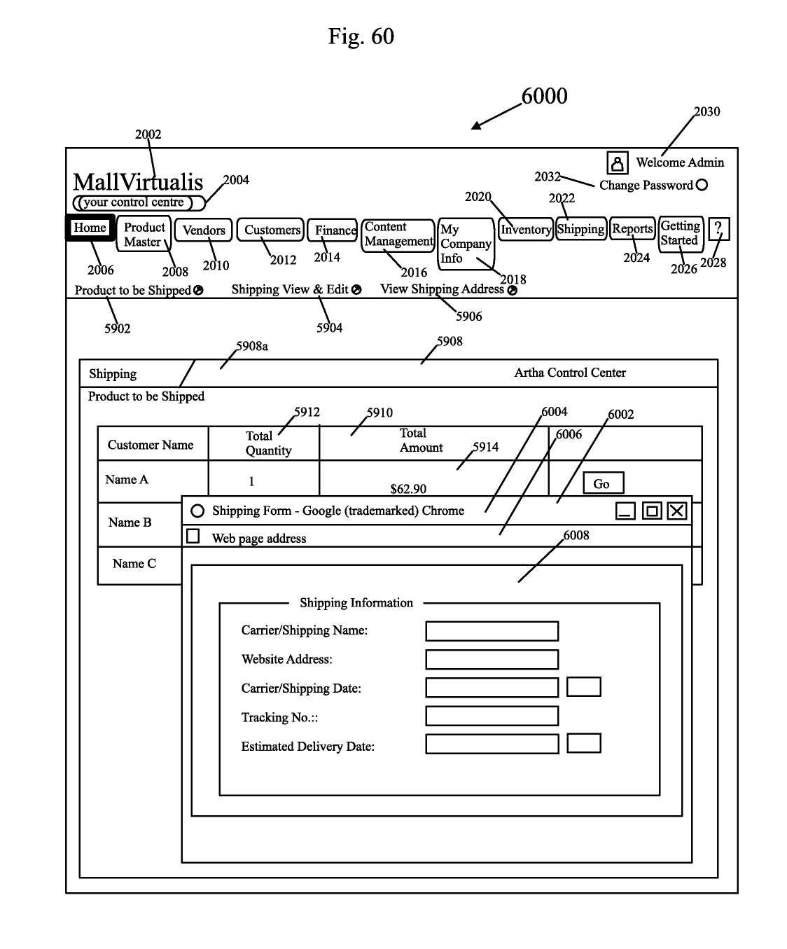

FIG. 60 shows an image 6000 which includes a field 6002 superimposed over the image 5900 of FIG. 59. The field 6002 includes fields 6004, 6006, and 6008. Field 6004 shows a title for a shipping form and minimize, maximize, and exit icons. Field 6006 shows a web page address on the internet. Field 6008 includes entry boxes for entering shipping information including carrier, web site address for carrier, shipping date, tracking no. and estimated delivery date. The information in field 6008 can be provided by a shipping carrier in response to selection of a “go” button in one of rows of field 5914, or can be entered by a user using first store computer interactive device 248.

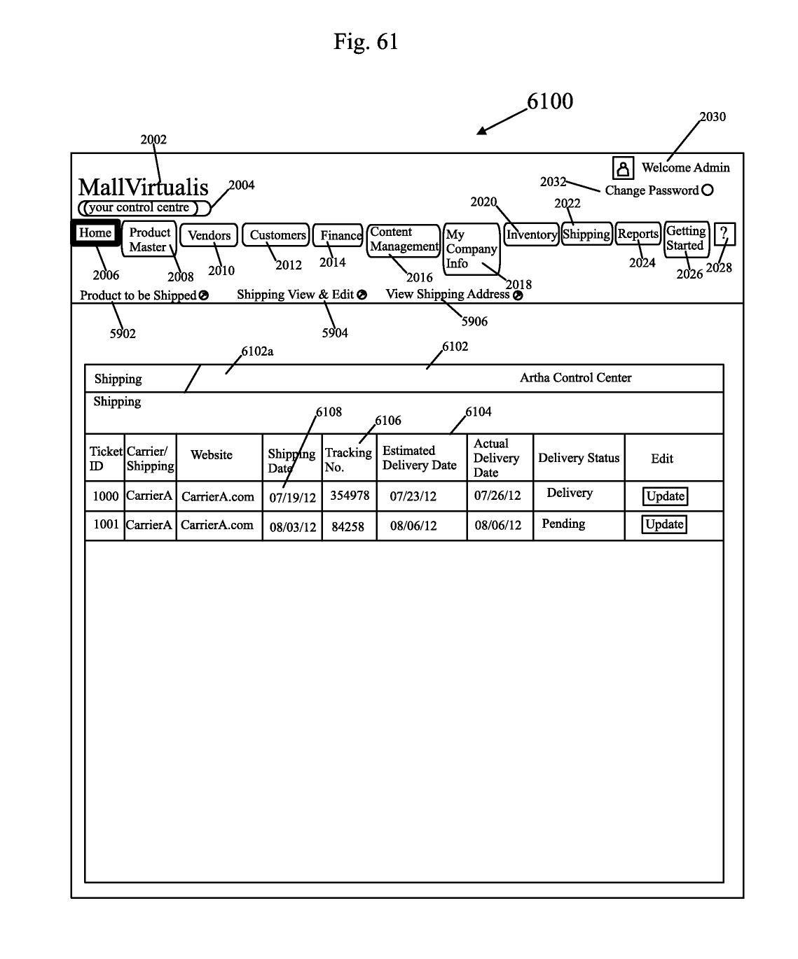

FIG. 61 shows an image 6100 which may be displayed on the first store computer display 250 by the first store computer processor 244 of FIG. 2C in accordance with an embodiment of the present invention, when an administrator of a first store selects the field 2022 for “Shipping” shown in FIG. 20 and when a user selects “Shipping View & Edit” field 5904.

The image 5900 includes fields 2002, 2004, 2006, 2008, 2010, 2012, 2014, 2016, 2018, 2020, 2022, 2024, 2026, and 2028 which were previously described and explained with reference to FIG. 20.

The image 5900 also includes fields 5902, 5904, and 5906.

The image 5900 includes field 6102, which includes fields 6102a, 6104, 6106, and 6108. Field 6102a is a text field. Field 6104 is a table. Field 6106 is a row of headings. Field 6108 includes a plurality of rows of data. An “update” button is provided in each row of data of field 6108 and can be clicked on using the first store computer interactive device 248 to cause updating of shipping information shown in the corresponding row of rows 6108. The data is the first through eighth columns of rows of data 6108 can be changed and then updated by selecting the corresponding update button by using the first store computer interactive device 248 to update the server computer memory 222 and/or the first store computer memory 242, and/or a first store web site provided by the server computer 220.

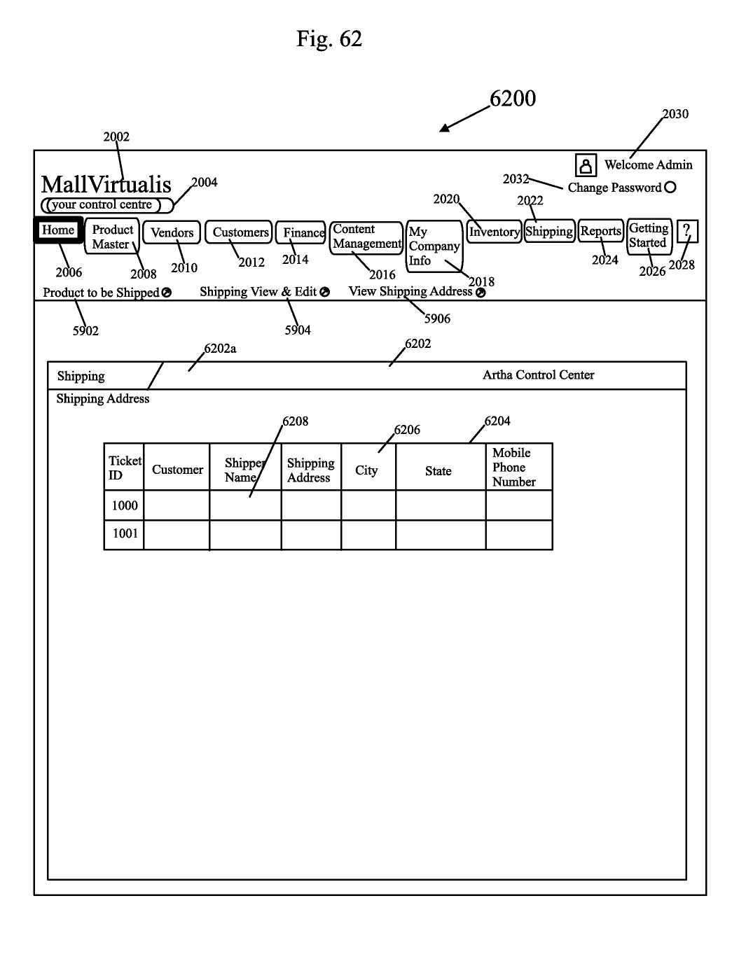

FIG. 62 shows an image 6200 which may be displayed on the first store computer display 250 by the first store computer processor 244 of FIG. 2C in accordance with an embodiment of the present invention, when an administrator of a first store selects the field 2022 for “Shipping” shown in FIG. 20 and when a user selects “View Shipping Address” field 5906.

The image 6200 includes fields 2002, 2004, 2006, 2008, 2010, 2012, 2014, 2016, 2018, 2020, 2022, 2024, 2026, and 2028 which were previously described and explained with reference to FIG. 20.

The image 6200 also includes fields 5902, 5904, and 5906.

The image 6200 includes field 6202, which includes fields 6202a, 6204, 6206, and 6208. Field 6202a is a text field. Field 6204 is a table. Field 6206 is a row of headings. Field 6208 includes a plurality of rows of data. Data may be entered and/or displayed in the rows of 6208 regarding shipping address information.

FIG. 63 shows an image 6300 which may be displayed on the first store computer display 250 by the first store computer processor 244 of FIG. 2C in accordance with an embodiment of the present invention, when an administrator of a first store selects the field 2024 for “Reports” shown in FIG. 20.

The image 6300 includes fields 2002, 2004, 2006, 2008, 2010, 2012, 2014, 2016, 2018, 2020, 2022, 2024, 2026, and 2028 which were previously described and explained with reference to FIG. 20.

The image 6300 also includes fields 6302, 6304, 6306, 6308, 6310, 6312, 6314, 6316, and 6318. The field 6302 includes text 6304 for “View” and an icon or box which can be selected to view a list of possible reports to view. The field 6302 further includes a field 6306 of a list of possible reports each of which can be selected by selecting the report name and/or the box next to the report by using computer interactive device 248.

The field 6308 shows a reports menu for a list of products, such as a products master report. Field 6310 is a text field. Field 6312 is a table. Field 6314 is a row of headings. Field 6316 includes a plurality of rows of data. A user may enter data into the columns of the rows of fields 6316 corresponding to the headings of field 6314. A user may select “export to excel” field or button 6318 using the computer interactive device 6318 to send the data to an excel document located in server computer memory 222 and/or first store computer memory 242, and/or for later displaying on a web site for the first store provided by the server computer 220.

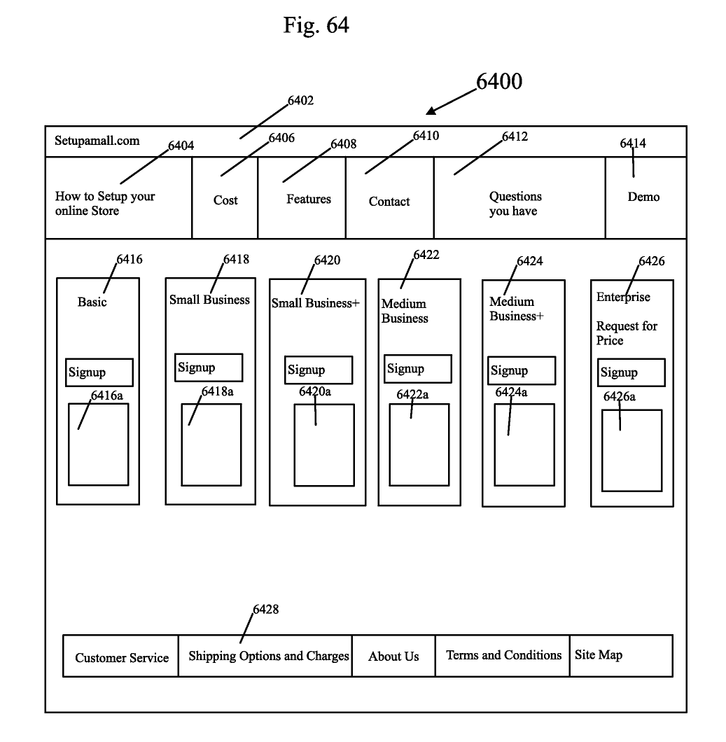

FIG. 64 shows an image 6400 which may be displayed on the first store computer display 250 by the first store computer processor 244 of FIG. 2C in accordance with an embodiment of the present invention. The image 6400 may be a first page of a web site supplied by the server computer 220 to the first store computer 240 specifying how to set up a first store web site or first store online store.

The image 6400 includes fields 6402, 6404, 6406, 6408, 6410, 6412, 6414, 6416, 6418, 6420, 6422, 6424, 6426, and 6428.

Field 6402 is a text field. Any of fields 6404, 6406, 6408, 6410, 6412, and 6414 can be selected using first store computer interactive device 248 to access further information concerning the topic shown. Each of the fields 6416, 6418, 6420, 6422, 6424, and 6426, provide specific information concerning specific web site set up and operation plans. Each of 6416-6426 includes a “signup” button which can be selected using interactive device 248 to sign a first store owner up for a particular online store or first store web site plan. In addition, fields 6416a, 6418a, 6420a, 6422a, 6424a, and 6426a are provided to specify further information about the particular plans. In addition there is a field 6428 provided having a plurality of further topics which also can be selected to obtain further information.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a server computer processor;
a server computer memory;
wherein the server computer processor is programmed by computer software stored in the server computer memory to provide a plurality of administrator web pages of a web site to a first store computer;
wherein the plurality of administrator web pages are configured to enable a user of an interactive device of the first store computer to enter a first set of information concerning a plurality of products for sale from a first store located at a first physical address, wherein the first store corresponds to the first store computer.

2. The apparatus of claim 1 wherein
the plurality of administrator web pages are configured to enable a user of the interactive device of the first store computer to enter a second set of information concerning a plurality of vendors who provide products for sale from the first store.

3. The apparatus of claim 1 wherein
the plurality of administrator web pages are configured to enable a user of the interactive device of the first store computer to enter a second set of information concerning a plurality of customers who have purchased products sold from the first store.

4. The apparatus of claim 1 wherein
the plurality of administrator web pages are configured to enable a user of the interactive device of the first store computer to enter a second set of information concerning financial data involving sales from the first store.

5. The apparatus of claim 1 wherein
the plurality of administrator web pages are configured to enable a user of the interactive device of the first store computer to enter a second set of information concerning categories of products for sale from the first store.

6. The apparatus of claim 1 wherein
the plurality of administrator web pages are configured to enable a user of the interactive device of the first store computer to enter a second set of information concerning tax information regarding products for sale from the first store.

7. The apparatus of claim 1 wherein
the plurality of administrator web pages are configured to enable a user of the interactive device of the first store computer to enter a second set of information concerning shipping information regarding products for sale from the first store.

8. The apparatus of claim 1 wherein
the server computer processor is programmed by computer software stored in the server computer memory to provide a geographical gateway web site page;
wherein the geographical gateway web site page is accessible from the server computer processor over the internet by a first customer using a first customer computer; and
wherein the geographical gateway web site page allows a user of the first customer computer to select a geographic area in which one or more stores are located which sell a particular product.

9. A method comprising
providing a plurality of administrator web pages of a web site to a first store computer from a server computer processor;
wherein the plurality of administrator web pages are configured to enable a user of an interactive device of the first store computer to enter a first set of information concerning a plurality of products for sale from a first store located at a first physical address, wherein the first store corresponds to the first store computer.

10. The method of claim 9 wherein
the plurality of administrator web pages are configured to enable a user of the interactive device of the first store computer to enter a second set of information concerning a plurality of vendors who provide products for sale from the first store.

11. The method of claim 9 wherein
the plurality of administrator web pages are configured to enable a user of the interactive device of the first store computer to enter a second set of information concerning a plurality of customers who have purchased products sold from the first store.

12. The method of claim 9 wherein
the plurality of administrator web pages are configured to enable a user of the interactive device of the first store computer to enter a second set of information concerning financial data involving sales from the first store.

13. The method of claim 9 wherein
the plurality of administrator web pages are configured to enable a user of the interactive device of the first store computer to enter a second set of information concerning categories of products for sale from the first store.

14. The method of claim 9 wherein
the plurality of administrator web pages are configured to enable a user of the interactive device of the first store computer to enter a second set of information concerning tax information regarding products for sale from the first store.

15. The method of claim 9 wherein
the plurality of administrator web pages are configured to enable a user of the interactive device of the first store computer to enter a second set of information concerning shipping information regarding products for sale from the first store.

16. The method of claim 9 wherein
the server computer processor is programmed by computer software stored in the server computer memory to provide a geographical gateway web site page;
wherein the geographical gateway web site page is accessible from the server computer processor over the internet by a first customer using a first customer computer; and
wherein the geographical gateway web site page allows a user of the first customer computer to select a geographic area in which one or more stores are located which sell a particular product.
